(19) United States
(12) Patent Application Publication
(10) Pub. No.: US 2021/0145000 A1
(43) Pub. Date: May 20, 2021

(54) WEED CONTROL FROM APPLICATIONS OF PYRIDINE CARBOXYLIC ACID HERBICIDES AND ACETYL CoA CARBOXYLASE (ACCase) INHIBITORS

(71) Applicant: Dow AgroSciences LLC, Indianapolis, IN (US)

(72) Inventors: Norbert M. Satchivi, Carmel, IN (US); Bryston L. Bangel, Mooresville, IN (US)

(73) Assignee: Dow AgroSciences LLC, Indianapolis, IN (US)

(21) Appl. No.: 17/045,188

(22) PCT Filed: Apr. 4, 2019
(86) PCT No.: PCT/US19/25700

§ 371 Date: Oct. 5, 2020

Related U.S. Application Data
(60) Provisional application No. 62/652,370, filed on Apr. 4, 2018.

(51) Int. Cl. A01N 43/40; A01N 43/90; A01N 37/34; A01N 37/36; A01N 43/76; A01N 43/60; A01N 35/10

(52) U.S. Cl. CPC A01N 43/40; A01N 43/90; A01N 37/34; A01N 35/10; A01N 43/76; A01N 43/60; A01N 37/36

(57) ABSTRACT

Disclosed herein are herbicidal compositions containing a herbicidally effective amount of (a) a pyridine carboxylic acid herbicide or an agriculturally acceptable N-oxide, salt, or ester thereof, and (b) an acetyl CoA carboxylase (ACCase) inhibitor or an agriculturally acceptable salt or ester thereof. Also disclosed herein are methods of controlling undesirable vegetation which comprise applying to vegetation or an area adjacent the vegetation or applying to soil or water to prevent the emergence or growth of vegetation (a) a pyridine carboxylic acid herbicide or an agriculturally acceptable N-oxide, salt, or ester thereof and (b) an acetyl CoA carboxylase (ACCase) inhibitor or an agriculturally acceptable salt or ester thereof, wherein (a) and (b) are each added in an amount sufficient to provide a herbicidal effect.

### CROSS-REFERENCE TO RELATED APPLICATIONS

This application claims priority to and benefit of U.S. Provisional Application Ser. No. 62/652,370, filed on Apr. 4, 2018, the entire disclosure of which is hereby expressly incorporated by reference.

### BACKGROUND

Many recurring problems in agriculture involve controlling growth of undesirable vegetation that can, for instance, inhibit crop growth. To help control undesirable vegetation, researchers have produced a variety of chemicals and chemical formulations effective in controlling such unwanted growth. However, a continuing need exists for new compositions and methods to control growth of undesirable vegetation.

### SUMMARY

Disclosed herein are herbicidal compositions containing a herbicidally effective amount of (a) a pyridine carboxylic acid herbicide or an agriculturally acceptable N-oxide, salt, or ester thereof, and (b) an acetyl CoA carboxylase (ACCase) inhibitor or an agriculturally acceptable salt or ester thereof. In some embodiments, the weight ratio of (a) to (b) can be from 1:3000 to 1000:1 (e.g., from 1:1500 to 500:1, from 1:500 to 160:1, from 1:50 to 16:1, or from 1:10 to 3:1).

The pyridine carboxylic acid herbicide can comprise a compound defined by Formula (I)

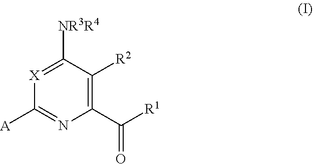

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is one of groups A1 to A36

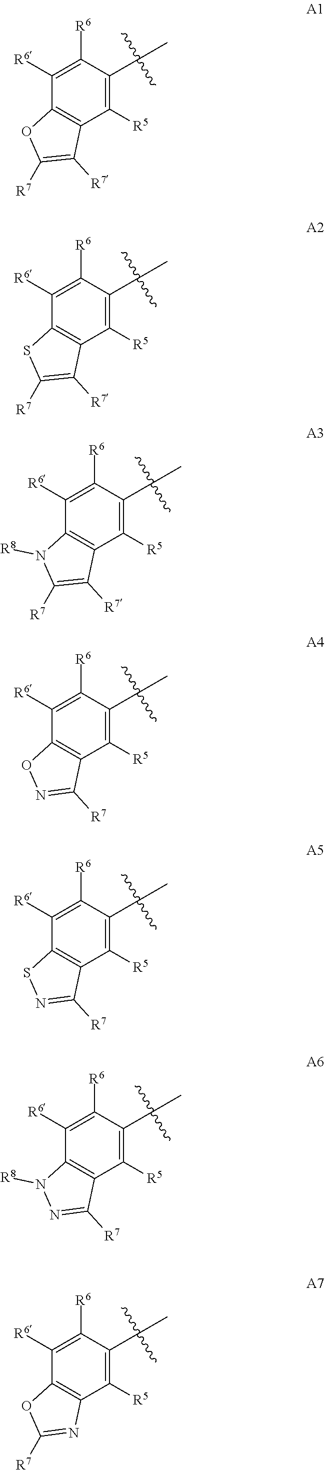

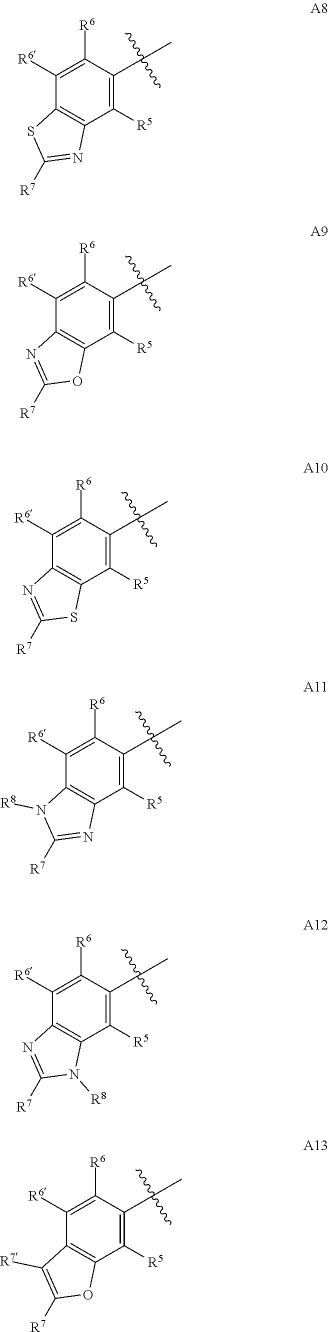

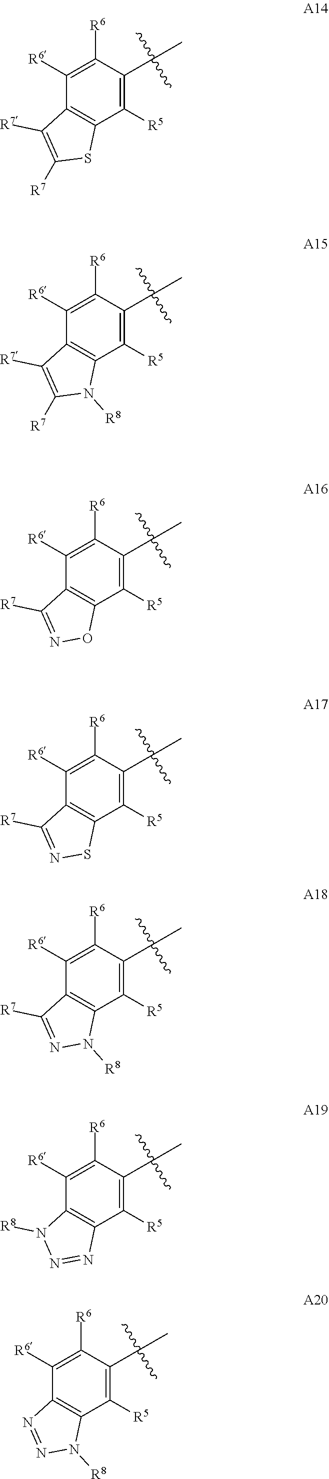

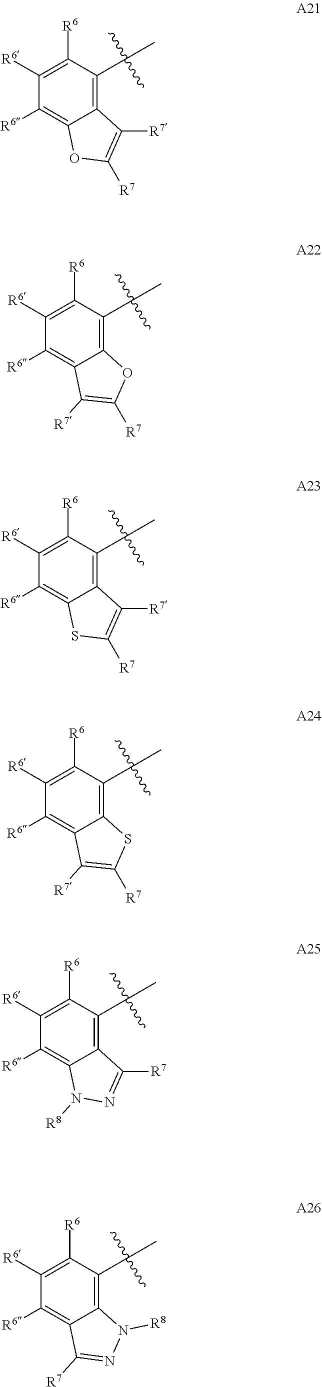

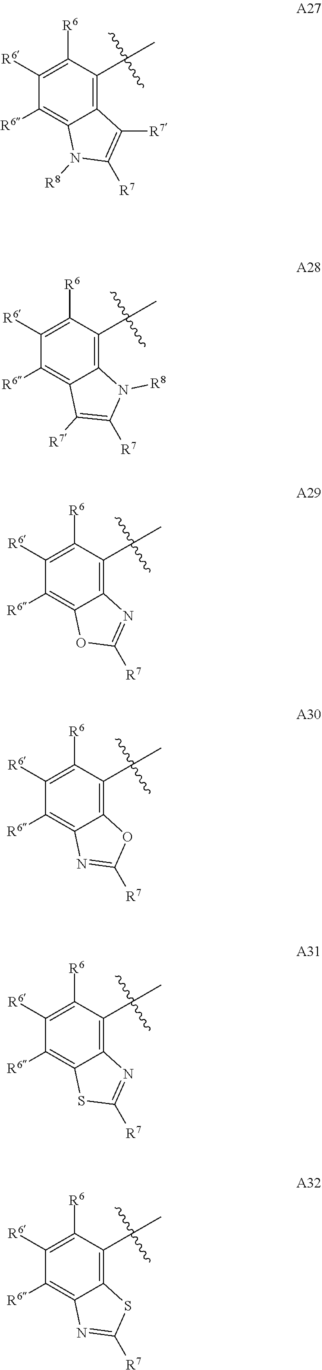

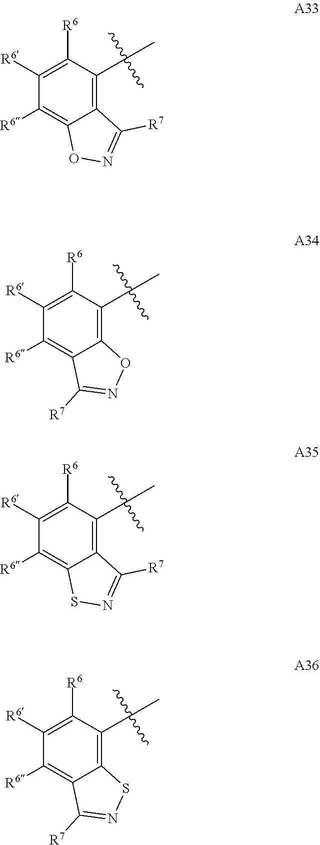

R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆, alkoxycarbonyl. C₁-C₆ alkylcarbamyl, C₁-C₆ alkylsulfonyl, C₁-C₆ trialkylsilyl, or phenyl;

or an agriculturally acceptable N-oxide or salt thereof.

In certain embodiments, the pyridine carboxylic acid herbicide can comprise a compound defined by Formula (II):

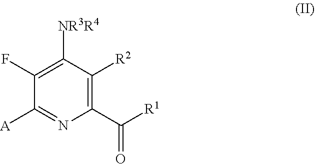

wherein

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR³ (R⁴), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkyl carbonyl, C₁-C₃ haloalkylcarbonyl, C₁-C₆, alkoxycarbonyl. C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments, R¹ is OR^{1′}, wherein R^{1′} is hydrogen, C₁-C₈ alkyl, or C₇-C₁₀ arylalkyl. In certain embodiments, R² is Cl, methoxy, vinyl, or 1-propenyl; R³ and R⁴ are hydrogen; A is A15; R⁵ is hydrogen or F; and R⁶ is hydrogen or F; and R^{6″} is hydrogen, halogen, C₁-C₄ alkyl, C₁-C₄ haloalkyl, cyclopropyl, C₂-C₄ alkynyl, CN, or NO₂.

In certain embodiments, the pyridine carboxylic acid herbicide can comprise a compound defined by Formula (III):

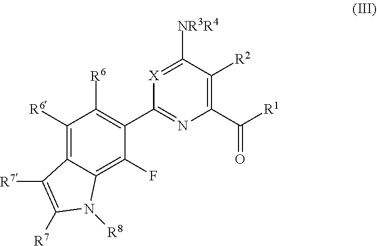

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR³ (R⁴), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments, X is N, CH or CF. In certain embodiments, X is CF, R¹ is OR^{1′}, wherein R^{1′} is hydrogen, C₁-C₈ alkyl, or C₇-C₁₀ arylalkyl; R² is Cl, methoxy, vinyl, or 1-propenyl; R³ and R⁴ are hydrogen; R⁶ is hydrogen or F; and R^{6′} is hydrogen, halogen, C₁-C₄ alkyl, C₁-C₄ haloalkyl, cyclopropyl, C₂-C₄ alkynyl, CN, or NO₂.

In certain embodiments, the pyridine carboxylic acid herbicide can include 4-amino-3-chloro-5-fluoro-6-(7-fluoro-1H-indol-6-yl) picolinic acid or an agriculturally acceptable N-oxide, salt, or ester thereof.

In some embodiments, (b) can comprise an aryloxyphenoxypropionate herbicide. In certain embodiments, (b) can include clodinafop, cyhalofop, diclofop, fenoxaprop, fluazifop, haloxyfop, metamifop, propaquizafop, or quizalofop, agriculturally acceptable salts or esters thereof, or combinations thereof. For example, in some aspects, the aryloxyphenoxypropionate herbicide may be fenoxaprop.

In some embodiments, (b) can comprise a cyclohexanedione herbicide. In certain embodiments, (b) can include alloxydim, butroxydim, clethodim, cycloxydim, profoxydim, sethoxydim, tepraloxydim, or tralkoxydim, agriculturally acceptable salts or esters thereof, or combinations thereof.

In some embodiments, (b) can comprise a phenylpyrazoline herbicide. In certain embodiments, (b) can include pinoxaden, and agriculturally acceptable salts thereof.

The composition can further comprise an additional pesticide, a herbicidal safener, an agriculturally acceptable adjuvant or carrier, or a combination thereof. The composition can be provided as a herbicidal concentrate.

The present disclosure also relates to methods of controlling undesirable vegetation which comprise applying to vegetation or an area adjacent the vegetation or applying to soil or water to prevent the emergence or growth of vegetation a herbicidally effective amount of (a) a pyridine carboxylic acid herbicide or an agriculturally acceptable N-oxide, salt, or ester thereof and (b) an acetyl CoA carboxylase (ACCase) inhibitor or an agriculturally acceptable salt or ester thereof. In some embodiments, (a) and (b) are applied simultaneously. In some embodiments, (a) and (b) are applied postemergence to the undesirable vegetation.

In some embodiments, (a) can comprise a pyridine carboxylic acid herbicide described above. In certain embodiments, (a) can comprise 4-amino-3-chloro-5-fluoro-6-(7-fluoro-1H-indol-6-yl) picolinic acid or an agriculturally acceptable N-oxide, salt, or ester thereof. In some embodiments, (b) can comprise an aryloxyphenoxypropionate herbicide. In certain embodiments, (b) can include clodinafop, cyhalofop, diclofop, fenoxaprop, fluazifop, haloxyfop, metamifop, propaquizafop, or quizalofop, or agriculturally acceptable salts or esters thereof. In some cases, (a) can be applied in an amount of from 0.5 grams acid equivalent per hectare (g ae/ha) to 300 g ae/ha (e.g., from 5 g ae/ha to 40 g ae/ha) and (b) can be applied in an amount of from 10 grams active ingredient per hectare (g ai/ha) to 1200 g ai/ha (e.g., from 30 g ai/ha to 800 g ai/ha). In some cases, (a) and (b) can be applied in a weight ratio of from 1:2500 to 1200:1 (e.g., from 1:1500 to 500:1, from 1:500 to 160:1, from 1:50 to 16:1, or from 1:20 to 10:1).

In some embodiments, (a) can contain a pyridine carboxylic acid herbicide described above. In certain embodiments, (a) can contain 4-amino-3-chloro-5-fluoro-6-(7-fluoro-1H-indol-6-yl) picobnic acid or an agriculturally acceptable N-oxide, salt, or ester thereof. In some embodiments, (b) can contain a cyclohexanedione herbicide. In certain embodiments, (b) can include alloxydim, butroxydim, clethodim, cycloxydim, profoxydim, sethoxydim, tepraloxydim, or tralkoxydim, or agriculturally acceptable salts or esters thereof. In some cases, (a) can be applied in an amount of from 0.5 grams acid equivalent per hectare (g ae/ha) to 300 g ae/ha (e.g., from 5 g ae/ha to 40 g ae/ha) and/or (b) can be applied in an amount of from 2 grams active ingredient per hectare (g ai/ha) to 1500 g ai/ha (e.g., from 20 g ai/ha to 1000 g ai/ha). In some cases, (a) and (b) can be applied in a weight ratio of from 1:3000 to 500:1 (e.g., from 1:1500 to 250:1, from 1:500 to 80:1, from 1:160 to 26:1, or from 1:30 to 5:1).

In some embodiments, (a) can contain a pyridine carboxylic acid herbicide described above. In certain embodiments, (a) can contain 4-amino-3-chloro-5-fluoro-6-(7-fluoro-1H-indol-6-yl) picobnic acid or an agriculturally acceptable N-oxide, salt, or ester thereof. In some embodiments, (b) can contain a phenylpyrazoline herbicide. In certain embodiments, (b) can include pinoxaden, or agriculturally acceptable salts or esters thereof. In some cases, (a) can be applied in an amount of from 0.5 grams acid equivalent per hectare (g ae/ha) to 300 g ae/ha (e.g., from 5 g ae/ha to 40 g ae/ha) and/or (b) can be applied in an amount of from 2 grams active ingredient per hectare (g ai/ha) to 900 g ai/ha (e.g., from 2 g ai/ha to 500 g ai/ha). In some cases, (a) and (b) can be applied in a weight ratio of from 1:3000 to 500:1 (e.g., from 1:1500 to 250:1, from 1:500 to 80:1, from 1:150 to 25:1, or from 1:30 to 5:1).

The description below sets forth further details of one or more embodiments of the present disclosure. Other features, objects, and advantages will be apparent from the description and from the claims.

### DETAILED DESCRIPTION

The present disclosure relates to herbicidal compositions containing a herbicidally effective amount of (a) a pyridine carboxylic acid herbicide or an agriculturally acceptable N-oxide, salt, or ester thereof and (b) an acetyl CoA carboxylase (ACCase) inhibitor or an agriculturally acceptable salt or ester thereof. The present disclosure also relates to methods for controlling undesirable vegetation.

### I. Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

As used herein, the terms “herbicide” and “herbicidal active ingredient” refer to an active ingredient that kills, controls, or otherwise adversely modifies the growth of vegetation, particularly undesirable vegetation, such as weeds, when applied in an appropriate amount.

As used herein, a “herbicidally effective amount” refers to an amount of an active ingredient that causes a “herbicidal effect,” such as, an adversely modifying effect including, for instance, a deviation from natural growth or development, killing, regulation, desiccation, growth inhibition, growth reduction, and retardation.

As used herein, applying a herbicide or herbicidal composition refers to delivering it directly to the targeted vegetation or to the locus thereof or to the area where control of undesired vegetation is desired. Methods of application include, but are not limited to pre-emergently contacting soil or water, post-emergently contacting the undesirable vegetation or area adjacent to the undesirable vegetation.

As used herein, the terms “crops” and “vegetation” can include, for instance, dormant seeds, germinant seeds, emerging seedlings, plants emerging from vegetative propagules, immature vegetation, and established vegetation.

As used herein, immature vegetation refers to small vegetative plants prior to reproductive stage, and mature vegetation refers to vegetative plants during and after the reproductive stage.

As used herein, the ACCase inhibitors that are the aryloxyphenoxypropionate herbicides are generally referred to as their carboxylic acid chemical forms even though they are commonly used in their ester or amide chemical forms (e.g., clodinofop vs. clodinofop-propargyl).

The ACCase inhibitor class of aryloxyphenoxypropionate herbicides contain a chiral carbon atom in the propionic acid portion of the molecule which allows these inhibitors to be provided as a racemic mixture of the two enantiomers (e.g., a 1 to 1 mixture of the R- and S-enantiomers) or as a mixture that is enriched in the more biologically active R-enantiomer (also referred to as the P-enantiomer). Most of the currently marketed products containing aryloxyphenoxypropionate herbicides are enriched in the R-enantiomer.

As used herein, unless otherwise specified, the term “acyl” refers to a group of formula —C(O)R, where R is hydrogen, alkyl (e.g., C₁-C₁₀ alkyl), haloalkyl (C₁-C₈ haloalkyl), alkenyl (C₂-C₈ alkenyl), haloalkenyl (e.g., C₂-C₈ haloalkenyl), alkynyl (e.g., C₂-C₈ alkynyl), alkoxy (C₁-C₈ alkoxy), haloalkoxy (C₁-C₈ alkoxy), aryl, or heteroaryl, arylalkyl (C₇-C₁₀ arylalkyl), as defined below, where “C(O)” or “CO” is short-hand notation for C═O. In some embodiments, the acyl group can be a C₁-C₆ acyl group (e.g., a formyl group, a C i-C₅ alkylcarbonyl group, or a C₁-C₅ haloalkylcarbonyl group). In some embodiments, the acyl group can be a C₁-C₃ acyl group (e.g., a formyl group, a C₁-C₃ alkylcarbonyl group, or a C₁-C₃ haloalkylcarbonyl group).

As used herein, the term “alkyl” refers to saturated, straight-chained or branched saturated hydrocarbon moieties. Unless otherwise specified, C₁-C₂₀ (e.g., C₁-C₁₂, C₁-C₁₀, C₁-C₈, C₁-C₆, C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, and 1-ethyl-2-methyl-propyl. Alkyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxy carbonyl, C₁-C₆, carbamoyl. C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “haloalkyl” refers to straight-chained or branched alkyl groups, wherein these groups the hydrogen atoms may partially or entirely be substituted with halogen atoms. Unless otherwise specified, C₁-C₂₀ (e.g., C₁-C₁₂, C₁-C₁₀, C₁-C₈, C₁-C₆, C₁-C₄) alkyl groups are intended. Examples include chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, and 1,1,1-trifluoroprop-2-yl. Haloalkyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “alkenyl” refers to unsaturated, straight-chained, or branched hydrocarbon moieties containing a double bond. Unless otherwise specified, C₂-C₂₀ (e.g., C₂-C₁₂, C₂-C₁₀, C₂-C₆, C₂-C₆, C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure-CH═CH—CH₃; and 2-propenyl refers to a group with the structure —CH₂—CH═CH₂. Alkenyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

The term “haloalkenyl,” as used herein, refers to an alkenyl group, as defined above, which is substituted by one or more halogen atoms.

As used herein, the term “alkynyl” represents straight-chained or branched hydrocarbon moieties containing a triple bond. Unless otherwise specified, C₂-C₂₀ (e.g., C₂-C₁₂, C₂-C₁₀, C₂-C₈, C₂-C₆, C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “alkoxy” refers to a group of the formula R—O—, where R is unsubstituted or substituted alkyl as defined above. Unless otherwise specified, alkoxy groups wherein R is a C₁-C₂₀ (e.g., C₁-C₁₂, C₁-C₁₀, C₁-C₈, C₁-C₆, C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

As used herein, the term “haloalkoxy” refers to a group of the formula R—O—, where R is unsubstituted or substituted haloalkyl as defined above. Unless otherwise specified, haloalkoxy groups wherein R is a C₁-C₂₀ (e.g., C₁-C₁₂, C₁-C₁₀, C₁-C₈, C₁-C₆, C₁-C₄) alkyl group are intended. Examples include chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, and 1,1,1-trifluoroprop-2-oxy.

As used herein, the term “alkylthio” refers to a group of the formula R—S—, where R is unsubstituted or substituted alkyl as defined above. Unless otherwise specified, alkylthio groups wherein R is a C₁-C₂₀ (e.g., C₁-C₁₂, C₁-C₁₀, C₁-C₈, C₁-C₆, C₁-C₄) alkyl group are intended. Examples include methylthio, ethylthio, propylthio, 1-methylethylthio, butylthio, 1-methyl-propylthio, 2-methylpropylthio, 1,1-dimethylethylthio, pentylthio, 1-methylbutylthio, 2-methylbutylthio, 3-methylbutylthio, 2,2-di-methylpropylthio, 1-ethylpropylthio, hexylthio, 1,1-dimethylpropylthio, 1,2-dimethylpropylthio, 1-methylpentylthio, 2-methylpentylthio, 3-methyl-pentylthio, 4-methyl-pentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio, and 1-ethyl-2-methylpropylthio.

As used herein, the term “haloalkylthio” refers to an alkylthio group as defined above wherein the carbon atoms are partially or entirely substituted with halogen atoms. Unless otherwise specified, haloalkylthio groups wherein R is a C₁-C₂₀ (e.g., C₁-C₁₂, C₁-C₁₀, C₁-C₈, C₁-C₆, C₁-C₄) alkyl group are intended. Examples include chloromethylthio, bromomethylthio, dichloromethylthio, trichloromethylthio, fluoromethylthio, difluoromethylthio, trifluoromethylthio, chlorofluoromethylthio, dichlorofluoro-methylthio, chlorodifluoromethylthio, 1-chloroethylthio, 1-bromoethylthio, 1-fluoroethylthio, 2-fluoroethylthio, 2,2-difluoroethylthio, 2,2,2-trifluoroethylthio, 2-chloro-2-fluoroethylthio, 2-chloro-2-difluoroethylthio, 2,2-dichloro-2-fluoroethylthio, 2,2,2-trichloroethylthio, pentafluoroethylthio, and 1,1,1-trifluoroprop-2-ylthio.

As used herein, the term “aryl,” as well as derivative terms such as aryloxy, refers to groups that include a monovalent aromatic carbocyclic group of from 6 to 14 carbon atoms. Aryl groups can include a single ring or multiple condensed rings. In some embodiments, aryl groups include C₆-C₁₀ aryl groups. Examples of aryl groups include, but are not limited to, phenyl, biphenyl, naphthyl, tetrahydronaphthyl, phenylcyclopropyl, and indanyl. In some embodiments, the aryl group can be a phenyl, indanyl or naphthyl group. The term “heteroaryl”, as well as derivative terms such as “heteroaryloxy”, refers to a 5- or 6-membered aromatic ring containing one or more heteroatoms, viz., N, O or S; these heteroaromatic rings may be fused to other aromatic systems. The aryl or heteroaryl substituents may be unsubstituted or substituted with one or more chemical moieties. Examples of suitable substituents include, for example, hydroxy, nitro, cyano, formyl, C₁-C₆ alkyl, C₂-C₆ alkenyl, C₂-C₆ alkynyl, C₁-C₆ alkoxy, C₁-C₆ haloalkyl, C₁-C₆ haloalkoxy, C₁-C₆ acyl, C₁-C₆ alkylthio, C₁-C₆ alkylsulfinyl, C₁-C₆ alkylsulfonyl, C₁-C₆ alkoxycarbonyl, C₁-C₆ carbamoyl, hydroxycarbonyl, C₁-C₆ alkylcarbonyl, aminocarbonyl, C₁-C₆ alkylaminocarbonyl, C₁-C₆ dialkylaminocarbonyl, provided that the substituents are sterically compatible and the rules of chemical bonding and strain energy are satisfied. Preferred substituents include halogen, C₁-C₂ alkyl and C₁-C₂ haloalkyl.

As used herein, the term “alkylcarbonyl” refers to an unsubstituted or substituted alkyl group bonded to a carbonyl group. C₁-C₃ alkylcarbonyl and C₁-C₃ haloalkylcarbonyl refer to groups wherein a C₁-C₃ unsubstituted or substituted alkyl or haloalkyl group is bonded to a carbonyl group (the group contains a total of 2 to 4 carbon atoms).

As used herein, the term “alkoxycarbonyl” refers to a group of the formula

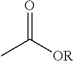

wherein R is unsubstituted or substituted alkyl.

As used herein, the term “arylalkyl” refers to an alkyl group substituted with an unsubstituted or substituted aryl group. C₇-C₁₀ arylalkyl refers to a group wherein the total number of carbon atoms in the group is 7 to 10, not including the carbon atoms present in any substituents of the aryl group.

As used herein, the term “alkylamino” refers to an amino group substituted with one or two unsubstituted or substituted alkyl groups, which may be the same or different.

As used herein, the term “haloalkylamino” refers to an alkylamino group wherein the alkyl carbon atoms are partially or entirely substituted with halogen atoms.

As used herein, C₁-C₆ alkylaminocarbonyl refers to a group of the formula RNHC(O)— wherein R is C₁-C₆ unsubstituted or substituted alkyl, and C₁-C₆ dialkylaminocarbonyl refers to a group of the formula R₂NC(O)— wherein each R is independently C₁-C₆ unsubstituted or substituted alkyl.

As used herein, the term “alkylcarbamyl” refers to a carbamyl group substituted on the nitrogen with an unsubstituted or substituted alkyl group.

As used herein, the term “alkylsulfonyl” refers to a group of the formula

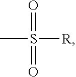

where R is unsubstituted or substituted alkyl.

As used herein, the term “carbamyl” (also referred to as carbamoyl and aminocarbonyl) refers to a group of the formula

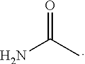

As used herein, the term “dialkylphosphonyl” refers to a group of the formula

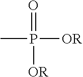

where R is independently unsubstituted or substituted alkyl in each occurrence.

As used herein, C₁-C₆ trialkylsilyl refers to a group of the formula —SiR₃ wherein each R is independently a C₁-C₆ unsubstituted or substituted alkyl group (the group contains a total of 3 to 18 carbon atoms).

As used herein, Me refers to a methyl group; OMe refers to a methoxy group; and i-Pr refers to an isopropyl group.

As used herein, the term “halogen” including derivative terms such as “halo” refers to fluorine, chlorine, bromine and iodine.

As used herein, agriculturally acceptable salts and esters refer to salts and esters that exhibit herbicidal activity, or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending on the pH, may be in the dissociated or undissociated form.

Compounds described herein can include N-oxides. Pyridine N-oxides can be obtained by oxidation of the corresponding pyridines. Suitable oxidation methods are described, for example, in Houben-Weyl, Methoden der organischen Chemie [Methods in organic chemistry], expanded and subsequent volumes to the 4th edition, volume E 7b, p. 565 f.

Pyridine Carboxylic Acid Herbicides

Compositions and methods of the present disclosure can include a pyridine carboxylic acid herbicide defined by Formula (I)

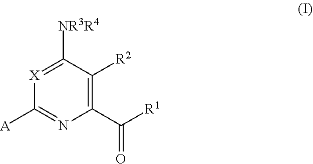

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is one of groups A1 to A36

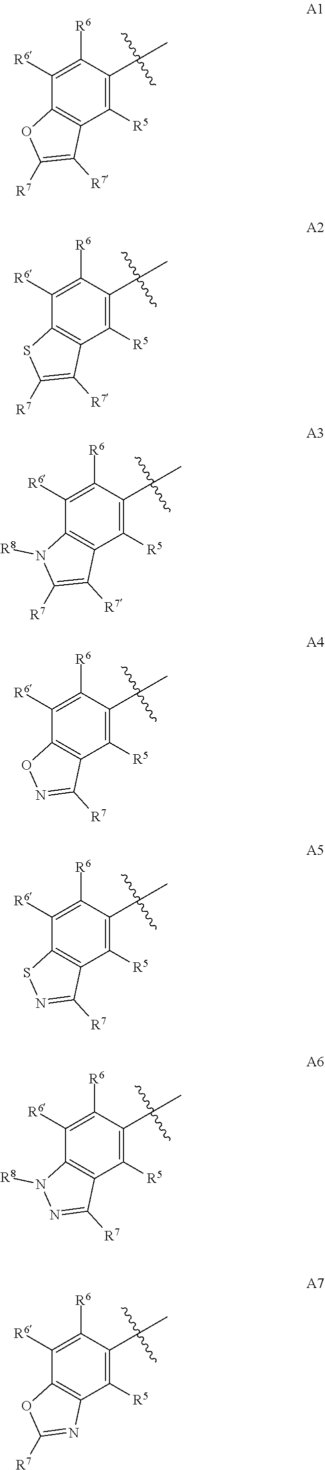

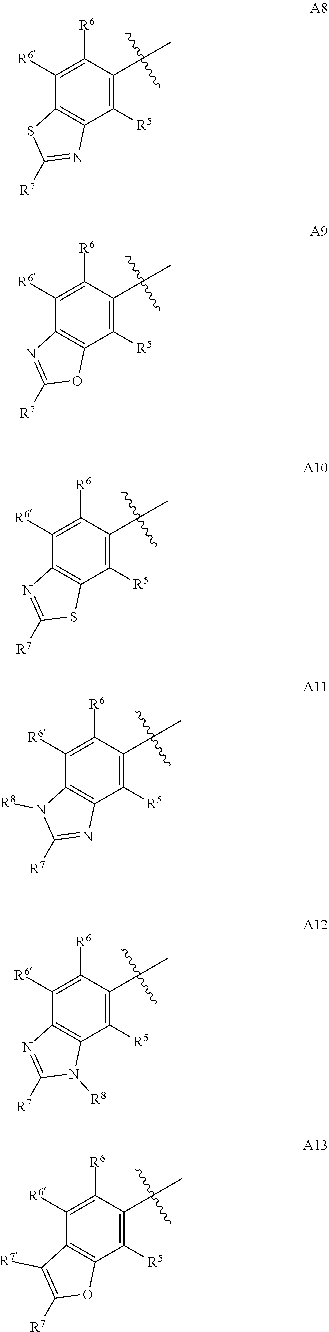

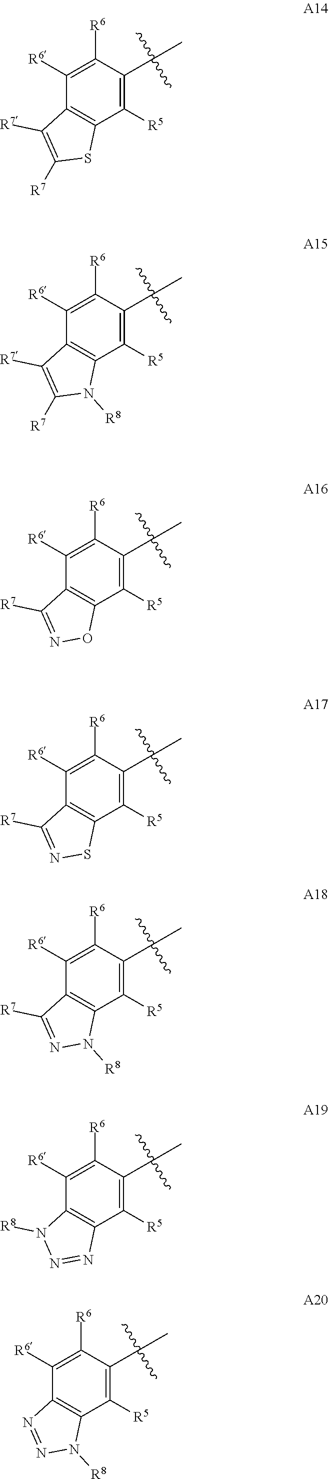

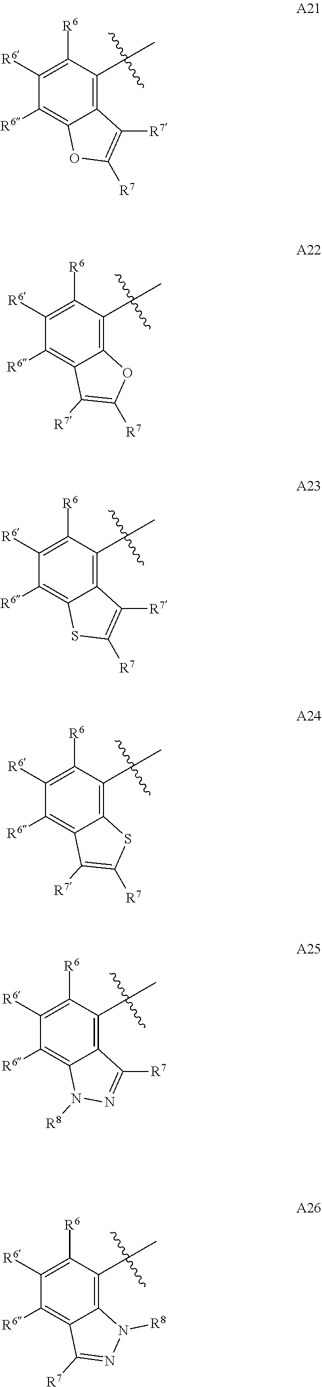

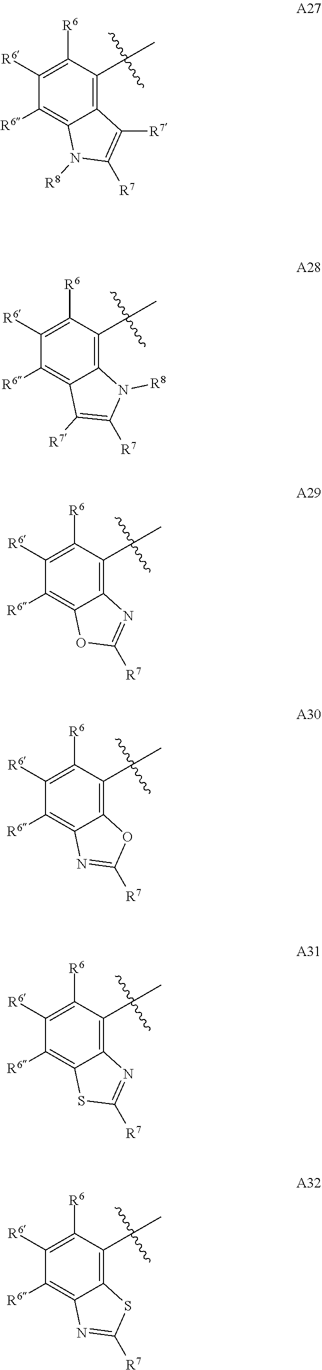

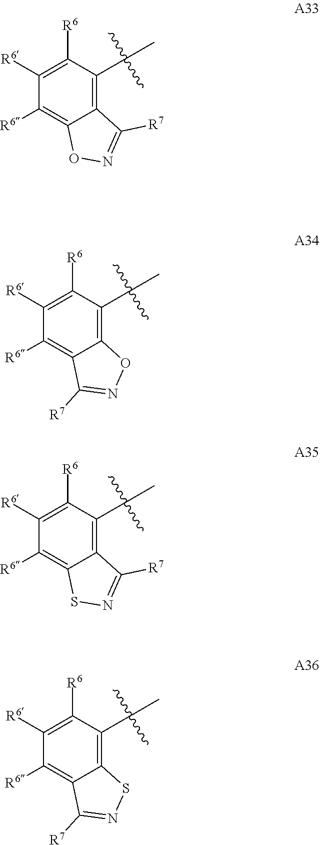

R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments, R¹ is OR^{1′}, wherein R^{1′} is hydrogen, C₁-C₈ alkyl, or C₇-C₁₀ arylalkyl. In some embodiments, R^{1′} is hydrogen or C₁-C₈ alkyl. In some embodiments, R^{1′} is hydrogen.

In some embodiments, R² is halogen, C₁-C₄ alkyl, C₁-C₄ haloalkyl, C₂-C₄ alkynyl, C₂-C₄-alkenyl, C₂-C₄ haloalkenyl, C₁-C₄-alkoxy, or C₁-C₄ haloalkoxy. In some embodiments, R² is halogen, C₂-C₄-alkenyl, C₂-C₄ haloalkenyl, or C₁-C₄-alkoxy. In some embodiments, R² is halogen. In some embodiments, R² is C₂-C₄-alkenyl or C₂-C₄ haloalkenyl. In some embodiments, R² is C₁-C₄ alkoxy. In some embodiments, R² is Cl, OMe, vinyl, or 1-propenyl. In some embodiments, R² is Cl. In some embodiments, R² is OMe. In some embodiments, R² is vinyl or 1-propenyl.

In some embodiments, R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy, or C₁-C₆ alkylamino. In some embodiments, R³ and R⁴ are independently hydrogen, C₁-C₆ alkyl, C₁-C₆ haloalkyl, C₃-C₆ alkenyl, C₃-C₆ haloalkenyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₁-C₆ alkoxy or C₁-C₆ alkylamino. In some embodiments, R³ and R⁴ are independently hydrogen, C₁-C₆ alkyl, C₁-C₆ haloalkyl, C₃-C₆ alkenyl, C₃-C₆ haloalkenyl, formyl, C₁-C₃ alkylcarbonyl, or C₁-C₃ haloalkylcarbonyl. In some embodiments, at least one of R³ and R⁴ are hydrogen. In some embodiments, R³ and R⁴ are both hydrogen.

In some embodiments, X is N, CH or CF. In some embodiments, X is N. In some embodiments, X is CH. In some embodiments, X is CF. In other embodiments, X is C—CH₃.

In some embodiments, A is A1, A2, A3, A4, A5, A6, A7, A8, A9, A10, A11, A12, A13, A14, A15, A16, A17, A18, A19, or A20. In other embodiments, A is one of A21, A22, A23, A24, A25, A26, A27, A28, A29, A30, A31, A32, A33, A34, A35, and A36.

In some embodiments, A is one of groups A1, A2, A3, A7, A8, A9, A10, A13, A14, and A15. In some embodiments, A is one of groups A1, A2, A3, A13, A14, and A15. In some embodiments, A is one of groups A13, A14, and A15. In some embodiments, A is A15.

In some embodiments, R⁵ is hydrogen, halogen, C₁-C₄ alkyl, C₁-C₄ haloalkyl, C₁-C₃ alkoxy, C₁-C₃ haloalkoxy, C₁-C₃ alkylthio, C₁-C₃ haloalkylthio, or amino. In some embodiments, R⁵ is hydrogen, halogen, C₁-C₄ alkyl, C₁-C₄ haloalkyl, C₁-C₃ alkoxy, C₁-C₃ haloalkoxy, or amino. In some embodiments, R⁵ is hydrogen, halogen, C₁-C₄ alkyl or C₁-C₄ alkoxy. In some embodiments, R⁵ is hydrogen or F. In some embodiments, R⁵ is hydrogen.

In other embodiments, R⁵ is F.

In some embodiments, R⁶ is hydrogen, halogen, C₁-C₄ alkyl, C₁-C₄ haloalkyl, C₁-C₃ alkoxy, or C₁-C₃ haloalkoxy. In some embodiments, R⁶ is hydrogen or fluorine. In some embodiments, R⁶ is hydrogen. In some embodiments, R⁶ is fluorine.

In some embodiments, R^{6′} is hydrogen or halogen. In some embodiments, R^{6′} is hydrogen, F, or Cl. In some embodiments, R^{6′} is hydrogen or F. In some embodiments, R^{6′} is hydrogen.

In some embodiments, R^{6″} is hydrogen, halogen, C₁-C₄ alkyl, C₁-C₄ haloalkyl, cyclopropyl, C₂-C₄ alkynyl, CN, or NO₂. In some embodiments, R^{6″} is hydrogen. In some embodiments, R^{6″} is halogen. In some embodiments, R^{6″} is C₁-C₄ alkyl. In some embodiments, R^{6″} is C₁-C₄ haloalkyl. In some embodiments, R^{6″} is cyclopropyl. In some embodiments, R^{6″} is C₂-C₄ alkynyl. In some embodiments, R^{6″} is CN. In some embodiments, R^{6″} is NO₂.

In some embodiments:

X is N, CH, CF, CCl, or CBr;

R¹ is OR^{1′}, wherein R^{1′} is hydrogen or C₁-C₄ alkyl;

R² is chlorine;

R³ and R⁴ are hydrogen;

A is A1, A2, A3, A4, A5, A6, A7, A8, A9, A10, A11, A12, A13, A14, A15, A16, A17, A18, A19, or A20;

R⁵ is hydrogen, halogen, OH, amino, CN, C₁-C₃ alkyl, C₁-C₃ alkoxy, C₁-C₃ alkylamino, or cyclopropyl;

R⁶, R^{6′}, and R^{6″} are independently hydrogen, halogen, OH, NH₂, CN, C₁-C₃ alkyl, C₁-C₃ alkoxy, cyclopropyl, or vinyl;

R⁷ and R^{7′} are independently hydrogen, halogen, C₁-C₃ alkyl, C₁-C₃ alkoxy, C₁-C₃ alkylthio, cyclopropyl, or C₁-C₃ alkylamino, or phenyl; and

R⁸ is hydrogen, C₁-C₃ alkyl, phenyl, or C₁-C₃ alkylcarbonyl.

In some embodiments, R² is halogen, C₂-C₄-alkenyl, C₂-C₄ haloalkenyl, or C₁-C₄-alkoxy; R³ and R⁴ are both hydrogen; and X is N, CH, or CF.

In some embodiments, R² is halogen; R³ and R⁴ are both hydrogen; and X is N, CH, or CF.

In some embodiments, R² is C₂-C₄-alkenyl or C₂-C₄ haloalkenyl; R³ and R⁴ are both hydrogen; and X is N, CH, or CF.

In some embodiments, R² is C₁-C₄-alkoxy; R³ and R⁴ are both hydrogen; and X is N, CH, or CF.

In some embodiments, R² is halogen, C₂-C₄-alkenyl, C₂-C₄ haloalkenyl, or C₁-C₄-alkoxy; R³ and R⁴ are both hydrogen; X is N, CH, or CF; R⁵ is hydrogen or F; R⁶ is hydrogen or F; R^{6′} is hydrogen; R^{6″}, if applicable to the relevant A group, is hydrogen or halogen; and R⁷ and R^{7′}, if applicable to the relevant A group, are independently hydrogen or halogen.

In some embodiments, R² is halogen, C₁-C₄-alkoxy, or C₂-C₄-alkenyl; R³ and R⁴ are hydrogen; X is N, CH, or CF; and A is one of groups A1 to A20.

In some embodiments, R² is chlorine; R³ and R⁴ are hydrogen; X is N, CH, or CF; A is one of groups A1 to A20; R⁵ is hydrogen or F; R⁶ and R^{6′} are independently hydrogen or F; and R⁷ and R^{7′}, if applicable to the relevant A group, are independently hydrogen, halogen, C₁-C₄ alkyl, or C₁-C₄ haloalkyl.

In some embodiments, R² is chlorine, methoxy, vinyl, or 1-propenyl; R³ and R⁴ are hydrogen; and X is N, CH, or CF.

In some embodiments, R² is chlorine; R³ and R⁴ are hydrogen; and X is N, CH, or CF.

In some embodiments, R² is vinyl or 1-propenyl; R³ and R⁴ are hydrogen; and X is N, CH, or CF.

In some embodiments, R² is methoxy; R³ and R⁴ are hydrogen; and X is N, CH, or CF.

In some embodiments, R² is chlorine; R³ and R⁴ are hydrogen; and X is N.

In some embodiments, R² is chlorine; R³ and R⁴ are hydrogen; and X is CH.

In some embodiments, R² is chlorine; R³ and R⁴ are hydrogen; and X is CF.

In some embodiments, R² is chlorine; R³ and R⁴ are hydrogen; X is CF; A is one of A1, A2, A3, A7, A8, A9, A10, A13, A14, or A15; R⁵ is F; and R⁶ is H.

In some embodiments, R² is chlorine, methoxy, vinyl, or 1-propenyl; R³ and R⁴ are hydrogen; X is N, CH, or CF; and A is one of A21-A36.

In some embodiments, R² is chlorine, methoxy, vinyl, or 1-propenyl; R³ and R⁴ are hydrogen; X is CF; and A is one of

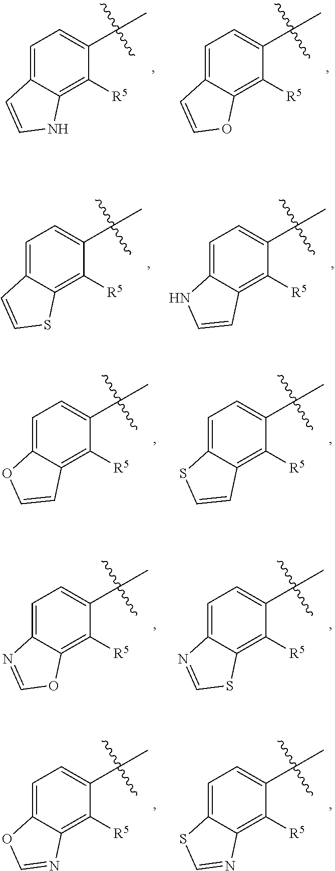

wherein R⁵ is hydrogen or F.

In some embodiments, R² is chlorine, methoxy, vinyl, or 1-propenyl; R³ and R⁴ are hydrogen; X is N, CH, or CF; and A is

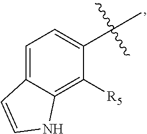

NH where R⁵ is hydrogen or F.

In some embodiments, R² is chlorine, methoxy, vinyl, or 1-propenyl; R³ and R⁴ are hydrogen; X is N, CH, or CF; and A is

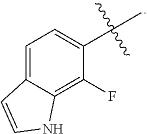 [SMILES: *c1ccc2cc[nH]c2c1F]

In some embodiments, R² is chlorine, methoxy, vinyl, or 1-propenyl; R³ and R⁴ are hydrogen; X is CF; and A is

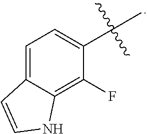 [SMILES: *c1ccc2cc[nH]c2c1F]

In some embodiments, the pyridine carboxylic acid herbicide can contain a compound defined by Formula (I)

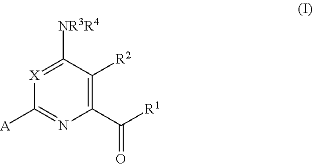

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof,

with the proviso that the pyridine carboxylic acid herbicide is not a compound defined by Formula (I)

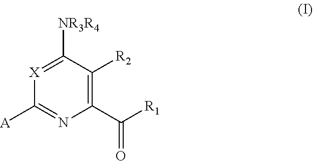

wherein

X is N, CH, CF, CCl, or CBr;

R¹ is OR^{1′}, wherein R^{1′} is hydrogen or C₁-C₄ alkyl;

R² is chlorine;

R³ and R⁴ are hydrogen;

A is A1, A2, A3, A4, A5, A6, A7, A8, A9, A10, A11, A12, A13, A14, A15, A16, A17, A18, A19, or A20;

R⁵ is hydrogen, halogen, OH, amino, CN, C₁-C₃ alkyl, C₁-C₃ alkoxy, C₁-C₃ alkylamino, or cyclopropyl;

R⁶, R^{6′}, and R^{6″} are independently hydrogen, halogen, OH, NH₂, CN, C₁-C₃ alkyl, C₁-C₃ alkoxy, cyclopropyl, or vinyl;

R⁷ and R^{7′} are independently hydrogen, halogen, C₁-C₃ alkyl, C₁-C₃ alkoxy, C₁-C₃ alkylthio, cyclopropyl, C₁-C₃ alkylamino, or phenyl; and

R⁸ is hydrogen, C₁-C₃ alkyl, phenyl, or C₁-C₃ alkylcarbonyl;

or an agriculturally acceptable N-oxide or salt thereof.

In some of these embodiments, RI is OR^{1′}. In some of these embodiments, X is CF. In some of these embodiments, A is A15. In some of these embodiments, R⁵ is F.

In some embodiments:

X is CY, wherein Y is C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆alkoxycarbonyl, C₁-C₆ alkylcarbamyl, C₁-C₆ alkylsulfonyl, C₁-C₆ trialkylsilyl, or phenyl.

In some of these embodiments, R¹ is OR. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆alkoxycarbonyl, C₁-C₆ alkylcarbamyl, C₁-C₆ alkylsulfonyl, C₁-C₆ trialkylsilyl, or phenyl;

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is F, Br, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁ alkyl, C₃-C₆ cycloalkyl, phenyl, substituted phenyl, C₁-C₁₀ alkoxy, or OH;

R³ and R⁴ are independently C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, or A20;

R⁵ is C₁-C₄ alkyl, C₁-C₄ haloalkyl, halocyclopropyl, C₂-C₄ alkenyl, C₂-C₄ haloalkenyl, C₂-C₄ alkynyl, C₁-C₃ haloalkoxy, C₁-C₃ alkylthio, C₁-C₃ haloalkylthio, C₂-C₄ alkylamino, or C₂-C₄ haloalkylamino;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, or A20;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently C₁-C₄ alkyl, C₁-C₄ haloalkyl, halocyclopropyl, C₃-C₄ alkenyl, C₂-C₄ haloalkenyl, C₂-C₄ alkynyl, C₁-C₃ haloalkoxy, C₁-C₃ alkylthio, C₁-C₃ haloalkylthio, C₁-C₄ alkylamino or C₂-C₄ haloalkylamino, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR^{1′}. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl; R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, or A18;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently C₁-C₄ alkyl, C₁-C₄ haloalkyl, halocyclopropyl, C₂-C₄ alkenyl, C₂-C₄ haloalkenyl, C₂-C₄ alkynyl, C₁-C₃ haloalkoxy, C₁-C₃ haloalkylthio, amino, C₄ alkylamino, or C₂-C₄ haloalkylamino; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A3, A6, A11, A12, A15, A18, A19, or A20;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is C₃-C₆ alkyl, C₁-C₆ haloalkyl, C₃-C₆ alkenyl, C₃-C₆ haloalkenyl, C₃-C₆ alkynyl, formyl, C₁-C₃ haloalkylcarbonyl, C₁-C₆ alkoxycarbonyl, C₁-C₆ alkylcarbamyl, C₁-C₆ alkylsulfonyl, or C₁-C₆ trialkylsilyl.

In some of these embodiments, R¹ is OR^{1′}. In some of these embodiments, X is CF. In some of these embodiments, A is A15. In some of these embodiments, R⁵ is F.

In certain embodiments, the pyridine carboxylic acid herbicide can contain a compound defined by Formula (II):

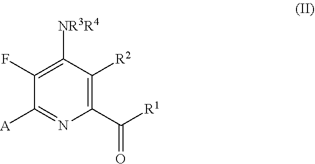

wherein

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments:

R¹ is OR^{1′}, wherein R^{1′} is hydrogen, C₁-C₈ alkyl, or C₇-C₁₀ arylalkyl;

R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio.

R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;

A is A1, A2, A3, A7, A8, A9, A10, A11, A12, A13, A14, A15, A21, A22, A23, A24, A27, A28, A29, A30, A31, or A32;

R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;

R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and

R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

In some embodiments, RI is OR^{1′}, wherein R^{1′} is hydrogen, C₁-C₈ alkyl, or C₇-C₁₀ arylalkyl.

In some embodiments, R² is halogen, C₂-C₄-alkenyl, C₂-C₄ haloalkenyl, or C₁-C₄-alkoxy. In certain embodiments, R² is Cl, methoxy, vinyl, or 1-propenyl. In some embodiments, R³ and R⁴ are hydrogen.

In some embodiments, A is A1, A2, A3, A7, A8, A9, A10, A13, A14, or A15. In certain embodiments, A is A1, A2, A3, A13, A14, or A15. In certain embodiments, A is A15.

In some embodiments, R⁵ is hydrogen or F. In certain embodiments, R⁵ is F. In certain embodiments, R⁵ is H.

In some embodiments, R⁶ is hydrogen or F. In certain embodiments, R⁶ is F. In certain embodiments, R⁶ is H. In some embodiments, R^{6″} is hydrogen, halogen, C₁-C₄ alkyl, C₁-C₄ haloalkyl, cyclopropyl, C₂-C₄ alkynyl, CN, or NO₂. In certain embodiments, R⁶, R^{6′}, and R^{6″} are all hydrogen.

In certain embodiments, R² is Cl, methoxy, vinyl, or 1-propenyl; R³ and R⁴ are hydrogen; A is A15; R⁵ is hydrogen or F; R⁶ is hydrogen or F; and R^{6″} is hydrogen, halogen, C₁-C₄ alkyl, C₁-C₄ haloalkyl, cyclopropyl, C₂-C₄ alkynyl, CN, or NO₂.

In certain embodiments, the pyridine carboxylic acid herbicide can contain a compound defined by Formula (III):

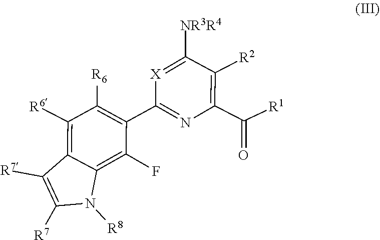

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments:

X is N, CH, CF, CCl, or CBr;

R¹ is OR^{1′}, wherein R^{1′} is hydrogen, C₁-C₈ alkyl, or C₇-C₁₀ arylalkyl;

R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio;

R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;

R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and

R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

In some embodiments, X is N, CH or CF. In some embodiments, X is N. In some embodiments, X is CH. In some embodiments, X is CF. In other embodiments, X is C—CH₃.

In some embodiments, R² is halogen, C₂-C₄-alkenyl, C₂-C₄ haloalkenyl, or C₁-C₄-alkoxy. In certain embodiments, R² is Cl, methoxy, vinyl, or 1-propenyl. In some embodiments, R³ and R⁴ are hydrogen.

In some embodiments, R⁶ is hydrogen or F. In certain embodiments, R⁶ is F. In certain embodiments, R⁶ is H. In some embodiments, R^{6′} is hydrogen, halogen, C₁-C₄ alkyl, C₁-C₄ haloalkyl, cyclopropyl, C₂-C₄ alkynyl, CN, or NO₂. In certain embodiments, R⁶ and R^{6′} are both hydrogen.

In certain embodiments, R⁷ and R^{7′} are both hydrogen.

In certain embodiments, R⁶, R^{6′}, R⁷, and R^{7′} are all hydrogen.

In certain embodiments, X is CF, R¹ is OR^{1′}, wherein R^{1′} is hydrogen, C₁-C₈ alkyl, or C₇-C₁₀ arylalkyl; R² is Cl, methoxy, vinyl, or 1-propenyl; R³ and R⁴ are hydrogen; R⁶ is hydrogen or F; and R^{6′} is hydrogen, halogen, C₁-C₄ alkyl, C₁-C₄ haloalkyl, cyclopropyl, C₂-C₄ alkynyl, CN, or NO₂.

In certain embodiments, the pyridine carboxylic acid herbicide is one of Compounds 1-7, the structures of which are shown in the table below.

| Compound | |
|---|---|
| No. | Structure |
| 1 | 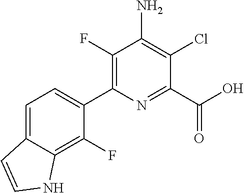 [SMILES: Nc1c(F)c(-c2ccc3cc[nH]c3c2F)nc(C(=O)O)c1Cl] |
| 2 | 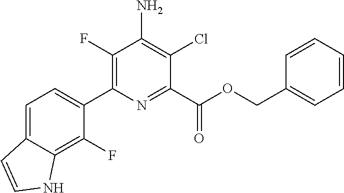 [SMILES: Nc1c(F)c(-c2ccc3cc[nH]c3c2F)nc(C(=O)OCc2ccccc2)c1Cl] |
| 3 | 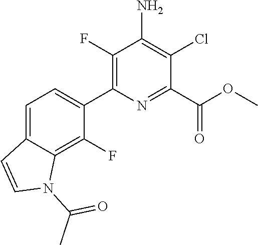 [SMILES: COC(=O)c1nc(-c2ccc3ccn(C(C)=O)c3c2F)c(F)c(N)c1Cl] |
| 4 | 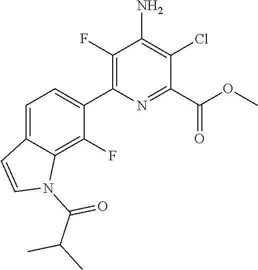 [SMILES: COC(=O)c1nc(-c2ccc3ccn(C(=O)C(C)C)c3c2F)c(F)c(N)c1Cl] |
| 5 | 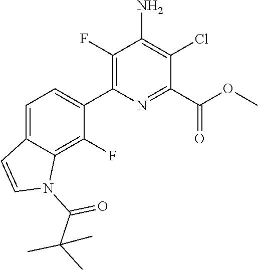 [SMILES: COC(=O)c1nc(-c2ccc3ccn(C(=O)C(C)(C)C)c3c2F)c(F)c(N)c1Cl] |
| 6 | 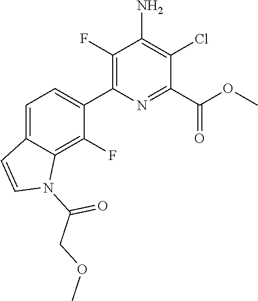 [SMILES: COCC(=O)n1ccc2ccc(-c3nc(C(=O)OC)c(Cl)c(N)c3F)c(F)c21] |
| 7 | 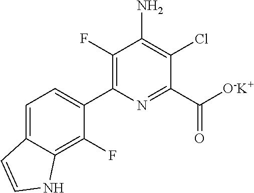 |

In certain embodiments, the pyridine carboxylic acid herbicide I is 4-amino-3-chloro-5-fluoro-6-(7-fluoro-1H-indol-6-yl) picolinic acid or an agriculturally acceptable N-oxide, salt, or ester thereof.

In some embodiments, the pyridine carboxylic acid herbicide can be provided as an agriculturally acceptable salt. Exemplary agriculturally acceptable salts of the pyridine carboxylic acid herbicides include, but are not limited to, sodium salts, potassium salts, ammonium salts or substituted ammonium salts, in particular mono-, di- and tri-C₁-C₈-alkylammonium salts such as methyl ammonium, dimethylammonium and isopropylammonium, mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, olamine salts, diglycolamine salts, choline salts, and quaternary ammonium salts such as those represented by the formula R⁹R¹⁰R¹¹R¹²N⁺ and wherein R⁹, R¹⁰, R¹¹ and R¹² (e.g., R⁹-R¹²) each independently can represent hydrogen, C₁-C₁₀ alkyl, C₂-C₈ alkenyl, C₂-C₈ alkynyl, C₁-C₈ alkoxy, C₁-C₈ alkylthio, or aryl groups, provided that R⁹-R¹² are sterically compatible.

In some embodiments, the pyridine carboxylic acid herbicide can be provided as an agriculturally acceptable ester. Suitable esters include, but are not limited to, C₁-C₈-alkyl esters and C₁-C₄-alkoxy-C₂-C₄-alkyl esters, such as methyl esters, ethyl esters, isopropyl, butyl, hexyl, heptyl, isoheptyl, isooctyl, 2-ethylhexyl, butoxyethyl esters, substituted or unsubstituted aryl esters, orthoesters, and substituted or unsubstituted arylalkyl esters. In some embodiments, the ester can contain a C₁-C₈ alkyl ester, wherein the C₁-C₈ alkyl group is optionally substituted with one or more moieties selected from the group of cyano, C₂-C₅ alkoxy, and C₂-C₅ alkylsulfonyl. For example, the ester can contain a methyl, —CH₂CN, —CH₂OCH₃, —CH₂OCH₂CH₂OCH₃, or —CH₂CH₂SO₂CH₃ ester.

In some embodiments, the ester is a substituted or unsubstituted benzyl ester. In some embodiments, the ester is a benzyl ester optionally substituted with one or more moieties selected from the group of halogen, C₁-C₂ alkyl, C₁-C₂ haloalkyl, and combinations thereof. In some embodiments, the ester is a methyl ester.

The pyridine carboxylic acid herbicide, or an agriculturally acceptable N-oxide, salt, or ester thereof, can be applied to vegetation or an area adjacent the vegetation or applied to soil or water to prevent the emergence or growth of vegetation in an amount sufficient to induce a herbicidal effect. In some embodiments, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of 0.5 grams acid equivalent per hectare (g ae/ha) or greater (e.g., 0.6 g ae/ha or greater, 0.7 g ae/ha or greater, 0.8 g ae/ha or greater, 0.9 g ae/ha or greater, 1 g ae/ha or greater, 1.1 g ae/ha or greater, 1.2 g ae/ha or greater, 1.3 g ae/ha or greater, 1.4 g ae/ha or greater, 1.5 g ae/ha or greater, 1.6 g ae/ha or greater, 1.7 g ae/ha or greater, 1.8 g ae/ha or greater, 1.9 g ae/ha or greater, 2 g ae/ha or greater, 2.25 g ae/ha or greater, 2.5 g ae/ha or greater, 2.75 g ae/ha or greater, 3 g ae/ha or greater, 4 g ae/ha or greater, 5 g ae/ha or greater, 6 g ae/ha or greater, 7 g ae/ha or greater, 8 g ae/ha or greater, 9 g ae/ha or greater, 10 g ae/ha or greater, 11 g ae/ha or greater, 12 g ae/ha or greater, 13 g ae/ha or greater, 14 g ae/ha or greater, 15 g ae/ha or greater, 16 g ae/ha or greater, 17 g ae/ha or greater, 18 g ae/ha or greater, 19 g ae/ha or greater, 20 g ae/ha or greater, 21 g ae/ha or greater, 22 g ae/ha or greater, 23 g ae/ha or greater, 24 g ae/ha or greater, 25 g ae/ha or greater, 26 g ae/ha or greater, 27 g ae/ha or greater, 28 g ae/ha or greater, 29 g ae/ha or greater, 30 g ae/ha or greater, 31 g ae/ha or greater, 32 g ae/ha or greater, 33 g ae/ha or greater, 34 g ae/ha or greater, 35 g ae/ha or greater, 36 g ae/ha or greater, 37 g ae/ha or greater, 38 g ae/ha or greater, 39 g ae/ha or greater, 40 g ae/ha or greater, 41 g ae/ha or greater, 42 g ae/ha or greater, 43 g ae/ha or greater, 44 g ae/ha or greater, 45 g ae/ha or greater, 46 g ae/ha or greater, 47 g ae/ha or greater, 48 g ae/ha or greater, 49 g ae/ha or greater, 50 g ae/ha or greater, 55 g ae/ha or greater, 60 g ae/ha or greater, 65 g ae/ha or greater, 70 g ae/ha or greater, 75 g ae/ha or greater, 80 g ae/ha or greater, 85 g ae/ha or greater, 90 g ae/ha or greater, 95 g ae/ha or greater, 100 g ae/ha or greater, 110 g ae/ha or greater, 120 g ae/ha or greater, 130 g ae/ha or greater, 140 g ae/ha or greater, 150 g ae/ha or greater, 160 g ae/ha or greater, 170 g ae/ha or greater, 180 g ae/ha or greater, 190 g ae/ha or greater, 200 g ae/ha or greater, 210 g ae/ha or greater, 220 g ae/ha or greater, 230 g ae/ha or greater, 240 g ae/ha or greater, 250 g ae/ha or greater, 260 g ae/ha or greater, 270 g ae/ha or greater, 280 g ae/ha or greater, or 290 g ae/ha or greater).

In some embodiments, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of 300 g ae/ha or less (e.g., 290 g ae/ha or less, 280 g ae/ha or less, 270 g ae/ha or less, 260 g ae/ha or less, 250 g ae/ha or less, 240 g ae/ha or less, 230 g ae/ha or less, 220 g ae/ha or less, 210 g ae/ha or less, 200 g ae/ha or less, 190 g ae/ha or less, 180 g ae/ha or less, 170 g ae/ha or less, 160 g ae/ha or less, 150 g ae/ha or less, 140 g ae/ha or less, 130 g ae/ha or less, 120 g ae/ha or less, 110 g ae/ha or less, 100 g ae/ha or less, 95 g ae/ha or less, 90 g ae/ha or less, 85 g ae/ha or less, 80 g ae/ha or less, 75 g ae/ha or less, 70 g ae/ha or less, 65 g ae/ha or less, 60 g ae/ha or less, 55 g ae/ha or less, 50 g ae/ha or less, 49 g ae/ha or less, 48 g ae/ha or less, 47 g ae/ha or less, 46 g ae/ha or less, 45 g ae/ha or less, 44 g ae/ha or less, 43 g ae/ha or less, 42 g ae/ha or less, 41 g ae/ha or less, 40 g ae/ha or less, 39 g ae/ha or less, 38 g ae/ha or less, 37 g ae/ha or less, 36 g ae/ha or less, 35 g ae/ha or less, 34 g ae/ha or less, 33 g ae/ha or less, 32 g ae/ha or less, 31 g ae/ha or less, 30 g ae/ha or less, 29 g ae/ha or less, 28 g ae/ha or less, 27 g ae/ha or less, 26 g ae/ha or less, 25 g ae/ha or less, 24 g ae/ha or less, 23 g ae/ha or less, 22 g ae/ha or less, 21 g ae/ha or less, 20 g ae/ha or less, 19 g ae/ha or less, 18 g ae/ha or less, 17 g ae/ha or less, 16 g ae/ha or less, 15 g ae/ha or less, 14 g ae/ha or less, 13 g ae/ha or less, 12 g ae/ha or less, 11 g ae/ha or less, 10 g ae/ha or less, 9 g ae/ha or less, 8 g ae/ha or less, 7 g ae/ha or less, 6 g ae/ha or less, 5 g ae/ha or less, 4 g ae/ha or less, 3 g ae/ha or less, 2.75 g ae/ha or less, 2.5 g ae/ha or less, 2.25 g ae/ha or less, 2 g ae/ha or less, 1.9 g ae/ha or less, 1.8 g ae/ha or less, 1.7 g ae/ha or less, 1.6 g ae/ha or less, 1.5 g ae/ha or less, 1.4 g ae/ha or less, 1.3 g ae/ha or less, 1.2 g ae/ha or less, 1.1 g ae/ha or less, 1 g ae/ha or less, 0.9 g ae/ha or less, 0.8 g ae/ha or less, 0.7 g ae/ha or less, or 0.6 g ae/ha or less).

The pyridine carboxylic acid herbicide or an agriculturally acceptable N-oxide, salt, or ester thereof can be applied to vegetation or an area adjacent the vegetation or applied to soil or water to prevent the emergence or growth of vegetation in an amount ranging from any of the minimum values described above to any of the maximum values described above. In some embodiments, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of from 0.5-300 g ae/ha (e.g., from 0.5-5 g ae/ha, from 2.5-40 g ae/ha, from 0.5-40 g ae/ha, from 0.5-2.5 g ae/ha, from 2-150 g ae/ha, from 5-75 g ae/ha, from 5-40 g ae/ha, from 30-40 g ae/ha, or from 5-15 g ae/ha). In some embodiments, the pyridine carboxylic acid herbicide, or an agriculturally acceptable N-oxide, salt, or ester thereof, is applied in an amount from 30-40 g ae/ha. In some embodiments, the pyridine carboxylic acid herbicide, or an agriculturally acceptable N-oxide, salt, or ester thereof, is applied in an amount from 5-40 g ae/ha.

ACCase Inhibitors

In addition to the pyridine carboxylic acid herbicide or agriculturally acceptable N-oxide, salt or ester thereof, the compositions can include an acetyl CoA carboxylase (ACCase) inhibitor. ACCase inhibitors inhibit lipid biosynthesis in the plant. Examples of ACCase inhibitors include aryloxyphenoxypropionates, cyclohexanediones, and phenylpyrazolines. In some embodiments, the ACCase inhibitor can include an aryloxyphenoxypropionate herbicide. In some embodiments, the ACCase inhibitor can include a cyclohexanedione herbicide. In some embodiments, the ACCase inhibitor can include a phenylpyrazoline herbicide.

In some embodiments, the composition can include an ACCase inhibitor selected from the group of cyclohexanediones, aryloxyphenoxypropionates, phenylpyrazolines and combinations thereof. In some cases, the composition can include clodinafop, cyhalofop, diclofop, fenoxaprop, fluazifop, haloxyfop, metamifop, propaquizafop, quizalofop, or agriculturally acceptable salts and esters thereof, and combinations thereof. In some cases, the composition can include, alloxydim, butroxydim, clethodim, cycloxydim, profoxydim, sethoxydim, tepraloxydim, tralkoxydim, or agriculturally acceptable salts thereof, and combinations thereof. In some cases, the composition can include pinoxaden.

The ACCase inhibitor or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the ACCase inhibitor or agriculturally acceptable salt or ester thereof is applied to vegetation or an area adjacent the vegetation or applied to soil or water to prevent the emergence or growth of vegetation in an amount of 1 g ai/ha or more (e.g., 1.5 g ai/ha or more, 2 g ai/ha or more, 2.5 g ai/ha or more, 3 g ai/ha or more, 3.5 g ai/ha or more, 4 g ai/ha or more, 4.5 g ai/ha or more, 5 g ai/ha or more, 6 g ai/ha or more, 7 g ai/ha or more, 8 g ai/ha or more, 9 g ai/ha or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 210 g ai/ha or more, 220 g ai/ha or more, 230 g ai/ha or more, 240 g ai/ha or more, 250 g ai/ha or more, 260 g ai/ha or more, 270 g ai/ha or more, 280 g ai/ha or more, 290 g ai/ha or more, 300 g ai/ha or more, 310 g ai/ha or more, 320 g ai/ha or more, 330 g ai/ha or more, 340 g ai/ha or more, 350 g ai/ha or more, 360 g ai/ha or more, 370 g ai/ha or more, 380 g ai/ha or more, 390 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 625 g ai/ha or more, 650 g ai/ha or more, 675 g ai/ha or more, 700 g ai/ha or more, 725 g ai/ha or more, 750 g ai/ha or more, 775 g ai/ha or more, 800 g ai/ha or more, 825 g ai/ha or more, 850 g ai/ha or more, 875 g ai/ha or more, 900 g ai/ha or more, 925 g ai/ha or more, 950 g ai/ha or more, 975 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1550 g ai/ha or more, 1600 g ai/ha or more, 1650 g ai/ha or more, 1660 g ai/ha or more, 1670 g ai/ha or more, 1680 g ai/ha or more, or 1690 g ai/ha or more).

In some embodiments, the ACCase inhibitor or agriculturally acceptable salt or ester thereof is applied to vegetation or an area adjacent the vegetation or applied to soil or water to prevent the emergence or growth of vegetation in an amount of 1700 g ai/ha or less (e.g., 1690 g ai/ha or less, 1680 g ai/ha or less, 1670 g ai/ha or less, 1660 g ai/ha or less, 1650 g ai/ha or less, 1600 g ai/ha or less, 1550 g ai/ha or less, 1500 g ai/ha or less, 1450 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 975 g ai/ha or less, 950 g ai/ha or less, 925 g ai/ha or less, 900 g ai/ha or less, 875 g ai/ha or less, 850 g ai/ha or less, 825 g ai/ha or less, 800 g ai/ha or less, 775 g ai/ha or less, 750 g ai/ha or less, 725 g ai/ha or less, 700 g ai/ha or less, 675 g ai/ha or less, 650 g ai/ha or less, 625 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 390 g ai/ha or less, 380 g ai/ha or less, 370 g ai/ha or less, 360 g ai/ha or less, 350 g ai/ha or less, 340 g ai/ha or less, 330 g ai/ha or less, 320 g ai/ha or less, 310 g ai/ha or less, 300 g ai/ha or less, 290 g ai/ha or less, 280 g ai/ha or less, 270 g ai/ha or less, 260 g ai/ha or less, 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9 g ai/ha or less, 8 g ai/ha or less, 7 g ai/ha or less, 6 g ai/ha or less, 5 g ai/ha or less, 4.5 g ai/ha or less, 4 g ai/ha or less, 3.5 g ai/ha or less, 3 g ai/ha or less, 2.5 g ai/ha or less, 2 g ai/ha or less, or 1.5 g ai/ha or less).

The ACCase inhibitor or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the ACCase inhibitor or agriculturally acceptable salt or ester thereof is applied to vegetation or an area adjacent the vegetation or applied to soil or water to prevent the emergence or growth of vegetation in an amount of 1-1700 g ai/ha (e.g., 2-1500 g ai/ha, 2-1250 g ai/ha, 1250-1700 g ai/ha, 10-1200 g ai/ha, 10-1150 g ai/ha, 10-1100 g ai/ha, 10-1050 g ai/ha, 1-1000 g ai/ha, 1-900 g ai/ha, 1-800 g ai/ha, 1-700 g ai/ha, 1-600 g ai/ha, 1-500 g ai/ha, 1-400 g ai/ha, 1-300 g ai/ha, 1-250 g ai/ha, 1-200 g ai/ha, 1-180 g ai/ha, 1-160 g ai/ha, 1-140 g ai/ha, 1-120 g ai/ha, 1-100 g ai/ha, 1-90 g ai/ha, 1-80 g ai/ha, 1-70 g ai/ha, 1-60 g ai/ha, 1-50 g ai/ha, 1-40 g ai/ha, 1-30 g ai/ha, 1-20 g ai/ha, 1-10 g ai/ha, 10-600 g ai/ha, 10-700 g ai/ha, 20-800 g ai/ha, 20-900 g ai/ha, 20-1000 g ai/ha, 30-900 g ai/ha, 30-800 g ai/ha, 30-700 g ai/ha, 30-600 g ai/ha, 30-500 g ai/ha, 40-500 g ai/ha, 50-500 g ai/ha, 60-500 g ai/ha, 70-500 g ai/ha, 80-500 g ai/ha, 90-500 g ai/ha, 100-500 g ai/ha, 100-400 g ai/ha, 30-400 g ai/ha, 30-350 g ai/ha, 30-300 g ai/ha, 30-250 g ai/ha, 30-200 g ai/ha, 30-150 g ai/ha, 50-100 g ai/ha, 70-140 g ai/ha, 100-150 g ai/ha, 100-300 g ai/ha, 350-800 g ai/ha, or 500-1000 g ai/ha).

In certain embodiments, the herbicidal composition contains a herbicidally effective amount of (a) a pyridine carboxylic acid herbicide or an agriculturally acceptable N-oxide, salt, or ester thereof, and (b) clodinafop, cyhalofop, diclofop, fenoxaprop, fluazifop, haloxyfop, metamifop, propaquizafop, quizalofop, or agriculturally acceptable salts or esters thereof.

In certain embodiments, the herbicidal composition contains a herbicidally effective amount of (a) a pyridine carboxylic acid herbicide or an agriculturally acceptable N-oxide, salt, or ester thereof, and (b) alloxydim, butroxydim, clethodim, cycloxydim, profoxydim, sethoxydim, tepraloxydim, tralkoxydim, or agriculturally acceptable salts thereof, and combinations thereof.

In certain embodiments, the herbicidal composition contains a herbicidally effective amount of (a) a pyridine carboxylic acid herbicide or an agriculturally acceptable N-oxide, salt, or ester thereof, and (b) pinoxaden, or agriculturally acceptable salts thereof.

Clodinafop

Compositions and methods of the present disclosure can include clodinafop or an agriculturally acceptable ester thereof. Clodinafop-propargyl, which has the following structure, is prop-2-ynyl (R)-2-[4-(5-chloro-3-fluoro-2-pyridyloxy)phenoxy]propionate and is used for post-emergence control of annual grasses, including Avena, Lolium, Setaria, Phalaris, and Alopecurus spp., in cereals.

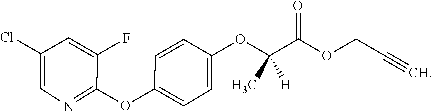 [SMILES: C#CCOC(=O)[C@@H](C)Oc1ccc(Oc2ncc(Cl)cc2F)cc1]

In some embodiments, clodinafop can be provided as an agriculturally acceptable salt or ester of clodinafop.

The clodinafop or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the clodinafop or agriculturally acceptable salt thereof is applied to vegetation or an area adjacent the vegetation or applied to soil or water to prevent the emergence or growth of vegetation in an amount of 9 g ai/ha or more (e.g., 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, or 100 g ai/ha or more).

In some embodiments, the clodinafop or agriculturally acceptable salt thereof is applied to vegetation or an area adjacent the vegetation or applied to soil or water to prevent the emergence or growth of vegetation in an amount of 101 g ai/ha or less (e.g., 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 14 g ai/ha or less, 13 g ai/ha or less, 12 g ai/ha or less, 11 g ai/ha or less, or 10 g ai/ha or less).

The clodinafop or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the clodinafop or agriculturally acceptable salt thereof is applied to vegetation or an area adjacent the vegetation or applied to soil or water to prevent the emergence or growth of vegetation in an amount of 10-100 g ai/ha (e.g., 10-90 g ai/ha, 10-80 g ai/ha, 10-70 g ai/ha, 10-60 g ai/ha, 10-50 g ai/ha, 10-40 g ai/ha, 10-30 g ai/ha, 10-20 g ai/ha, 20-100 g ai/ha, 30-100 g ai/ha, 40-100 g ai/ha, 50-100 g ai/ha, 60-100 g ai/ha, 70-100 g ai/ha, 30-90 g ai/ha, 30-80 g ai/ha, 30-70 g ai/ha, 30-60 g ai/ha, 30-50 g ai/ha, or 30-40 g ai/ha).

Cyhalofop

Compositions and methods of the present disclosure can include cyhalofop or an agriculturally acceptable salt or ester thereof. Cyhalofop, as well as methods of preparing cyhalofop, are known in the art. In some embodiments, cyhalofop can be provided as an agriculturally acceptable ester of cyhalofop. Cyhalofop-butyl, shown below, is an aryloxyphenoxypropionate that is used for post-emergence control of grass weeds in nice.

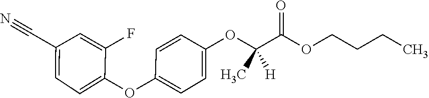 [SMILES: CCCCOC(=O)[C@@H](C)Oc1ccc(Oc2ccc(C#N)cc2F)cc1]

The cyhalofop or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the cyhalofop or agriculturally acceptable salt or ester thereof is applied to vegetation or an area adjacent the vegetation or applied to soil or water to prevent the emergence or growth of vegetation in an amount of 20 g ai/ha or more (e.g., 30 g ai/ha or more, 40 g ai/ha or more, 50 g ai/ha or more, 60 g ai/ha or more, 70 g ai/ha or more, 80 g ai/ha or more, 90 g ai/ha or more, 100 g ai/ha or more, 120 g ai/ha or more, 140 g ai/ha or more, 160 g ai/ha or more, 180 g ai/ha or more, 200 g ai/ha or more, 225 g ai/ha or more, 250 g ai/ha or more, 275 g ai/ha or more, 300 g ai/ha or more, 350 g ai/ha or more, 400 g ai/ha or more, 450 g ai/ha or more, or 500 g ai/ha or more).

In some embodiments, the cyhalofop or agriculturally acceptable salt or ester thereof is applied to vegetation or an area adjacent the vegetation or applied to soil or water to prevent the emergence or growth of vegetation in an amount of 501 g ai/ha or less (e.g., 500 g ai/ha or less, 450 g ai/ha or less, 400 g ai/ha or less, 350 g ai/ha or less, 300 g ai/ha or less, 275 g ai/ha or less, 250 g ai/ha or less, 225 g ai/ha or less, 200 g ai/ha or less, 180 g ai/ha or less, 160 g ai/ha or less, 140 g ai/ha or less, 120 g ai/ha or less, 100 g ai/ha or less, 90 g ai/ha or less, 80 g ai/ha or less, 70 g ai/ha or less, 60 g ai/ha or less, 50 g ai/ha or less, 40 g ai/ha or less, 30 g ai/ha or less, or 20 g ai/ha or less).

The cyhalofop or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the cyhalofop or agriculturally acceptable salt or ester thereof is applied to vegetation or an area adjacent the vegetation or applied to soil or water to prevent the emergence or growth of vegetation in an amount of 20-500 g ai/ha (e.g., 20-450 g ai/ha, 20-400 g ai/ha, 20-350 g ai/ha, 30-350 g ai/ha, 40-350 g ai/ha, 50-350 g ai/ha, 60-350 g ai/ha, 70-350 g ai/ha, 70-340 g ai/ha, 70-330 g ai/ha, 70-320 g ai/ha, 70-310 g ai/ha, 75-310 g ai/ha, 80-350 g ai/ha, 100-350 g ai/ha, 150-350 g ai/ha, 200-350 g ai/ha, 250-350 g ai/ha, or 300-350 g ai/ha).

Diclofop

Compositions and methods of the present disclosure can include diclofop or an agriculturally acceptable salt or ester thereof. Diclofop-methyl, shown below, is an aryloxyphenoxypropionate that is used for post-emergence control of wild oats, wild millets, and other annual grass weeds in wheat, barley, rye, red fescue, and broad-leaved crops such as soybeans, sugar beet, fodder beet, flax, legumes, canola/oilseed rape, sunflowers, clover, alfalfa, peanuts, brassicas, carrots, celery, beetroot, parsnips, lettuce, spinach, potatoes, cucumbers, peas, beans, tomatoes, fennel, alliums, and herbs. Diclofop, as well as methods of preparing diclofop, are known in the art.

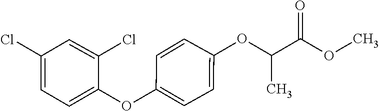 [SMILES: COC(=O)C(C)Oc1ccc(Oc2ccc(Cl)cc2Cl)cc1]

In some embodiments, diclofop can be provided as an agriculturally acceptable salt or ester of diclofop.

The diclofop or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the diclofop or agriculturally acceptable salt or ester thereof is applied to vegetation or an area adjacent the vegetation or applied to soil or water to prevent the emergence or growth of vegetation in an amount 100 g ai/ha or more (e.g., 150 g ai/ha or more, 175 g ai/ha or more, 200 g ai/ha or more, 220 g ai/ha or more, 240 g ai/ha or more, 260 g ai/ha or more, 280 g ai/ha or more, 300 g ai/ha or more, 320 g ai/ha or more, 340 g ai/ha or more, 360 g ai/ha or more, 380 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 620 g ai/ha or more, 640 g ai/ha or more, 660 g ai/ha or more, 680 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, or 1200 g ai/ha or more).

In some embodiments, the diclofop or agriculturally acceptable salt or ester thereof is applied to vegetation or an area adjacent the vegetation or applied to soil or water to prevent the emergence or growth of vegetation in an amount of 1201 g ai/ha or less (e.g., 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 680 g ai/ha or less, 660 g ai/ha or less, 640 g ai/ha or less, 620 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 380 g ai/ha or less, 360 g ai/ha or less, 340 g ai/ha or less, 320 g ai/ha or less, 300 g ai/ha or less, 280 g ai/ha or less, 260 g ai/ha or less, 240 g ai/ha or less, 220 g ai/ha or less, 200 g ai/ha or less, 175 g ai/ha or less, 150 g ai/ha or less, 140 g ai/ha or less, 130 g ai/ha or less, 120 g ai/ha or less, 110 g ai/ha or less, or 101 g ai/ha or less).

The diclofop or an agriculturally acceptable ester thereof can be applied to vegetation or an area adjacent the vegetation or applied to soil or water to prevent the emergence or growth of vegetation in an amount ranging from any of the minimum values described above to any of the maximum values described above. In some embodiments, the diclofop or agriculturally acceptable ester thereof is applied to vegetation or an area adjacent the vegetation or applied to soil or water to prevent the emergence or growth of vegetation in an amount of 100-1200 g ai/ha (e.g., 120-1200 g ai/ha, 140-1200 g ai/ha, 160-1200 g ai/ha, 180-1200 g ai/ha, 200-1180 g ai/ha, 210-1160 g ai/ha, 220-1140 g ai/ha, 240-1120 g ai/ha, 250-1100 g ai/ha, 300-1000 g ai/ha, 350-1000 g ai/ha, 360-950 g ai/ha, 370-850 g ai/ha, 370-800 g ai/ha, 370-750 g ai/ha, 370-700 g ai/ha, 400-650 g ai/ha, 450-600 g ai/ha, 500-600 g ai/ha, or 550-600 g ai/ha).

Fenoxaprop

Compositions and methods of the present disclosure can include fenoxaprop or an agriculturally acceptable salt or ester thereof. Fenoxaprop-P-ethyl, shown below, is an aryloxyphenoxypropionate that is used for post-emergence control of annual and perennial grass weeds in potatoes, beans, soybeans, beets, vegetables, peanuts, flax, canola/oilseed rape and cotton; and (when applied with the herbicide safener mefenpyr-diethyl) annual and perennial grass weeds and wild oats in wheat, rye, triticale and, depending on the ratio, in some varieties of barley. Fenoxaprop, as well as methods of preparing fenoxaprop, are known in the art.

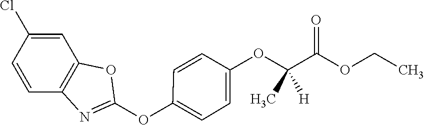 [SMILES: CCOC(=O)[C@@H](C)Oc1ccc(Oc2nc3ccc(Cl)cc3o2)cc1]

In some embodiments, fenoxaprop can be provided as an agriculturally acceptable salt or ester of fenoxaprop.

The fenoxaprop or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the fenoxaprop or agriculturally acceptable salt or ester thereof is applied to vegetation or an area adjacent the vegetation or applied to soil or water to prevent the emergence or growth of vegetation in an amount of 25 g ai/ha or more (e.g., 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 105 g ai/ha or more, 110 g ai/ha or more, 115 g ai/ha or more, 120 g ai/ha or more, 125 g ai/ha or more, 130 g ai/ha or more, 135 g ai/ha or more, 140 g ai/ha or more, 145 g ai/ha or more, or 150 g ai/ha or more).

In some embodiments, the fenoxaprop or agriculturally acceptable salt or ester thereof is applied to vegetation or an area adjacent the vegetation or applied to soil or water to prevent the emergence or growth of vegetation in an amount of 151 g ai/ha or less (e.g., 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, or 25 g ai/ha or less).

The fenoxaprop or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the fenoxaprop or agriculturally acceptable salt or ester thereof is applied to vegetation or an area adjacent the vegetation or applied to soil or water to prevent the emergence or growth of vegetation in an amount of 25-150 g ai/ha (e.g., 26-140 g ai/ha, 27-140 g ai/ha, 28-140 g ai/ha, 29-140 g ai/ha, 30-140 g ai/ha, 32-135 g ai/ha, 34-130 g ai/ha, 36-125 g ai/ha, 38-120 g ai/ha, 40-115 g ai/ha, 40-110 g ai/ha, 40-105 g ai/ha, 40-100 g ai/ha, 40-95 g ai/ha, 40-90 g ai/ha, 40-80 g ai/ha, 50-80 g ai/ha, 60-80 g ai/ha, or 70-90 g ai/ha).

Fluazifop

Compositions and methods of the present disclosure can include fluazifop or an agriculturally acceptable salt or ester thereof. Fluazifop-P-butyl, shown below, is an aryloxyphenoxypropionate that is used for post-emergence control of annual and perennial grass weeds in broad-leaved crops. Particular uses include control of volunteer cereals and other grass weeds in canola/oilseed rape, sugar beet, fodder beet, potatoes, cotton, soybeans, peanuts, pome fruit, bush fruit, vines, citrus fruit, pineapples, bananas, strawberries, sunflowers, alfalfa, coffee, ornamentals and many vegetables. Fluazifop, as well as methods of preparing fluazifop, are known in the art.

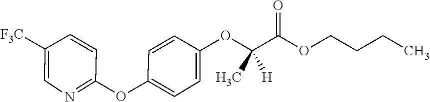 [SMILES: CCCCOC(=O)[C@@H](C)Oc1ccc(Oc2ccc(C(F)(F)F)cn2)cc1]

In some embodiments, fluazifop can be provided as an agriculturally acceptable salt or ester of fluazifop.

The fluazifop or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the fluazifop or agriculturally acceptable ester thereof is applied to vegetation or an area adjacent the vegetation or applied to soil or water to prevent the emergence or growth of vegetation in an amount of 95 grams active ingredient per hectare (g ai/ha) or more (e.g., 100 g ai/ha or more, 105 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 225 g ai/ha or more, 250 g ai/ha or more, 275 g ai/ha or more, 300 g ai/ha or more, 325 g ai/ha or more, 350 g ai/ha or more, 375 g ai/ha or more, 400 g ai/ha or more, 425 g ai/ha or more, 450 g ai/ha or more, 475 g ai/ha or more, 500 g ai/ha or more, 600 g ai/ha or more, 700 g ai/ha or more, 800 g ai/ha or more, 900 g ai/ha or more, 1000 g ai/ha or more, 1200 g ai/ha or more, or 1400 g ai/ha or more).

In some embodiments, the fluazifop or agriculturally acceptable salt or ester thereof is applied to vegetation or an area adjacent the vegetation or applied to soil or water to prevent the emergence or growth of vegetation in an amount of 1401 g ai/ha or less (e.g., 1400 g ai/ha or less, 1200 g ai/ha or less, 1100 g ai/ha or less, 900 g ai/ha or less, 800 g ai/ha or less, 700 g ai/ha or less, 600 g ai/ha or less, 500 g ai/ha or less, 475 g ai/ha or less, 450 g ai/ha or less, 425 g ai/ha or less, 400 g ai/ha or less, 375 g ai/ha or less, 350 g ai/ha or less, 325 g ai/ha or less, 300 g ai/ha or less, 275 g ai/ha or less, 250 g ai/ha or less, 225 g ai/ha or less, 200 g ai/ha or less, 175 g ai/ha or less, 150 g ai/ha or less, 125 g ai/ha or less, or 100 g ai/ha or less).

The fluazifop or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the fluazifop or agriculturally acceptable salt or ester thereof is applied to vegetation or an area adjacent the vegetation or applied to soil or water to prevent the emergence or growth of vegetation in an amount of 100-1400 g ai/ha (e.g., 100-1300 g ai/ha, 100-1200 g ai/ha, 100-1100 g ai/ha, 100-1000 g ai/ha, 100-900 g ai/ha, 100-800 g ai/ha, 100-700 g ai/ha, 100-600 g ai/ha, 100-500 g ai/ha, 100-475 g ai/ha, 100-450 g ai/ha, 100-425 g ai/ha, 100-400 g ai/ha, 110-375 g ai/ha, 120-375 g ai/ha, 130-375 g ai/ha, 150-375 g ai/ha, 175-375 g ai/ha, 175-350 g ai/ha, 200-350 g ai/ha, or 250-300 g ai/ha).

Haloxyfop

Compositions and methods of the present disclosure can include haloxyfop or an agriculturally acceptable ester thereof. Haloxyfop-P-methyl, shown below, is an aryloxyphenoxypropionate that is used post-emergence for control of annual and perennial grasses in sugar beet, fodder beet, canola/oilseed rape, potatoes, leaf vegetables, onions, flax, sunflowers, soybeans, vines, strawberries and other crops. Haloxyfop-P, as well as methods of preparing haloxyfop-P, are known in the art.

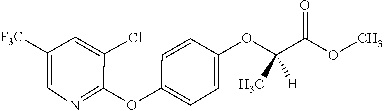 [SMILES: COC(=O)[C@@H](C)Oc1ccc(Oc2ncc(C(F)(F)F)cc2Cl)cc1]

In some embodiments, haloxyfop-P can be provided as an agriculturally acceptable salt or ester of haloxyfop-P.

The haloxyfop-P or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the haloxyfop-P or agriculturally acceptable salt or ester thereof is applied to vegetation or an area adjacent the vegetation or applied to soil or water to prevent the emergence or growth of vegetation in an amount of 24 g ai/ha or more (e.g., 25 g ai/ha or more, 30 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 210 g ai/ha or more, 220 g ai/ha or more, 230 g ai/ha or more, 240 g ai/ha or more, or 250 g ai/ha or more).

In some embodiments, the haloxyfop or agriculturally acceptable salt or ester thereof is applied to vegetation or an area adjacent the vegetation or applied to soil or water to prevent the emergence or growth of vegetation in an amount of 251 g ai/ha or less (e.g., 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, or 25 g ai/ha or less).

The haloxyfop or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the haloxyfop or agriculturally acceptable salt or ester thereof is applied to vegetation or an area adjacent the vegetation or applied to soil or water to prevent the emergence or growth of vegetation in an amount of 25-250 g ai/ha (e.g., 25-225 g ai/ha, 25-200 g ai/ha, 25-190 g ai/ha, 25-180 g ai/ha, 30-175 g ai/ha, 30-170 g ai/ha, 30-165 g ai/ha, 30-160 g ai/ha, 30-155 g ai/ha, 30-150 g ai/ha, 30-140 g ai/ha, 30-130 g ai/ha, 30-120 g ai/ha, 30-110 g ai/ha, 30-100 g ai/ha, 30-90 g ai/ha, 30-80 g ai/ha, 30-70 g ai/ha, 30-60 g ai/ha, or 30-50 g ai/ha).

Metamifop

Compositions and methods of the present disclosure can include metamifop. Metamifop, shown below, is an aryloxyphenoxypropionate that is used for post-emergence control of annual and perennial grass weeds (including Echinochloa spp., Leptochloa chinensis, Digitaria spp. and Eleusine indica) in various crops, including rice. Metamifop, as well as methods of preparing metamifop, are known in the art.

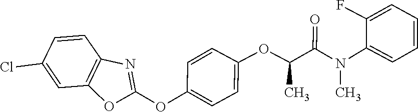 [SMILES: C[C@@H](Oc1ccc(Oc2nc3ccc(Cl)cc3o2)cc1)C(=O)N(C)c1ccccc1F]

The metamifop can be applied to vegetation or an area adjacent the vegetation or applied to soil or water to prevent the emergence or growth of vegetation in an amount sufficient to induce a herbicidal effect. In some embodiments, the metamifop is applied to vegetation or an area adjacent the vegetation or applied to soil or water to prevent the emergence or growth of vegetation in an amount of 49 g ai/ha or more (e.g., 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 105 g ai/ha or more, 110 g ai/ha or more, 115 g ai/ha or more, 120 g ai/ha or more, 125 g ai/ha or more, 130 g ai/ha or more, 135 g ai/ha or more, 140 g ai/ha or more, 145 g ai/ha or more, 150 g ai/ha or more, 155 g ai/ha or more, 160 g ai/ha or more, 165 g ai/ha or more, 170 g ai/ha or more, 175 g ai/ha or more, 180 g ai/ha or more, 185 g ai/ha or more, 190 g ai/ha or more, 195 g ai/ha or more, 200 g ai/ha or more, 210 g ai/ha or more, 220 g ai/ha or more, 230 g ai/ha or more, 240 g ai/ha or more, 250 g ai/ha or more, 260 g ai/ha or more, 270 g ai/ha or more, 280 g ai/ha or more, 290 g ai/ha or more, or 300 g ai/ha or more).

In some embodiments, the metamifop is applied to vegetation or an area adjacent the vegetation or applied to soil or water to prevent the emergence or growth of vegetation in an amount of 301 g ai/ha or less (e.g., 300 g ai/ha or less, 290 g ai/ha or less, 280 g ai/ha or less, 270 g ai/ha or less, 260 g ai/ha or less, 250 g ai/ha or less, 240 g ai/ha or less, 230 g ai/ha or less, 220 g ai/ha or less, 210 g ai/ha or less, 200 g ai/ha or less, 195 g ai/ha or less, 190 g ai/ha or less, 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, or 60 g ai/ha or less).

The metamifop can be applied to vegetation or an area adjacent the vegetation or applied to soil or water to prevent the emergence or growth of vegetation in an amount ranging from any of the minimum values described above to any of the maximum values described above. In some embodiments, the metamifop is applied to vegetation or an area adjacent the vegetation or applied to soil or water to prevent the emergence or growth of vegetation in an amount of 60-300 g ai/ha (e.g., 60-275 g ai/ha, 60-250 g ai/ha, 60-225 g ai/ha, 60-200 g ai/ha, 70-200 g ai/ha, 80-200 g ai/ha, 90-200 g ai/ha, 100-200 g ai/ha, 120-200 g ai/ha, 140-200 g ai/ha, or 160-200 g ai/ha).

Propaquizafop

Compositions and methods of the present disclosure can include propaquizafop. Propaquizafop, shown below, is an aryloxyphenoxypropionate that is to control of a wide range of annual and perennial grasses (including Sorghum halepense, Agropyron repens and Cynodon dactylon) in soybeans, cotton, sugar beet, potatoes, peanuts, peas, oilseed rape and vegetables. Propaquizafop, as well as methods of preparing propaquizafop, are known in the art.

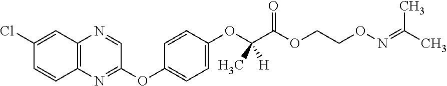 [SMILES: CC(C)=NOCCOC(=O)[C@@H](C)Oc1ccc(Oc2cnc3cc(Cl)ccc3n2)cc1]

The propaquizafop can be applied to vegetation or an area adjacent the vegetation or applied to soil or water to prevent the emergence or growth of vegetation in an amount sufficient to induce a herbicidal effect. In some embodiments, the propaquizafop is applied to vegetation or an area adjacent the vegetation or applied to soil or water to prevent the emergence or growth of vegetation in an amount of 29 g ai/ha or more (e.g., 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 210 g ai/ha or more, 220 g ai/ha or more, 230 g ai/ha or more, 240 g ai/ha or more, 250 g ai/ha or more, 260 g ai/ha or more, 270 g ai/ha or more, 280 g ai/ha or more, 290 g ai/ha or more, or 300 g ai/ha or more).

In some embodiments, the propaquizafop is applied to vegetation or an area adjacent the vegetation or applied to soil or water to prevent the emergence or growth of vegetation in an amount of 301 g ai/ha or less (e.g., 300 g ai/ha or less, 290 g ai/ha or less, 280 g ai/ha or less, 270 g ai/ha or less, 260 g ai/ha or less, 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, or 30 g ai/ha or less).

The propaquizafop can be applied to vegetation or an area adjacent the vegetation or applied to soil or water to prevent the emergence or growth of vegetation in an amount ranging from any of the minimum values described above to any of the maximum values described above. In some embodiments, the propaquizafop is applied to vegetation or an area adjacent the vegetation or applied to soil or water to prevent the emergence or growth of vegetation in an amount of 29-300 g ai/ha (e.g., 30-290 g ai/ha, 35-280 g ai/ha, 40-270 g ai/ha, 45-260 g ai/ha, 50-250 g ai/ha, 60-240 g ai/ha, 60-230 g ai/ha, 60-220 g ai/ha, 60-210 g ai/ha, 60-200 g ai/ha, 60-180 g ai/ha, 60-160 g ai/ha, 60-140 g ai/ha, 60-120 g ai/ha, 60-100 g ai/ha, 60-90 g ai/ha, or 60-80 g ai/ha).

Quizalofop

Compositions and methods of the present disclosure can include quizalofop or an agriculturally acceptable ester thereof. Quizalofop-P-ethyl, shown below, is an aryloxyphenoxypropionate that is used for selective post-emergence control of annual and perennial grass weeds in potatoes, soybeans, sugar beet, peanuts, oilseed rape, sunflowers, vegetables, cotton and flax. Quizalofop, as well as methods of preparing haloxyfop, are known in the art.

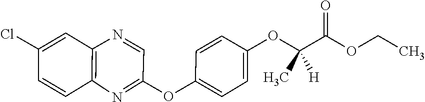 [SMILES: CCOC(=O)[C@@H](C)Oc1ccc(Oc2cnc3cc(Cl)ccc3n2)cc1]

In some embodiments, quizalofop can be provided as an agriculturally acceptable salt or ester of quizalofop.

The quizalofop or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the quizalofop or agriculturally acceptable salt or ester thereof is applied to vegetation or an area adjacent the vegetation or applied to soil or water to prevent the emergence or growth of vegetation in an amount of 24 g ai/ha or more (e.g., 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 210 g ai/ha or more, 220 g ai/ha or more, 230 g ai/ha or more, 240 g ai/ha or more, or 250 g ai/ha or more).

In some embodiments, the quizalofop or agriculturally acceptable salt or ester thereof is applied to vegetation or an area adjacent the vegetation or applied to soil or water to prevent the emergence or growth of vegetation in an amount of 251 g ai/ha or less (e.g., 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, or 25 g ai/ha or less).

The quizalofop or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the quizalofop or agriculturally acceptable salt or ester thereof is applied to vegetation or an area adjacent the vegetation or applied to soil or water to prevent the emergence or growth of vegetation in an amount of 25-250 g ai/ha (e.g., 25-225 g ai/ha, 25-200 g ai/ha, 25-190 g ai/ha, 25-180 g ai/ha, 30-175 g ai/ha, 30-170 g ai/ha, 30-165 g ai/ha, 30-160 g ai/ha, 30-155 g ai/ha, 30-150 g ai/ha, 40-140 g ai/ha, 50-160 g ai/ha, 60-170 g ai/ha, 60-160 g ai/ha, 60-140 g ai/ha, 60-120 g ai/ha, 60-100 g ai/ha, 60-90 g ai/ha, or 60-80 g ai/ha).

In certain embodiments, the herbicidal composition contains a herbicidally effective amount of (a) a pyridine carboxylic acid herbicide or an agriculturally acceptable N-oxide, salt, or ester thereof, and (b) alloxydim, butroxydim, clethodim, cycloxydim, profoxydim, sethoxydim, tepraloxydim, tralkoxydim, pinoxaden, or agriculturally acceptable salts thereof, or combinations thereof.

Alloxydim

Compositions and methods of the present disclosure can include alloxydim or an agriculturally acceptable salt or ester thereof. Alloxydim, shown below, is a cyclohexanedione herbicide that provides post-emergence control of grass weeds and volunteer cereals in sugar beet, vegetables and broad-leaved crops. Alloxydim, as well as methods of preparing alloxydim, are known in the art. Its herbicidal activity is described in The Pesticide Manual, Fifteenth Edition, 2009.

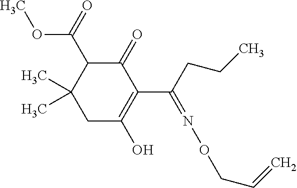 [SMILES: C=CCON=C(CCC)C1=C(O)CC(C)(C)C(C(=O)OC)C1=O]

In some embodiments, alloxydim can be provided as an agriculturally acceptable salt or ester of alloxydim.

The alloxydim or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the alloxydim or agriculturally acceptable salt or ester thereof is applied to vegetation or an area adjacent the vegetation or applied to soil or water to prevent the emergence or growth of vegetation in an amount of 299 g ai/ha or more (e.g., 300 g ai/ha or more, 320 g ai/ha or more, 340 g ai/ha or more, 360 g ai/ha or more, 380 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 620 g ai/ha or more, 640 g ai/ha or more, 660 g ai/ha or more, 680 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1200 g ai/ha or more, 1300 g ai/ha or more, 1400 g ai/ha or more, or 1500 g ai/ha or more).

In some embodiments, the alloxydim or agriculturally acceptable salt or ester thereof is applied to vegetation or an area adjacent the vegetation or applied to soil or water to prevent the emergence or growth of vegetation in an amount of 1501 g ai/ha or less (e.g., 1500 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 680 g ai/ha or less, 660 g ai/ha or less, 640 g ai/ha or less, 620 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 380 g ai/ha or less, 360 g ai/ha or less, 340 g ai/ha or less, 320 g ai/ha or less, or 300 g ai/ha or less).

The alloxydim or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the alloxydim or agriculturally acceptable salt or ester thereof is applied to vegetation or an area adjacent the vegetation or applied to soil or water to prevent the emergence or growth of vegetation in an amount of 300-1500 g ai/ha (e.g., 350-1400 g ai/ha, 400-1300 g ai/ha, 450-1250 g ai/ha, 450-1200 g ai/ha, 450-1150 g ai/ha, 450-1100 g ai/ha, 450-1050 g ai/ha, 500-1000 g ai/ha, 500-900 g ai/ha, 500-800 g ai/ha, 500-700 g ai/ha, or 500-600 g ai/ha).

Butroxydim

Compositions and methods of the present disclosure can include butroxydim or an agriculturally acceptable salt or ester thereof. Butroxydim, shown below, is a cyclohexanedione herbicide that provides post-emergence control of annual grasses in many broad-leaved crops. Butroxydim, as well as methods of preparing butroxydim, are known in the art. Its herbicidal activity is described in The Pesticide Manual, Fifteenth Edition, 2009.

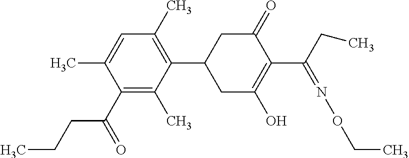 [SMILES: CCCC(=O)c1c(C)cc(C)c(C2CC(=O)C(C(CC)=NOCC)=C(O)C2)c1C]

In some embodiments, butroxydim can be provided as an agriculturally acceptable salt or ester of butroxydim.

The butroxydim or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the butroxydim or agriculturally acceptable salt or ester thereof is applied to vegetation or an area adjacent the vegetation or applied to soil or water to prevent the emergence or growth of vegetation in an amount of 9 g ai/ha or more (e.g., 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 105 g ai/ha or more, 110 g ai/ha or more, 115 g ai/ha or more, or 120 g ai/ha or more).

In some embodiments, the butroxydim or agriculturally acceptable salt or ester thereof is applied to vegetation or an area adjacent the vegetation or applied to soil or water to prevent the emergence or growth of vegetation in an amount of 121 g ai/ha or less (e.g., 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, or 10 g ai/ha or less).

The butroxydim or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the butroxydim or agriculturally acceptable salt or ester thereof is applied to vegetation or an area adjacent the vegetation or applied to soil or water to prevent the emergence or growth of vegetation in an amount of 10-120 g ai/ha (e.g., 10-115 g ai/ha, 10-110 g ai/ha, 10-105 g ai/ha, 10-100 g ai/ha, 10-95 g ai/ha, 15-90 g ai/ha, 15-85 g ai/ha, 20-80 g ai/ha, 20-75 g ai/ha, 25-75 g ai/ha, 25-65 g ai/ha, 25-55 g ai/ha, or 25-45 g ai/ha).

Clethodim

Compositions and methods of the present disclosure can include clethodim or an agriculturally acceptable salt or ester thereof. Clethodim, shown below, is a cyclohexanedione herbicide that provides post-emergence control of annual and perennial grasses in a wide range of broad-leaved crops, including such field crops as canola/oilseed rape, soybean, cotton, flax, sunflowers, alfalfa, peanuts, sugar beet, tobacco, and potatoes, as well as vegetable crops, trees, and vines.

Clethodim, as well as methods of preparing clethodim, are known in the art. Its herbicidal activity is described in The Pesticide Manual, Fifteenth Edition, 2009.

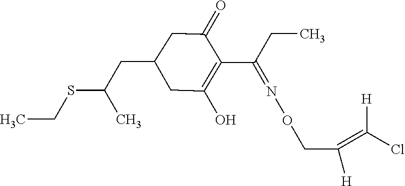 [SMILES: CCSC(C)CC1CC(=O)C(C(CC)=NOC/C=C/Cl)=C(O)C1]

In some embodiments, clethodim can be provided as an agriculturally acceptable salt or ester of clethodim.

The clethodim or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the clethodim or agriculturally acceptable salt or ester thereof is applied to vegetation or an area adjacent the vegetation or applied to soil or water to prevent the emergence or growth of vegetation in an amount of 1.9 g ai/ha or more (e.g., 2 g ai/ha or more, 4 g ai/ha or more, 6 g ai/ha or more, 8 g ai/ha or more, 10 g ai/ha or more, 12 g ai/ha or more, 14 g ai/ha or more, 16 g ai/ha or more, 18 g ai/ha or more, 20 g ai/ha or more, 22 g ai/ha or more, 24 g ai/ha or more, 26 g ai/ha or more, 28 g ai/ha or more, 30 g ai/ha or more, 35 g ai/ha or more, 40 g ai/ha or more, 45 g ai/ha or more, 50 g ai/ha or more, 60 g ai/ha or more, 70 g ai/ha or more, 80 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 260 g ai/ha or more, 280 g ai/ha or more, 300 g ai/ha or more, 320 g ai/ha or more, 340 g ai/ha or more, 360 g ai/ha or more, 380 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 620 g ai/ha or more, 640 g ai/ha or more, 660 g ai/ha or more, 680 g ai/ha or more, 700 g ai/ha or more, 750 g ai/ha or more, 800 g ai/ha or more, 850 g ai/ha or more, or 900 g ai/ha or more).

In some embodiments, the clethodim or agriculturally acceptable salt or ester thereof is applied to vegetation or an area adjacent the vegetation or applied to soil or water to prevent the emergence or growth of vegetation in an amount of 901 g ai/ha or less (e.g., 900 g ai/ha or less, 850 g ai/ha or less, 800 g ai/ha or less, 750 g ai/ha or less, 700 g ai/ha or less, 680 g ai/ha or less, 660 g ai/ha or less, 640 g ai/ha or less, 620 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 380 g ai/ha or less, 360 g ai/ha or less, 340 g ai/ha or less, 320 g ai/ha or less, 300 g ai/ha or less, 290 g ai/ha or less, 280 g ai/ha or less, 270 g ai/ha or less, 260 g ai/ha or less, 250 g ai/ha or less, 240 g ai/ha or less, 235 g ai/ha or less, 230 g ai/ha or less, 225 g ai/ha or less, 220 g ai/ha or less, 215 g ai/ha or less, 210 g ai/ha or less, 205 g ai/ha or less, 200 g ai/ha or less, 195 g ai/ha or less, 190 g ai/ha or less, 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 140 g ai/ha or less, 130 g ai/ha or less, 120 g ai/ha or less, 110 g ai/ha or less, 100 g ai/ha or less, 90 g ai/ha or less, 80 g ai/ha or less, 70 g ai/ha or less, 60 g ai/ha or less, 50 g ai/ha or less, 45 g ai/ha or less, 40 g ai/ha or less, 35 g ai/ha or less, 30 g ai/ha or less, 28 g ai/ha or less, 26 g ai/ha or less, 24 g ai/ha or less, 22 g ai/ha or less, 20 g ai/ha or less, 18 g ai/ha or less, 16 g ai/ha or less, 14 g ai/ha or less, 12 g ai/ha or less, 10 g ai/ha or less, 8 g ai/ha or less, 6 g ai/ha or less, 4 g ai/ha or less, or 2 g ai/ha or less).

The clethodim or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the clethodim or agriculturally acceptable salt or ester thereof is applied to vegetation or an area adjacent the vegetation or applied to soil or water to prevent the emergence or growth of vegetation in an amount of 2-900 g ai/ha (e.g., 2-800 g ai/ha, 2-700 g ai/ha, 2-600 g ai/ha, 2-500 g ai/ha, 5-500 g ai/ha, 10-500 g ai/ha, 20-500 g ai/ha, 40-500 g ai/ha, 60-500 g ai/ha, 80-500 g ai/ha, 100-500 g ai/ha, 200-500 g ai/ha, 300-500 g ai/ha, 3-400 g ai/ha, 3-300 g ai/ha, 3-200 g ai/ha, 3-100 g ai/ha, 3-50 g ai/ha, or 3-20 g ai/ha).

Cycloxydim

Compositions and methods of the present disclosure can include cycloxydim or an agriculturally acceptable salt thereof. Cycloxydim, shown below, is a cyclohexanedione herbicide that provides post-emergence control of annual and perennial grasses (except red fescue and Poa spp.) in broad-leaved crops (e.g. canola/oilseed rape, beans, potatoes, cotton, celery, fennel, beetroot, sugar beet, fodder beat, sunflowers, soybeans, flax, alfalfa, crucifers and alliums). Cycloxydim, as well as methods of preparing cycloxydim, are known in the art. Its herbicidal activity is described in The Pesticide Manual, Fifteenth Edition, 2009.

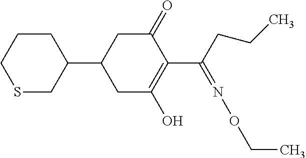 [SMILES: CCCC(=NOCC)C1=C(O)CC(C2CCCSC2)CC1=O]

In some embodiments, cycloxydim can be provided as an agriculturally acceptable salt or ester of cycloxydim.

The cycloxydim or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the cycloxydim or agriculturally acceptable salt or ester thereof is applied to vegetation or an area adjacent the vegetation or applied to soil or water to prevent the emergence or growth of vegetation in an amount of 49 g ai/ha or more (e.g., 50 g ai/ha or more, 60 g ai/ha or more, 70 g ai/ha or more, 80 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 225 g ai/ha or more, 250 g ai/ha or more, 275 g ai/ha or more, 300 g ai/ha or more, 325 g ai/ha or more, 350 g ai/ha or more, 375 g ai/ha or more, 400 g ai/ha or more, 425 g ai/ha or more, 450 g ai/ha or more, 475 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, or 700 g ai/ha or more).

In some embodiments, the cycloxydim or agriculturally acceptable salt or ester thereof is applied to vegetation or an area adjacent the vegetation or applied to soil or water to prevent the emergence or growth of vegetation in an amount of 701 g ai/ha or less (e.g., 700 g ai/ha or less, 680 g ai/ha or less, 660 g ai/ha or less, 640 g ai/ha or less, 620 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 380 g ai/ha or less, 360 g ai/ha or less, 340 g ai/ha or less, 320 g ai/ha or less, 300 g ai/ha or less, 290 g ai/ha or less, 280 g ai/ha or less, 270 g ai/ha or less, 260 g ai/ha or less, 250 g ai/ha or less, 240 g ai/ha or less, 230 g ai/ha or less, 220 g ai/ha or less, 210 g ai/ha or less, 200 g ai/ha or less, 195 g ai/ha or less, 190 g ai/ha or less, 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, or 50 g ai/ha or less).

The cycloxydim or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the cycloxydim or agriculturally acceptable salt or ester thereof is applied to vegetation or an area adjacent the vegetation or applied to soil or water to prevent the emergence or growth of vegetation in an amount of 50-700 g ai/ha (e.g., 50-650 g ai/ha, 50-600 g ai/ha, 50-550 g ai/ha, 50-500 g ai/ha, 75-500 g ai/ha, 100-500 g ai/ha, 120-500 g ai/ha, 140-500 g ai/ha, 160-500 g ai/ha, 180-500 g ai/ha, 200-500 g ai/ha, 250-500 g ai/ha, 50-400 g ai/ha, 50-300 g ai/ha, or 50-200 g ai/ha).

Profoxydim

Compositions and methods of the present disclosure can include profoxydim or an agriculturally acceptable salt thereof. Profoxydim is a cyclohexanedione herbicide that has the chemical name (EZ)-2-{1-[(2RS)-2-(4-chlorophenoxy)propoxyimino]butyl}-3-hydroxy-5-(cis-thian-3-yl)cyclohex-2-en-1-one, and has the following structure:

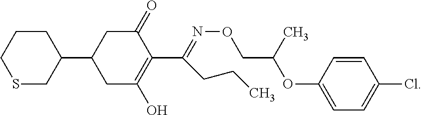 [SMILES: CCC/C(=N\OCC(C)Oc1ccc(Cl)cc1)C1=C(O)CC(C2CCCSC2)CC1=O]

Profoxydim is used for control of grass weeds, including Echinochloa spp., Brachiaria spp., Digitaria spp., Eleusine spp., Leptochloa spp., Setaria spp., Ischaemum rugosum and Rottboellia exaltata, in rice. Profoxydim, as well as methods of preparing clethodim, are known in the art. Its herbicidal activity is described in The Pesticide Manual, Fifteenth Edition, 2009.

In some embodiments, profoxydim can be provided as an agriculturally acceptable salt or ester of profoxydim.

The profoxydim can be applied to vegetation or an area adjacent the vegetation or applied to soil or water to prevent the emergence or growth of vegetation in an amount sufficient to induce a herbicidal effect. In some embodiments, the profoxydim is applied to vegetation or an area adjacent the vegetation or applied to soil or water to prevent the emergence or growth of vegetation in an amount of 49 g ai/ha or more (e.g., 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 105 g ai/ha or more, 110 g ai/ha or more, 115 g ai/ha or more, 120 g ai/ha or more, 125 g ai/ha or more, 130 g ai/ha or more, 135 g ai/ha or more, 140 g ai/ha or more, 145 g ai/ha or more, 150 g ai/ha or more, 155 g ai/ha or more, 160 g ai/ha or more, 165 g ai/ha or more, 170 g ai/ha or more, 175 g ai/ha or more, 180 g ai/ha or more, 185 g ai/ha or more, 190 g ai/ha or more, 195 g ai/ha or more, 200 g ai/ha or more, 210 g ai/ha or more, 220 g ai/ha or more, 230 g ai/ha or more, 240 g ai/ha or more, 250 g ai/ha or more, 260 g ai/ha or more, 270 g ai/ha or more, 280 g ai/ha or more, 290 g ai/ha or more, or 300 g ai/ha or more).

In some embodiments, the profoxydim is applied to vegetation or an area adjacent the vegetation or applied to soil or water to prevent the emergence or growth of vegetation in an amount of 301 g ai/ha or less (e.g., 300 g ai/ha or less, 290 g ai/ha or less, 280 g ai/ha or less, 270 g ai/ha or less, 260 g ai/ha or less, 250 g ai/ha or less, 240 g ai/ha or less, 230 g ai/ha or less, 220 g ai/ha or less, 210 g ai/ha or less, 200 g ai/ha or less, 195 g ai/ha or less, 190 g ai/ha or less, 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, or 50 g ai/ha or less).

The profoxydim can be applied to vegetation or an area adjacent the vegetation or applied to soil or water to prevent the emergence or growth of vegetation in an amount ranging from any of the minimum values described above to any of the maximum values described above. In some embodiments, the profoxydim is applied to vegetation or an area adjacent the vegetation or applied to soil or water to prevent the emergence or growth of vegetation in an amount of 50-300 g ai/ha (e.g., 50-275 g ai/ha, 50-250 g ai/ha, 50-225 g ai/ha, 50-200 g ai/ha, 50-180 g ai/ha, 50-160 g ai/ha, 50-140 g ai/ha, 50-120 g ai/ha, 50-100 g ai/ha, 60-200 g ai/ha, 70-200 g ai/ha, or 75-200 g ai/ha).

Sethoxydim

Compositions and methods of the present disclosure can include sethoxydim or an agriculturally acceptable salt thereof. Sethoxydim is a cyclohexanedione herbicide that has the chemical name (±)-(EZ)-2-(1-ethoxyiminobutyl)-5-[2-(ethylthio)propyl]-3-hydroxycyclohex-2-enone, and has the following structure:

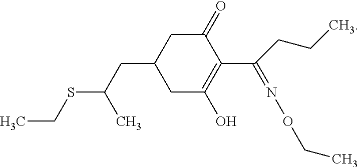 [SMILES: CCCC(=NOCC)C1=C(O)CC(CC(C)SCC)CC1=O]

Sethoxydim is registered for controlling annual and perennial grasses in broad-leaved crops, like canola/oilseed rape, corn, soybean, cotton, fodder beet, sunflowers, spinach, potatoes, tobacco, peanuts, strawberries, alfalfa, flax, vegetables, and sugar beet. Sethoxydim, as well as methods of preparing sethoxydim, are known in the art. Its herbicidal activity is described in The Pesticide Manual, Fifteenth Edition, 2009.

In some embodiments, sethoxydim can be provided as an agriculturally acceptable salt or ester of sethoxydim.

The sethoxydim or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the sethoxydim or agriculturally acceptable salt or ester thereof is applied to vegetation or an area adjacent the vegetation or applied to soil or water to prevent the emergence or growth of vegetation in an amount of 1.9 g ai/ha or more (e.g., 2 g ai/ha or more, 4 g ai/ha or more, 6 g ai/ha or more, 8 g ai/ha or more, 10 g ai/ha or more, 12 g ai/ha or more, 14 g ai/ha or more, 16 g ai/ha or more, 18 g ai/ha or more, 20 g ai/ha or more, 22 g ai/ha or more, 24 g ai/ha or more, 26 g ai/ha or more, 28 g ai/ha or more, 30 g ai/ha or more, 35 g ai/ha or more, 40 g ai/ha or more, 45 g ai/ha or more, 50 g ai/ha or more, 60 g ai/ha or more, 70 g ai/ha or more, 80 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 260 g ai/ha or more, 280 g ai/ha or more, 300 g ai/ha or more, 320 g ai/ha or more, 340 g ai/ha or more, 360 g ai/ha or more, 380 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 620 g ai/ha or more, 640 g ai/ha or more, 660 g ai/ha or more, 680 g ai/ha or more, 700 g ai/ha or more, 750 g ai/ha or more, 800 g ai/ha or more, 850 g ai/ha or more, or 900 g ai/ha or more).

In some embodiments, the sethoxydim or agriculturally acceptable salt or ester thereof is applied to vegetation or an area adjacent the vegetation or applied to soil or water to prevent the emergence or growth of vegetation in an amount of 901 g ai/ha or less (e.g., 900 g ai/ha or less, 850 g ai/ha or less, 800 g ai/ha or less, 750 g ai/ha or less, 700 g ai/ha or less, 680 g ai/ha or less, 660 g ai/ha or less, 640 g ai/ha or less, 620 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 380 g ai/ha or less, 360 g ai/ha or less, 340 g ai/ha or less, 320 g ai/ha or less, 300 g ai/ha or less, 290 g ai/ha or less, 280 g ai/ha or less, 270 g ai/ha or less, 260 g ai/ha or less, 250 g ai/ha or less, 240 g ai/ha or less, 235 g ai/ha or less, 230 g ai/ha or less, 225 g ai/ha or less, 220 g ai/ha or less, 215 g ai/ha or less, 210 g ai/ha or less, 205 g ai/ha or less, 200 g ai/ha or less, 195 g ai/ha or less, 190 g ai/ha or less, 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 140 g ai/ha or less, 130 g ai/ha or less, 120 g ai/ha or less, 110 g ai/ha or less, 100 g ai/ha or less, 90 g ai/ha or less, 80 g ai/ha or less, 70 g ai/ha or less, 60 g ai/ha or less, 50 g ai/ha or less, 45 g ai/ha or less, 40 g ai/ha or less, 35 g ai/ha or less, 30 g ai/ha or less, 28 g ai/ha or less, 26 g ai/ha or less, 24 g ai/ha or less, 22 g ai/ha or less, 20 g ai/ha or less, 18 g ai/ha or less, 16 g ai/ha or less, 14 g ai/ha or less, 12 g ai/ha or less, 10 g ai/ha or less, 8 g ai/ha or less, 6 g ai/ha or less, 4 g ai/ha or less, or 2 g ai/ha or less).

The sethoxydim or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the sethoxydim or agriculturally acceptable salt or ester thereof is applied to vegetation or an area adjacent the vegetation or applied to soil or water to prevent the emergence or growth of vegetation in an amount of 2-900 g ai/ha (e.g., 2-800 g ai/ha, 2-700 g ai/ha, 2-600 g ai/ha, 2-500 g ai/ha, 5-500 g ai/ha, 10-500 g ai/ha, 20-500 g ai/ha, 40-500 g ai/ha, 60-500 g ai/ha, 80-500 g ai/ha, 100-500 g ai/ha, 200-500 g ai/ha, 300-500 g ai/ha, 3-400 g ai/ha, 3-300 g ai/ha, 3-200 g ai/ha, 3-100 g ai/ha, 5-100 g ai/ha, 3-50 g ai/ha, or 3-20 g ai/ha).

Tepraloxydim

Compositions and methods of the present disclosure can include tepraloxydim or an agriculturally acceptable salt or ester thereof. Tepraloxydim is a cyclohexanedione herbicide that has the chemical name (EZ)—(RS)-2-{1-[(2E)-3-chloroallyloxyimino]propyl}-3-hydroxy-5-perhydropyran-4-ylcyclohex-2-en-1-one, and has the following structure:

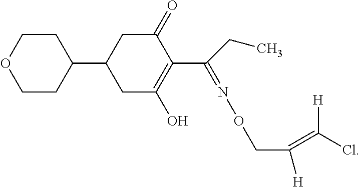 [SMILES: CCC(=NOC/C=C/Cl)C1=C(O)CC(C2CCOCC2)CC1=O]

Tepraloxydim is used for broad-spectrum post-emergence grass weed control, especially Poa annua and volunteer maize, and also Sorghum halepense and Elymus repens, in broad-leaved crops. Tepraloxydim, as well as methods of preparing tepraloxydim, are known in the art. Its herbicidal activity is described in The Pesticide Manual, Fifteenth Edition, 2009.

In some embodiments, tepraloxydim can be provided as an agriculturally acceptable salt or ester of tepraloxydim.

The tepraloxydim or agriculturally acceptable salt or ester thereof can be applied to vegetation or an area adjacent the vegetation or applied to soil or water to prevent the emergence or growth of vegetation in an amount sufficient to induce a herbicidal effect. In some embodiments, the tepraloxydim or agriculturally acceptable salt or ester thereof is applied to vegetation or an area adjacent the vegetation or applied to soil or water to prevent the emergence or growth of vegetation in an amount of 24 g ai/ha or more (e.g., 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, or 200 g ai/ha or more).

In some embodiments, the tepraloxydim or agriculturally acceptable salt or ester thereof is applied to vegetation or an area adjacent the vegetation or applied to soil or water to prevent the emergence or growth of vegetation in an amount of 201 g ai/ha or less (e.g., 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, or 25 g ai/ha or less).

The tepraloxydim or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the tepraloxydim or agriculturally acceptable salt or ester thereof is applied to vegetation or an area adjacent the vegetation or applied to soil or water to prevent the emergence or growth of vegetation in an amount of 25-200 g ai/ha (e.g., 25-190 g ai/ha, 25-180 g ai/ha, 25-175 g ai/ha, 25-170 g ai/ha, 25-165 g ai/ha, 25-160 g ai/ha, 25-155 g ai/ha, 25-150 g ai/ha, 30-140 g ai/ha, 35-130 g ai/ha, 40-120 g ai/ha, 45-110 g ai/ha, or 50-100 g ai/ha,).

Tralkoxydim

Compositions and methods of the present disclosure can include tralkoxydim or an agriculturally acceptable salt or ester thereof. Tralkoxydim is a cyclohexanedione herbicide that has the chemical name 2-[1-(ethoxyimino)propyl]-3-hydroxy-5-mesitylcyclohex-2-enone, and has the following structure:

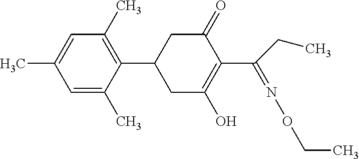 [SMILES: CCON=C(CC)C1=C(O)CC(c2c(C)cc(C)cc2C)CC1=O]

Tralkoxydim is used for post-emergence control of annual grass weeds (including Avena spp., Lolium spp., Setaria viridis, Phalaria spp., Alopecurus myosuroides, and Apera spica-venti) in wheat and barley. Tralkoxydim, as well as methods of preparing tralkoxydim, are known in the art. Its herbicidal activity is described in The Pesticide Manual, Fifteenth Edition, 2009.

In some embodiments, tralkoxydim can be provided as an agriculturally acceptable salt or ester of tralkoxydim.

The tralkoxydim or agriculturally acceptable salt or ester thereof can be applied to vegetation or an area adjacent the vegetation or applied to soil or water to prevent the emergence or growth of vegetation in an amount of 95 grams active ingredient per hectare (g ai/ha) or more (e.g., 100 g ai/ha or more, 105 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 225 g ai/ha or more, 250 g ai/ha or more, 275 g ai/ha or more, 300 g ai/ha or more, 325 g ai/ha or more, 350 g ai/ha or more, 375 g ai/ha or more, 400 g ai/ha or more, 425 g ai/ha or more, 450 g ai/ha or more, 475 g ai/ha or more, or 500 g ai/ha or more).

In some embodiments, the tralkoxydim or agriculturally acceptable salt or ester thereof is applied to vegetation or an area adjacent the vegetation or applied to soil or water to prevent the emergence or growth of vegetation in an amount of 501 g ai/ha or less (e.g., 500 g ai/ha or less, 475 g ai/ha or less, 450 g ai/ha or less, 425 g ai/ha or less, 400 g ai/ha or less, 375 g ai/ha or less, 350 g ai/ha or less, 325 g ai/ha or less, 300 g ai/ha or less, 275 g ai/ha or less, 250 g ai/ha or less, 225 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, or 100 g ai/ha or less).

The tralkoxydim or an agriculturally acceptable salt or ester thereof can be applied to vegetation or an area adjacent the vegetation or applied to soil or water to prevent the emergence or growth of vegetation in an amount ranging from any of the minimum values described above to any of the maximum values described above. In some embodiments, the tralkoxydim or agriculturally acceptable salt or ester thereof is applied to vegetation or an area adjacent the vegetation or applied to soil or water to prevent the emergence or growth of vegetation in an amount of 100-500 g ai/ha (e.g., 110-475 g ai/ha, 120-450 g ai/ha, 130-425 g ai/ha, 140-400 g ai/ha, 150-400 g ai/ha, 150-375 g ai/ha, 160-350 g ai/ha, 170-325 g ai/ha, 180-300 g ai/ha, or 190-275 g ai/ha).

Pinoxaden

Compositions and methods of the present disclosure can include pinoxaden or an agriculturally acceptable salt thereof. Pinoxaden, shown below, is a phenylpyrazoline herbicide that provides post-emergence control of annual grasses, including Alopecurus, Apera, Avena, Lolium, Phalaris and Setaria spp., in wheat and barley. Pinoxaden, as well as methods of preparing pinoxaden, are known in the art. Its herbicidal activity is described in The Pesticide Manual, Fifteenth Edition, 2009.

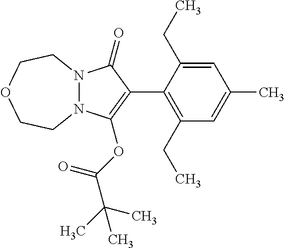 [SMILES: CCc1cc(C)cc(CC)c1-c1c(OC(=O)C(C)(C)C)n2n(c1=O)CCOCC2]

In some embodiments, pinoxaden can be provided as an agriculturally acceptable salt of pinoxaden.

The pinoxaden or an agriculturally acceptable salt thereof can be applied to vegetation or an area adjacent the vegetation or applied to soil or water to prevent the emergence or growth of vegetation in an amount sufficient to induce a herbicidal effect. In some embodiments, the pinoxaden or an agriculturally acceptable salt thereof is applied to vegetation or an area adjacent the vegetation or applied to soil or water to prevent the emergence or growth of vegetation in an amount of 1.9 g ai/ha or more (e.g., 2 g ai/ha or more, 4 g ai/ha or more, 6 g ai/ha or more, 8 g ai/ha or more, 10 g ai/ha or more, 12 g ai/ha or more, 14 g ai/ha or more, 16 g ai/ha or more, 18 g ai/ha or more, 20 g ai/ha or more, 22 g ai/ha or more, 24 g ai/ha or more, 26 g ai/ha or more, 28 g ai/ha or more, 30 g ai/ha or more, 35 g ai/ha or more, 40 g ai/ha or more, 45 g ai/ha or more, 50 g ai/ha or more, 60 g ai/ha or more, 70 g ai/ha or more, 80 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 260 g ai/ha or more, 280 g ai/ha or more, 300 g ai/ha or more, 320 g ai/ha or more, 340 g ai/ha or more, 360 g ai/ha or more, 380 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 620 g ai/ha or more, 640 g ai/ha or more, 660 g ai/ha or more, 680 g ai/ha or more, 700 g ai/ha or more, 750 g ai/ha or more, 800 g ai/ha or more, 850 g ai/ha or more, or 900 g ai/ha or more).

In some embodiments, the pinoxaden or an agriculturally acceptable salt thereof is applied to vegetation or an area adjacent the vegetation or applied to soil or water to prevent the emergence or growth of vegetation in an amount of 901 g ai/ha or less (e.g., 900 g ai/ha or less, 850 g ai/ha or less, 800 g ai/ha or less, 750 g ai/ha or less, 700 g ai/ha or less, 680 g ai/ha or less, 660 g ai/ha or less, 640 g ai/ha or less, 620 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 380 g ai/ha or less, 360 g ai/ha or less, 340 g ai/ha or less, 320 g ai/ha or less, 300 g ai/ha or less, 290 g ai/ha or less, 280 g ai/ha or less, 270 g ai/ha or less, 260 g ai/ha or less, 250 g ai/ha or less, 240 g ai/ha or less, 235 g ai/ha or less, 230 g ai/ha or less, 225 g ai/ha or less, 220 g ai/ha or less, 215 g ai/ha or less, 210 g ai/ha or less, 205 g ai/ha or less, 200 g ai/ha or less, 195 g ai/ha or less, 190 g ai/ha or less, 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 140 g ai/ha or less, 130 g ai/ha or less, 120 g ai/ha or less, 110 g ai/ha or less, 100 g ai/ha or less, 90 g ai/ha or less, 80 g ai/ha or less, 70 g ai/ha or less, 60 g ai/ha or less, 50 g ai/ha or less, 45 g ai/ha or less, 40 g ai/ha or less, 35 g ai/ha or less, 30 g ai/ha or less, 28 g ai/ha or less, 26 g ai/ha or less, 24 g ai/ha or less, 22 g ai/ha or less, 20 g ai/ha or less, 18 g ai/ha or less, 16 g ai/ha or less, 14 g ai/ha or less, 12 g ai/ha or less, 10 g ai/ha or less, 8 g ai/ha or less, 6 g ai/ha or less, 4 g ai/ha or less, or 2 g ai/ha or less).

The pinoxaden or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the pinoxaden or an agriculturally acceptable salt thereof is applied to vegetation or an area adjacent the vegetation or applied to soil or water to prevent the emergence or growth of vegetation in an amount of 2-900 g ai/ha (e.g., 2-800 g ai/ha, 2-600 g ai/ha, 2-500 g ai/ha, 5-500 g ai/ha, 10-500 g ai/ha, 20-500 g ai/ha, 40-500 g ai/ha, 60-500 g ai/ha, 80-500 g ai/ha, 100-500 g ai/ha, 150-500 g ai/ha, 200-500 g ai/ha, 250-500 g ai/ha, 300-500 g ai/ha, 3-400 g ai/ha, 3-300 g ai/ha, 3-200 g ai/ha, 3-100 g ai/ha, 3-50 g ai/ha, 3-20 g ai/ha, 5-30 g ai/ha, 10-50 g ai/ha, 20-50 g ai/ha, or 30-60 g ai/ha).

### II. Compositions

A. Herbicidal Mixtures or Combinations

The (a) pyridine carboxylic acid herbicide or an agriculturally acceptable N-oxide, salt, or ester thereof is mixed with or applied in combination with (b) an ACCase inhibitor or an agriculturally acceptable salt or ester thereof (a) and (b) can be provided in an amount sufficient to induce a herbicidal effect. In some embodiments, (a) and (b) are used in an amount sufficient to induce an unexpected herbicidal effect while still showing good crop compatibility (such as their use in crops does not result in increased damage to crops when compared to the individual application of the herbicidal compounds (a) or (b)). In some embodiments, (a) and (b) can be provided together to furnish a herbicidal effect that is more than the additive effect of (a) and (b) when used separately. In some embodiments, the damage or injury to the undesired vegetation caused by the compositions and methods disclosed herein is evaluated using a scale from 0% to 100%, when compared with the untreated control vegetation, wherein 0% indicates no damage to the undesired vegetation and 100% indicates complete destruction of the undesired vegetation.

In some embodiments, the joint action of a pyridine carboxylic acid herbicide or an agriculturally acceptable N-oxide, salt, or ester thereof and an ACCase inhibitor or an agriculturally acceptable salt or ester thereof results in enhanced activity against undesired vegetation, even at application rates below those typically used for the pesticide to have a herbicidal effect on its own. In some embodiments, the compositions and methods disclosed herein can, based on the individual components, be used at lower application rates to achieve a herbicidal effect comparable to the effect produced by the individual components at normal application rates. In some embodiments, the compositions and methods disclosed herein provide an accelerated action on undesired vegetation (e.g., they effect damaging of undesired vegetation more quickly compared with application of the individual herbicides).

In some embodiments, the observed effect for undesired vegetation is at least 1%, at least 2%, at least 3%, at least 4%, at least 5%, at least 10%, at least 15%, at least 20%, or at least 25% greater than the effect (E) calculated according to the Colby method (e.g., an observed effect of 96% would be 4% greater than an calculated effect (E) of 92%). In some embodiments, for undesired vegetation, the difference (Do) between 100% and the observed effect is at least 5%, at least 10%, at least 15%, at least 20%, at least 25%, at least 30%, at least 35%, at least 40%, at least 45%, or at least 50% less than the difference (D_{E}) between 100% and the effect (E) calculated according to the Colby equation (e.g., an observed effect of 96% would produce a Do of 4%, a calculated effect (E) of 92% would produce a D_{E} of 8%, and Do would be 50% less than or half of D_{E}).

In some embodiments, the weight ratio of (a) a pyridine carboxylic acid herbicide or an agriculturally acceptable N-oxide, salt, or ester thereof (in g ae/ha) to (b) an ACCase inhibitor or an agriculturally acceptable salt or ester thereof (in g ai/ha) is 1:2800 or more, 1:2600 or more, 1:2400 or more, 1:2200 or more, 1:2000 or more, 1:1800 or more, 1:1600 or more, 1:1400 or more, 1:1200 or more, 1:1000 or more, 1:900 or more, 1:800 or more, 1:700 or more, 1:600 or more, 1:500 or more, 1:400 or more, 1:300 or more, 1:200 or more, 1:100 or more, 1:90 or more, 1:80 or more, 1:70 or more, 1:60 or more, 1:50 or more, 1:40 or more, 1:30 or more, 1:20 or more, 1:10 or more, 1:9 or more, 1:8 or more, 1:7 or more, 1:6 or more, 1:5 or more, 1:4 or more, 1:3 or more, 1:2 or more, 1:1.9 or more, 1:1.8 or more, 1:1.7 or more, 1:1.6 or more, 1:1.5 or more, 1:1.4 or more, 1:1.3 or more, 1:1.2 or more, 1:1.1 or more, 1:1 or more, 1.1:1 or more, 1.2:1 or more, 1.3:1 or more, 1.4:1 or more, 1.5:1 or more, 1.6:1 or more, 1.7:1 or more, 1.8:1 or more, 1.9:1 or more, 2:1 or more, 3:1 or more, 4:1 or more, 5:1 or more, 6:1 or more, 7:1 or more, 8:1 or more, 9:1 or more, 10:1 or more, 20:1 or more, 30:1 or more, 40:1 or more, 50:1 or more, 60:1 or more, 70:1 or more, 80:1 or more, 90:1 or more, 100:1 or more, 200:1 or more, 500:1 or more, or 1000:1 or more.

In some embodiments, the weight ratio of (a) a pyridine carboxylic acid herbicide or an agriculturally acceptable N-oxide, salt, or ester thereof (in g ae/ha) to (b) an ACCase inhibitor or an agriculturally acceptable salt or ester thereof (in g ai/ha) is 1000:1 or less, 500:1 or less, 200:1 or less, 100:1 or less, 90:1 or less, 80:1 or less, 70:1 or less, 60:1 or less, 50:1 or less, 40:1 or less, 30:1 or less, 20:1 or less, 10:1 or less, 9:1 or less, 8:1 or less, 7:1 or less, 6:1 or less, 5:1 or less, 4:1 or less, 3:1 or less, 2:1 or less, 1.9:1 or less, 1.8:1 or less, 1.7:1 or less, 1.6:1 or less, 1.5:1 or less, 1.4:1 or less, 1.3:1 or less, 1.2:1 or less, 1.1:1 or less, 1:1 or less, 1:1.1 or less, 1:1.2 or less, 1:1.3 or less, 1:1.4 or less, 1:1.5 or less, 1:1.6 or less, 1:1.7 or less, 1:1.8 or less, 1:1.9 or less, 1:2 or less, 1:3 or less, 1:4 or less, 1:5 or less, 1:6 or less, 1:7 or less, 1:8 or less, 1:9 or less, 1:10 or less, 1:20 or less, 1:30 or less, 1:40 or less, 1:50 or less, 1:60 or less, 1:70 or less, 1:80 or less, 1:90 or less, 1:100 or less, 1:200 or less, 1:300 or less, 1:400 or less, 1:500 or less, 1:600 or less, 1:700 or less, 1:800 or less, 1:900 or less, 1:1000 or less, 1:1200 or less, 1:1400 or less, 1:1600 or less, 1:1800 or less, 1:2000 or less, 1:2200 or less, 1:2400 or less, 1:2600 or less, 1:2800 or less, or 1:3000 or less.

The weight ratio of (a) a pyridine carboxylic acid herbicide or an agriculturally acceptable N-oxide, salt, or ester thereof (in g ae/ha) to (b) an ACCase inhibitor or an agriculturally acceptable salt or ester thereof (in g ai/ha) can range from any of the minimum ratios described above to any of the maximum values described above. In some embodiments, the weight ratio of (a) a pyridine carboxylic acid herbicide or an agriculturally acceptable N-oxide, salt, or ester thereof (in g ae/ha) to (b) an ACCase inhibitor or an agriculturally acceptable salt or ester thereof (in g ai/ha) is from 1:3000 to 1000:1, from 1:3000 to 600:1, from 1:2500 to 400:1, from 1:2000 to 200:1, from 1:1500 to 500:1, from 1:1000 to 100:1, 1:800 to 400:1, from 1:500 to 160:1, from 1:400 to 200:1, from 1:200 to 100:1, from 1:100 to 100:1, from 1:50 to 50:1, from 1:50 to 16:1, from 1:40 to 40:1, from 1:30 to 30:1, from 1:20 to 20:1, from 1:10 to 10:1, 1:1000 to 20:1, from 1:900 to 10:1, from 1:900 to 50:1, from 1:800 to 40:1, from 1:700 to 30:1, from 1:600 to 20:1, from 1:500 to 15:1, from 1:400 to 10:1, from 1:300 to 9:1, from 1:200 to 8:1, from 1:100 to 7:1, from 1:50 to 6:1, from 1:40 to 5:1, from 1:30 to 4:1, from 1:20 to 3:1, from 1:10 to 3:1, from 1:10 to 2:1, from 1:5 to 5:1, from 1:4 to 4:1, from 1:3 to 3:1, or from 1:2 to 2:1).

In some embodiments, (b) includes an aryloxyphenoxypropionate or an agriculturally acceptable salt or ester thereof. In some embodiments, the weight ratio of (a) a pyridine carboxylic acid herbicide or an agriculturally acceptable N-oxide, salt, or ester thereof (in g ae/ha) to (b) an aryloxyphenoxypropionate herbicide or an agriculturally acceptable salt or ester thereof (in g ai/ha) is 1:2500 or more (e.g., 1:2400 or more, 1:2300 or more, 1:2200 or more, 1:2100 or more, 1:2000 or more, 1:1900 or more, 1:1800 or more, 1:1700 or more, 1:1600 or more, 1:1500 or more, 1:1400 or more, 1:1300 or more, 1:1200 or more, 1:1100 or more, 1:1000 or more, 1:900 or more, 1:800 or more, 1:700 or more, 1:600 or more, 1:500 or more, 1:400 or more, 1:300 or more, 1:200 or more, 1:100 or more, 1:90 or more, 1:80 or more, 1:70 or more, 1:60 or more, 1:50 or more, 1:40 or more, 1:30 or more, 1:20 or more, 1:10 or more, 1:9 or more, 1:8 or more, 1:7 or more, 1:6 or more, 1:5 or more, 1:4 or more, 1:3 or more, 1:2 or more, 1:1.9 or more, 1:1.8 or more, 1:1.7 or more, 1:1.6 or more, 1:1.5 or more, 1:1.4 or more, 1:1.3 or more, 1:1.2 or more, 1:1.1 or more, 1:1 or more, 1.1:1 or more, 1.2:1 or more, 1.3:1 or more, 1.4:1 or more, 1.5:1 or more, 1.6:1 or more, 1.7:1 or more, 1.8:1 or more, 1.9:1 or more, 2:1 or more, 3:1 or more, 4:1 or more, 5:1 or more, 6:1 or more, 7:1 or more, 8:1 or more, 9:1 or more, 10:1 or more, 20:1 or more, 30:1 or more, 40:1 or more, 50:1 or more, 60:1 or more, 70:1 or more, 80:1 or more, 90:1 or more, 100:1 or more, 200:1 or more, 300:1 or more, 400:1 or more, 500:1 or more, 600:1 or more, 700:1 or more, 800:1 or more, 900:1 or more, 1000:1 or more, or 1100:1 or more).

In some embodiments, the weight ratio of (a) a pyridine carboxylic acid herbicide or an agriculturally acceptable N-oxide, salt, or ester thereof (in g ae/ha) to (b) an aryloxyphenoxypropionate herbicide or an agriculturally acceptable salt or ester thereof (in g ai/ha) is 1200:1 or less (e.g., 1100:1 or less, 1000:1 or less, 900:1 or less, 800:1 or less, 700:1 or less, 600:1 or less, 500:1 or less, 400:1 or less, 300:1 or less, 200:1 or less, 100:1 or less, 90:1 or less, 80:1 or less, 70:1 or less, 60:1 or less, 50:1 or less, 40:1 or less, 30:1 or less, 20:1 or less, 10:1 or less, 9:1 or less, 8:1 or less, 7:1 or less, 6:1 or less, 5:1 or less, 4:1 or less, 3:1 or less, 2:1 or less, 1.9:1 or less, 1.8:1 or less, 1.7:1 or less, 1.6:1 or less, 1.5:1 or less, 1.4:1 or less, 1.3:1 or less, 1.2:1 or less, 1.1:1 or less, 1:1 or less, 1:1.1 or less, 1:1.2 or less, 1:1.3 or less, 1:1.4 or less, 1:1.5 or less, 1:1.6 or less, 1:1.7 or less, 1:1.8 or less, 1:1.9 or less, 1:2 or less, 1:3 or less, 1:4 or less, 1:5 or less, 1:6 or less, 1:7 or less, 1:8 or less, 1:9 or less, 1:10 or less, 1:20 or less, 1:30 or less, 1:40 or less, 1:50 or less, 1:60 or less, 1:70 or less, 1:80 or less, 1:90 or less, 1:100 or less, 1:200 or less, 1:300 or less, 1:400 or less, 1:500 or less, 1:600 or less, 1:700 or less, 1:800 or less, 1:900 or less, 1:1000 or less, 1:1100 or less, 1:1200 or less, 1:1300 or less, 1:1400 or less, 1:1500 or less, 1:1600 or less, 1:1700 or less, 1:1800 or less, 1:1900 or less, 1:2000 or less, 1:2100 or less, 1:2200 or less, 1:2300 or less, 1:2400 or less, or 1:2500 or less).

The weight ratio of (a) a pyridine carboxylic acid herbicide or an agriculturally acceptable N-oxide, salt, or ester thereof to (b) an aryloxyphenoxypropionate herbicide or an agriculturally acceptable salt or ester thereof can range from any of the minimum ratios described above to any of the maximum values described above. In some embodiments, the weight ratio of (a) a pyridine carboxylic acid herbicide or an agriculturally acceptable N-oxide, salt, or ester thereof to (b) aryloxyphenoxypropionate or an agriculturally acceptable salt or ester thereof is from 1:2500 to 1200:1 (e.g., from 1:2500 to 1000:1, from 1:2500 to 800:1, from 1:2500 to 600:1, from 1:1500 to 500:1, from 1:1300 to 400:1, from 1:700 to 200:1, from 1:500 to 190:1, from 1:500 to 160:1, from 1:300 to 180:1, from 1:200 to 170:1, from 1:50 to 120:1, from 1:1.5 to 150:1, from 1:1.5 to 100:1, from 1:1.5 to 50:1, from 1:10 to 16:1, or from 1:1.5 to 40:1). In certain embodiments, the weight ratio of (a) a pyridine carboxylic acid herbicide or an agriculturally acceptable N-oxide, salt, or ester thereof to (b) an aryloxyphenoxypropionate herbicide or an agriculturally acceptable salt or ester thereof is from from 1:50 to 16:1, 1:20 to 10:1, from 1:15 to 5:1, or from 1:10 to 3:1.

In some embodiments, (b) includes an cyclohexanedione herbicide or an agriculturally acceptable salt or ester thereof. In some embodiments, the weight ratio of (a) a pyridine carboxylic acid herbicide or an agriculturally acceptable N-oxide, salt, or ester thereof (in g ae/ha) to (b) a cyclohexanedione herbicide or an agriculturally acceptable salt or ester thereof (in g ai/ha) is 1:3400 or more (e.g., 1:3200 or more, 1:3000 or more, 1:2800 or more, 1:2600 or more, 1:2400 or more, 1:2200 or more, 1:2000 or more, 1:1800 or more, 1:1600 or more, 1:1400 or more, 1:1200 or more, 1:1000 or more, 1:900 or more, 1:800 or more, 1:700 or more, 1:600 or more, 1:500 or more, 1:400 or more, 1:300 or more, 1:200 or more, 1:100 or more, 1:90 or more, 1:80 or more, 1:70 or more, 1:60 or more, 1:50 or more, 1:40 or more, 1:30 or more, 1:20 or more, 1:10 or more, 1:9 or more, 1:8 or more, 1:7 or more, 1:6 or more, 1:5 or more, 1:4 or more, 1:3 or more, 1:2 or more, 1:1.9 or more, 1:1.8 or more, 1:1.7 or more, 1:1.6 or more, 1:1.5 or more, 1:1.4 or more, 1:1.3 or more, 1:1.2 or more, 1:1.1 or more, 1:1 or more, 1.1:1 or more, 1.2:1 or more, 1.3:1 or more, 1.4:1 or more, 1.5:1 or more, 1.6:1 or more, 1.7:1 or more, 1.8:1 or more, 1.9:1 or more, 2:1 or more, 3:1 or more, 4:1 or more, 5:1 or more, 6:1 or more, 7:1 or more, 8:1 or more, 9:1 or more, 10:1 or more, 15:1 or more, 20:1 or more, 25:1 or more, 30:1 or more, 35:1 or more, 40:1 or more, 45:1 or more, 50:1 or more, 51:1 or more, 52:1 or more, 53:1 or more, 54:1 or more, 55:1 or more, 56:1 or more, 57:1 or more, 58:1 or more, or 59:1 or more).

In some embodiments, the weight ratio of (a) a pyridine carboxylic acid herbicide or an agriculturally acceptable N-oxide, salt, or ester thereof (in g ae/ha) to (b) a cyclohexanedione herbicide or an agriculturally acceptable salt or ester thereof (in g ai/ha) is 60:1 or less (e.g., 59:1 or less, 58:1 or less, 57:1 or less, 56:1 or less, 55:1 or less, 54:1 or less, 53:1 or less, 52:1 or less, 51:1 or less, 50:1 or less, 45:1 or less, 40:1 or less, 35:1 or less, 30:1 or less, 25:1 or less, 20:1 or less, 15:1 or less, 10:1 or less, 9:1 or less, 8:1 or less, 7:1 or less, 6:1 or less, 5:1 or less, 4:1 or less, 3:1 or less, 2:1 or less, 1.9:1 or less, 1.8:1 or less, 1.7:1 or less, 1.6:1 or less, 1.5:1 or less, 1.4:1 or less, 1.3:1 or less, 1.2:1 or less, 1.1:1 or less, 1:1 or less, 1:1.1 or less, 1:1.2 or less, 1:1.3 or less, 1:1.4 or less, 1:1.5 or less, 1:1.6 or less, 1:1.7 or less, 1:1.8 or less, 1:1.9 or less, 1:2 or less, 1:3 or less, 1:4 or less, 1:5 or less, 1:6 or less, 1:7 or less, 1:8 or less, 1:9 or less, 1:10 or less, 1:20 or less, 1:30 or less, 1:40 or less, 1:50 or less, 1:60 or less, 1:70 or less, 1:80 or less, 1:90 or less, 1:100 or less, 1:200 or less, 1:300 or less, 1:400 or less, 1:500 or less, 1:600 or less, 1:700 or less, 1:800 or less, 1:900 or less, 1:1000 or less, 1:1200 or less, 1:1400 or less, 1:1600 or less, 1:1800 or less, 1:2000 or less, 1:2200 or less, 1:2400 or less, 1:2600 or less, 1:2800 or less, 1:3000 or less, or 1:3200 or less).

The weight ratio of (a) a pyridine carboxylic acid herbicide or an agriculturally acceptable N-oxide, salt, or ester thereof to (b) a cyclohexanedione herbicide or an agriculturally acceptable salt or ester thereof can range from any of the minimum ratios described above to any of the maximum values described above. In some embodiments, the weight ratio of (a) a pyridine carboxylic acid herbicide or an agriculturally acceptable N-oxide, salt, or ester thereof to (b) an cyclohexanedione or an agriculturally acceptable salt or ester thereof is from 1:3000 to 500:1 (e.g., from 1:2500 to 400:1, from 1:2000 to 300:1, from 1:1500 to 250:1, from 1:1000 to 150:1, from 1:750 to 125:1, from 1:500 to 80:1, from 1:440 to 50:1, from 1:280 to 25:1, from 1:160 to 26:1, from 1:100 to 10:1, from 1:50 to 5:1, or from 1:30 to 5:1). In certain embodiments, the weight ratio of (a) a pyridine carboxylic acid herbicide or an agriculturally acceptable N-oxide, salt, or ester thereof to (b) a cyclohexanedione herbicide or an agriculturally acceptable salt or ester thereof is from 1:20 to 10:1, or from 1:10 to 5:1.

In some embodiments, (b) includes phenylpyrazoline or an agriculturally acceptable salt or ester thereof. In some embodiments, the weight ratio of (a) a pyridine carboxylic acid herbicide or an agriculturally acceptable N-oxide, salt, or ester thereof (in g ae/ha) to (b) a phenylpyrazoline herbicide or an agriculturally acceptable salt or ester thereof (in g ai/ha) is 1:3000 or more (e.g., 1:2000 or more, 1:1500 or more, 1:1400 or more, 1:1300 or more, 1:1200 or more, 1:1100 or more, 1:1000 or more, 1:900 or more, 1:800 or more, 1:700 or more, 1:600 or more, 1:500 or more, 1:400 or more, 1:300 or more, 1:200 or more, 1:100 or more, 1:90 or more, 1:80 or more, 1:70 or more, 1:60 or more, 1:50 or more, 1:40 or more, 1:30 or more, 1:20 or more, 1:15 or more, 1:10 or more, 1:5 or more, 1:2.5 or more, 1:1.25 or more, 1:1.1 or more, 1:1 or more, 1.1:1 or more, 1.25:1 or more, 1.5:1 or more, 2:1 or more, 3:1 or more, 4:1 or more, 5:1 or more, 6:1 or more, 7:1 or more, 8:1 or more, 9:1 or more, 10:1 or more, 12:1 or more, 14:1 or more, 16:1 or more, 18:1 or more, 20:1 or more, 22:1 or more, 24:1 or more, 26:1 or more, 28:1 or more, 30:1 or more, 32:1 or more, 34:1 or more, 36:1 or more, 38:1 or more, 40:1 or more, 50:1 or more, 60:1 or more, 70:1 or more, 80:1 or more, 90:1 or more, 100:1 or more, 150:1 or more, 200:1 or more, 250:1 or more, 300:1 or more, 350:1 or more, 400:1 or more, 450:1 or more, or 500:1 or more).

In some embodiments, the weight ratio of (a) a pyridine carboxylic acid herbicide or an agriculturally acceptable N-oxide, salt, or ester thereof (in g ae/ha) to (b) a phenylpyrazoline herbicide or an agriculturally acceptable salt or ester thereof (in g ai/ha) is 500:1 or less (e.g., 450:1 or less, 400:1 or less, 350:1 or less, 300:1 or less, 250:1 or less, 200:1 or less, 150:1 or less, 100:1 or less, 150:1 or less, 50:1 or less, 40:1 or less, 30:1 or less, 20:1 or less, 18:1 or less, 16:1 or less, 14:1 or less, 12:1 or less, 10:1 or less, 9:1 or less, 8:1 or less, 7:1 or less, 6:1 or less, 5:1 or less, 4:1 or less, 3:1 or less, 2:1 or less, 1.5:1 or less, 1.25:1 or less, 1.1:1 or less, 1:1 or less, 1:1.1 or less, 1:1.25 or less, 1:2.5 or less, 1:5 or less, 1:10 or less, 1:15 or less, 1:20 or less, 1:30 or less, 1:40 or less, 1:50 or less, 1:60 or less, 1:70 or less, 1:80 or less, 1:90 or less, 1:100 or less, 1:125 or less, 1:150 or less, 1:175 or less, 1:200 or less, 1:225 or less, 1:250 or less, 1:300 or less, 1:350 or less, 1:400 or less, 1:500 or less, 1:600 or less, 1:700 or less, 1:800 or less, 1:900 or less, 1:1000 or less, 1:1100 or less, 1:1200 or less, 1:1300 or less, 1:1400 or less, 1:1500 or less, 1:1800 or less, 1:2000 or less, or 1:3000 or less).

The weight ratio of (a) a pyridine carboxylic acid herbicide or an agriculturally acceptable N-oxide, salt, or ester thereof to (b) a phenylpyrazoline herbicide or an agriculturally acceptable salt or ester thereof can range from any of the minimum ratios described above to any of the maximum values described above. In some embodiments, the weight ratio of (a) a pyridine carboxylic acid herbicide or an agriculturally acceptable N-oxide, salt, or ester thereof to (b) a phenylpyrazoline herbicide or an agriculturally acceptable salt thereof is from 1:3000 to 500:1 (e.g., from 1:1500 to 250:1, from 1:1500 to 150:1, from 1:1400 to 50:1, 1:1300 to 50:1, from 1:1200 to 47:1, from 1:1100 to 45:1, from 1:1000 to 42:1, from 1:900 to 40:1, from 1:800 to 40:1, 1:700 to 40:1 from 1:600 to 40:1, from 1:500 to 80:1, from 1:500 to 60:1, from 1:400 to 40:1, from 1:300 to 40:1, from 1:250 to 40:1, from 1:200 to 40:1, from 1:150 to 40:1, from 1:150 to 25:1, from 1:130 to 30:1, 1:120 to 20:1, or from 1:100 to 10:1). In certain embodiments, the weight ratio of (a) a pyridine carboxylic acid herbicide or an agriculturally acceptable N-oxide, salt, or ester thereof to (b) a phenylpyrazoline herbicide or an agriculturally acceptable salt or ester thereof is from 1:50 to 10:1, from 1:30 to 5:1, or from 1:25 to 5:1.

In some embodiments, the active ingredients in the compositions disclosed herein consist of (a) a pyridine carboxylic acid herbicide or an agriculturally acceptable N-oxide, salt, or ester thereof and (b) an ACCase inhibitor or an agriculturally acceptable salt or ester thereof.

B. Formulations

The present disclosure also relates to formulations of the compositions and methods disclosed herein. In some embodiments, the formulation can be in the form of a single package formulation including: (a) a pyridine carboxylic acid herbicide or an agriculturally acceptable N-oxide, salt, or ester thereof and (b) an ACCase inhibitor or an agriculturally acceptable salt or ester thereof. In some embodiments, the formulation can be in the form of a single package formulation including both (a) and (b) and further including at least one additive. In some embodiments, the formulation can be in the form of a two-package formulation, wherein one package contains (a) and optionally at least one additive while the other package contains (b) and optionally at least one additive. In some embodiments of the two-package formulation, the formulation including (a) and optionally at least one additive and the formulation including (b) and optionally at least one additive are mixed before application and then applied simultaneously. In some embodiments, the mixing is performed as a tank mix (for example, the formulations are mixed immediately before or upon dilution with water). In some embodiments, the formulation including (a) and the formulation including (b) are not mixed but are applied sequentially (in succession), for example, immediately or within 1 hour, within 2 hours, within 4 hours, within 8 hours, within 16 hours, within 24 hours, within 2 days, or within 3 days, of each other.

In some embodiments, the formulation of (a) and (b) is present in suspended, emulsified, or dissolved form. Exemplary formulations include, but are not limited to, aqueous solutions, powders, suspensions, also highly-concentrated aqueous, oily or other suspensions or dispersions, aqueous emulsions, aqueous microemulsions, aqueous suspo-emulsions, oil dispersions, self-emulsifying formulations, pastes, dusts, and materials for spreading or granules.

In some embodiments, (a) a pyridine carboxylic acid herbicide or an agriculturally acceptable N-oxide, salt, or ester thereof and/or (b) an ACCase inhibitor or an agriculturally acceptable salt or ester thereof is an aqueous solution that can be diluted before use. In some embodiments, (a) and/or (b) is provided as a high-strength formulation such as a concentrate. In some embodiments, the concentrate is stable and retains potency during storage and shipping. In some embodiments, the concentrate is a clear, homogeneous liquid that is stable at temperatures of 54° C. or greater. In some embodiments, the concentrate does not exhibit any precipitation of solids at temperatures of −10° C. or higher. In some embodiments, the concentrate does not exhibit separation, precipitation, or crystallization of any components at low temperatures. For example, the concentrate remains a clear solution at temperatures below 0° C. (e.g., below −5° C., below −10° C., below −15° C.). In some embodiments, the concentrate exhibits a viscosity of less than 50 centipoise (50 megapascals), even at temperatures as low as 5° C.

The compositions and methods disclosed herein can also be mixed with or applied with an additive. In some embodiments, the additive can be diluted in water or can be concentrated. In some embodiments, the additive is added sequentially. In some embodiments, the additive is added simultaneously. In some embodiments, the additive is premixed with the pyridine carboxylic acid herbicide or agriculturally acceptable N-oxide, salt, or ester thereof. In some embodiments, the additive is premixed with the ACCase inhibitor or agriculturally acceptable salt or ester thereof.

C. Other Actives

In some embodiments, the additive is an additional pesticide. For example, the compositions described herein can be applied in conjunction with one or more additional herbicides to control undesirable vegetation. The composition can be formulated with the one or more additional herbicides, tank mixed with the one or more additional herbicides, or applied sequentially with the one or more additional herbicides. Exemplary additional herbicides include, but are not limited to: 4-CPA, 4-CPB, 4-CPP, 2,4-D, 2,4-D choline salt, 2,4-D esters and amines, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, aminocyclopyrachlor, 4-aminopicolinic acid based herbicides, such as halauxifen, halauxifen-methyl, florpyrauxifen, florpyrauxifen-benzyl, and those described in U.S. Pat. Nos. 7,314,849 and 7,432,227 to Balko, et al., aminopyralid, amiprofos-methyl, amitrole, ammonium sulfamate, anilofos, anisuron, asulam, atraton, atrazine, azafenidin, aziprotryne, barban, BCPC, beflubutamid, benazolin, bencarbazone, benfluralin, benfuresate, bensulide, benthiocarb, bentazon-sodium, benzadox, benzfendizone, benzipram, benzobicyclon, benzofenap, benzofluor, benzoylprop, benzthiazuron, bicyclopyrone, bifenox, bilanafos, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlornitrofen, chloropon, chlorotoluron, chloroxuron, chloroxynil, chlorpropham, chlorthal, chlorthiamid, cinidon-ethyl, cinmethylin, cisanilide, clacyfos, clethodim, cliodinate, clodinafop-propargyl, clofop, clomazone, clomeprop, cloprop, cloproxydim, clopyralid, CMA, copper sulfate, CPMF, CPPC, credazine, cresol, cumyluron, cyanatryn, cyanazine, cycloate, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethidimuron, ethiolate, ethobenzamid, etobenzamid, ethofumesate, ethoxyfen, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, fluazifop, fluazifop-P-butyl, fluazolate, fluchloralin, flufenacet, flufenican, flufenpyr-ethyl, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, fluridone, flurochloridone, fluroxypyr, fluroxypyr-meptyl, flurtamone, fluthiacet, fomesafen, fosamine, fumiclorac, furyloxyfen, glufosinate, glufosinate-ammonium, glufosinate-P-ammonium, glyphosate salts and esters, halosafen, haloxydine, hexachloroacetone, hexaflurate, hexazinone, indanofan, indaziflam, iodobonil, iodomethane, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lancotrione, lenacil, linuron, MAA, MAMA, MCPA esters and amines, MCPA-thioethyl, MCPB, mecoprop, mecoprop-P, medinoterb, mefenacet, mefluidide, mesoprazine, mesotrione, metam, metamifop, metamitron, metazachlor, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metoxuron, metribuzin, molinate, monalide, monisouron, monochloroacetic acid, monolinuron, monuron, morfamquat, MSMA, naproanilide, napropamide, napropamide-M, naptalam, neburon, nipyraclofen, nitralin, nitrofen, nitrofluorfen, norflurazon, noruron, OCH, orbencarb, ortho-dichlorobenzene, oryzalin, oxadiargyl, oxadiazon, oxapyrazon, oxaziclomefone, oxyfluorfen, paraflufen-ethyl, parafluron, paraquat, pebulate, pelargonic acid, pendimethalin, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, procyazine, prodiamine, profluazol, profluralin, profoxydim, proglinazine, prohexadione-calcium, prometon, prometryn, pronamide, propachlor, propanil, propaquizafop, propazine, propham, propisochlor, propyzamide, prosulfalin, prosulfocarb, proxan, prynachlor, pydanon, pyraclonil, pyraflufen-ethyl, pyrasulfotole, pyrazogyl, pyrazolynate, pyrazoxyfen, pyributicarb, pyriclor, pyridafol, pyridate, quinclorac, quinmerac, quinoclamine, quinonamid, quizalofop, quizalofop-P-ethyl, rhodethanil, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfosate, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiameturon, thiazafluron, thiazopyr, thidiazimin, thidiazuron, thiobencarb, tiafenacil, tiocarbazil, tioclorim, tolpyralate, topramezone, tralkoxydim, tri-allate, triafamone, triaziflam, tricamba, triclopyr choline salt, triclopyr esters and amines, tridiphane, trietazine, trifluralin, trifop, trifopsime, trihydroxytriazine, trimeturon, tripropindan, tritac, vemolate, xylachlor and salts, esters, optically active isomers, and mixtures thereof.

In some embodiments, the additional pesticide or an agriculturally acceptable salt or ester thereof is provided in a premixed formulation with (a), (b), or combinations thereof. In some embodiments, the pyridine carboxylic acid herbicide or an agriculturally acceptable N-oxide, salt, or ester thereof is provided in a premixed formulation with an additional pesticide. In some embodiments, the ACCase inhibitor or an agriculturally acceptable salt or ester thereof is provided in a premixed formulation with an additional pesticide. In some embodiments, the clodinafop, the cyhalofop, the diclofop, the fenoxaprop, the fluazifop, the haloxyfop, the metamifop, the propaquizafop, the quizalofop, or an agriculturally acceptable salt or ester thereof, is provided in a premixed formulation with an additional pesticide. In some embodiments, the alloxydim, the butroxydim, the clethodim, the cycloxydim, the profoxydim, the sethoxydim, the tepraloxydim, the tralkoxydim, or an agriculturally acceptable salt or ester thereof, is provided in a premixed formulation with an additional pesticide. In some embodiments, the pinoxaden, or an agriculturally acceptable salt or ester thereof, is provided in a premixed formulation with an additional pesticide.

D. Adjuvants/Carriers/Colorants/Adhesives

In some embodiments, the additive includes an agriculturally acceptable adjuvant. Exemplary agriculturally acceptable adjuvants include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oil, safeners, adhesives (for instance, for use in seed formulations), surfactants, protective colloids, emulsifiers, tackifiers, and mixtures thereof.

Exemplary agriculturally acceptable adjuvants include, but are not limited to, crop oil concentrate (mineral oil (85%)+emulsifiers (15%)) or less, nonylphenol ethoxylate or less, benzylcocoalkyldimethyl quaternary ammonium salt or less, blend of petroleum hydrocarbon, alkyl esters, organic acid, and anionic surfactant or less, C₉-C₁₁ alkylpolyglycoside or less, phosphate alcohol ethoxylate or less, natural primary alcohol (C₁₂-C₁₆) ethoxylate or less, di-sec-butylphenol EO-PO block copolymer or less, polysiloxane-methyl cap or less, nonylphenol ethoxylate+urea ammonium nitrate or less, emulsified methylated seed oil or less, tridecyl alcohol (synthetic) ethoxylate (8 EO) or less, tallow amine ethoxylate (15 EO) or less, and PEG(400) dioleate-99.

In some embodiments, the additive is a safener, which is an organic compound leading to better crop plant compatibility when applied with a herbicide. In some embodiments, the safener itself is herbicidally active. In some embodiments, the safener acts as an antidote or antagonist in the crop plants and can reduce or prevent damage to the crop plants. Exemplary safeners include, but are not limited to, AD-67 (MON 4660), benoxacor, benthiocarb, brassinolide, cloquintocet (mexyl), cyometrinil, cyprosulfamide, daimuron, dichlormid, dicyclonon, dietholate, dimepiperate, disulfoton, fenchlorazole, fenchlorazole-ethyl, fenclorim, flurazole, fluxofenim, furilazole, harpin proteins, isoxadifen-ethyl, jiecaowan, jiecaoxi, mefenpyr, mefenpyr-diethyl, mephenate, metcamifen, naphthalic anhydride, 2,2,5-trimethyl-3-(dichloroacetyl)-1,3-oxazolidine, 4-(dichloroacetyl)-1-oxa-4-azaspiro [4.5]decane, oxabetrinil, R29148, and N-phenyl-sulfonylbenzoic acid amides, as well as thereof agriculturally acceptable salts and, provided they have a carboxyl group, their agriculturally acceptable derivatives. In some embodiments, the safener can be cloquintocet or an ester or salt or ester thereof, such as cloquintocet (mexyl). In some embodiments, the safener can be dichlormid. In some embodiments, the safener is employed in rice, cereal, corn, or maize. For example, dichlormid or cloquintocet can be used to antagonize harmful effects of the compositions on rice, row crops, and cereals.

Exemplary surfactants (e.g., wetting agents, tackifiers, dispersants, emulsifiers) include, but are not limited to, the alkali metal salts, alkaline earth metal salts and ammonium salts of aromatic sulfonic acids, for example lignosulfonic acids, phenolsulfonic acids, naphthalenesulfonic acids, and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalene sulfonic acids with phenol and formaldehyde, polyoxyethylene octylphenol ether, ethoxylated isooctyl-, octyl- or nonylphenol, alkylphenyl or tributylphenyl polyglycol ether, alkyl aryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denatured proteins, polysaccharides (e.g., methylcellulose), hydrophobically modified starches, polyvinyl alcohol, polycarboxylates, polyalkoxylates, polyvinyl amine, polyethyleneimine, polyvinylpyrrolidone and copolymers thereof.

Exemplary thickeners include, but are not limited to, polysaccharides, such as xanthan gum, and organic and inorganic sheet minerals, and mixtures thereof.

Exemplary antifoam agents include, but are not limited to, silicone emulsions, long-chain alcohols, fatty acids, salts of fatty acids, organofluorine compounds, and mixtures thereof.

Exemplary antimicrobial agents include, but are not limited to, bactericides based on dichlorophen and benzyl alcohol hemiformal, and isothiazolinone derivates, such as alkylisothiazolinones and benzisothiazolinones, and mixtures thereof.

Exemplary antifreeze agents, include, but are not limited to ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

In some embodiments, the additive includes a carrier. In some embodiments, the additive includes a liquid or solid carrier. In some embodiments, the additive includes an organic or inorganic carrier. Exemplary liquid carriers include, but are not limited to, petroleum fractions or hydrocarbons such as mineral oil, aromatic solvents, paraffinic oils, and the like or less, vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like or less, esters of the above vegetable oils or less, esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like or less, esters of mono, di and polycarboxylic acids and the like, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like, and water as well as mixtures thereof. Exemplary solid carriers include, but are not limited to, silicas, silica gels, silicates, talc, kaolin, limestone, lime, chalk, bole, loess, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

In some embodiments, emulsions, pastes or oil dispersions can be prepared by homogenizing (a) and (b) in water by means of wetting agent, tackifier, dispersant or emulsifier. In some embodiments, concentrates suitable for dilution with water are prepared, containing (a), (b), a wetting agent, a tackifier, and a dispersant or emulsifier.

In some embodiments, powders or materials for spreading and dusts can be prepared by mixing or concomitant grinding of (a) and (b) and optionally a safener with a solid carrier.

In some embodiments, granules (e.g., coated granules, impregnated granules and homogeneous granules) can be prepared by binding the (a) and (b) to solid carriers.

The formulations disclosed herein can contain amounts of (a) and (b) that provide a herbicidal effect that is better than the additive effect of (a) and (b) when used separately. In some embodiments, the concentrations of (a) and (b) in the formulations can be varied. In some embodiments, the formulations contain from 1% to 95% (e.g., from 5% to 95%, from 10% to 80%, from 20% to 70%, from 30% to 50%) by total weight of (a) and (b). In formulations designed to be employed as concentrates, (a) and (b) can be present in a concentration of from 0.1 to 98 weight percent (0.5 to 90 weight percent), based on the total weight of the formulation. Concentrates can be diluted with an inert carrier, such as water, prior to application. The diluted formulations applied to undesired vegetation or the locus of undesired vegetation can contain from 0.0006 to 8.0 weight percent of (a) and (b) (e.g., from 0.001 to 5.0 weight percent), based on the total weight of the diluted formulation.

In some embodiments, (a) and (b), independently, can be employed in a purity of from 90% to 100% (e.g., from 95% to 100%) according to nuclear magnetic resonance (NMR) spectrometry. In some embodiments, the concentrations of (a), (b), and additional pesticides in the formulations can be varied. In some embodiments, the formulations contain from 1% to 95% (e.g., from 5% to 95%, from 10% to 80%, from 20% to 70%, from 30% to 50%) by total weight of (a), (b), and additional pesticides. In some embodiments, (a), (b), and additional pesticides or safeners, independently, can be employed in a purity of from 90% to 100% (e.g., from 95% to 100%) according to NMR spectrometry.

### III. Methods of Use

A. Methods of Application

The compositions disclosed herein can be applied in any known technique for applying herbicides. Exemplary application techniques include, but are not limited to, spraying, atomizing, dusting, spreading, or direct application into water (in-water). The method of application can vary depending on the intended purpose. In some embodiments, the method of application can be chosen to ensure the finest possible distribution of the compositions disclosed herein.

In some embodiments, a method of controlling undesirable vegetation which contains contacting the vegetation or the locus thereof with or applying to the soil or water to prevent the emergence or growth of vegetation any of the compositions is disclosed herein.

The compositions disclosed herein can be applied pre-emergence (before the emergence of undesirable vegetation) or post-emergence (e.g., during and/or after emergence of the undesirable vegetation). If desired, the compositions can be applied as an in-water application. In some embodiments, the pyridine carboxylic acid herbicide or or an agriculturally acceptable N-oxide, salt, or ester thereof and the ACCase inhibitor are applied simultaneously. In some embodiments, (a) and (b) can be provided together to furnish a herbicidal effect that is more than the additive effect of (a) and (b) when used separately.

When the compositions are used in crops, the compositions can be applied after seeding and before or after the emergence of the crop plants. In some embodiments, the compositions disclosed herein show good crop tolerance even when the crop has already emerged and can be applied during or after the emergence of the crop plants. In some embodiments, when the compositions are used in crops, the compositions can be applied before seeding of the crop plants.

In some embodiments, the compositions disclosed herein are applied to vegetation or an area adjacent the vegetation or applied to soil or water to prevent the emergence or growth of vegetation by spraying (e.g., foliar spraying). In some embodiments, the spraying techniques use, for example, water as carrier and spray liquor rates of from 10 liters per hectare (L/ha) to 2000 L/ha (e.g., from 50 L/ha to 1000 L/ha or from 100 to 500 L/ha). In some embodiments, the compositions disclosed herein are applied by the low-volume or the ultra-low-volume method. In some embodiments, wherein the compositions disclosed herein are less well tolerated by certain crop plants, the compositions can be applied with the aid of the spray apparatus in such a way that they come into little contact, if any, with the leaves of the sensitive crop plants while reaching the leaves of undesirable vegetation that grows underneath or the bare soil (e.g., post-directed or lay-by). In some embodiments, the compositions disclosed herein can be applied as dry formulations (e.g., granules, WDGs, etc.) into water.

In some embodiments, herbicidal activity is exhibited by the compounds of the mixture when they are applied directly to the plant or to the locus of the plant at any stage of growth or before planting or emergence. The effect observed can depend upon the type of undesirable vegetation to be controlled, the stage of growth of the undesirable vegetation, the application parameters of dilution and spray drop size, the particle size of solid components, the environmental conditions at the time of use, the specific compound employed, the specific adjuvants and carriers employed, the soil type, and the like, as well as the amount of chemical applied. In some embodiments, these and other factors can be adjusted to promote non-selective or selective herbicidal action. In some cases, the compositions are applied to relatively immature undesirable vegetation.

The compositions and methods disclosed herein can be used to control undesired vegetation in a variety of crop and non-crop applications. In some embodiments, the compositions and methods disclosed herein can be used for controlling undesired vegetation in crops. Exemplary crops include, but are not limited to, wheat, barley, triticale, rye, teff, oats, maize, cotton, soy, sorghum, rice, sugarcane and range land (e.g., pasture grasses). In some embodiments, the undesirable vegetation is controlled in a row crop (e.g., maize, sorghum, soybean, cotton, or oilseed rape/canola). In some embodiments, the compositions and methods disclosed herein can be used for controlling undesired vegetation in maize, wheat, rice, barley, or a combination thereof.

The compositions and methods disclosed herein can be used for controlling undesired vegetation in non-crop areas. Exemplary non-crop areas include, but are not limited to, turfgrass, pastures, grasslands, fallow land, rights-of-way, aquatic settings, tree and vine, wildlife management areas, or rangeland. In some embodiments, the compositions and methods disclosed herein can be used in industrial vegetation management (IVM) or for utility, pipeline, roadside, and railroad rights-of-way applications. In some embodiments, the compositions and methods disclosed herein can also be used in forestry (e.g., for site preparation or for combating undesirable vegetation in plantation forests). In some embodiments, the compositions and methods disclosed herein can be used to control undesirable vegetation in conservation reserve program lands (CRP), trees, vines, grasslands, and grasses grown for seeds. In some embodiments, the compositions and methods disclosed herein can be used on lawns (e.g., residential, industrial, and institutional), golf courses, parks, cemeteries, athletic fields, and sod farms.

The compositions and methods disclosed herein can also be used on crop plants that are resistant to, for instance, herbicides, pathogens, and/or insects. In some embodiments, the compositions and methods disclosed herein can be used on crop plants that are resistant to one or more herbicides because of genetic engineering or breeding. In some embodiments, the compositions and methods disclosed herein can be used on crop plants that are resistant to one or more pathogens such as plant pathogenous fungi owing to genetic engineering or breeding. In some embodiments, the compositions and methods disclosed herein can be used in crop plants that are resistant to attack by insects owing to genetic engineering or breeding. Exemplary resistant crops include, but are not limited to, crops that are resistant to photosystem II inhibitors, or crop plants that, owing to introduction of the gene for Bacillus thuringiensis (or Bt) toxin by genetic modification, are resistant to attack by certain insects. In some embodiments, the compositions and methods described herein also can be used in conjunction with glyphosate, glufosinate, dicamba, phenoxy auxins, pyridyloxy auxins, aryloxyphenoxypropionates, acetyl CoA carboxylase (ACCase) inhibitors, 4-hydroxyphenyl-pyruvate dioxygenase (HPPD) inhibitors, protoporphyrinogen oxidase (PPO) inhibitors, triazines, and bromoxynil to control vegetation in crops tolerant to glyphosate, glufosinate, dicamba, phenoxy auxins, pyridyloxy auxins, aryloxyphenoxypropionates, acetyl CoA carboxylase (ACCase) inhibitors, 4-hydroxyphenyl-pyruvate dioxygenase (HPPD) inhibitors, protoporphyrinogen oxidase (PPO) inhibitors, triazines, bromoxynil, or combinations thereof. In some embodiments, the undesirable vegetation is controlled in glyphosate, glufosinate, dicamba, phenoxy auxins, pyridyloxy auxins, aryloxyphenoxypropionates, acetyl CoA carboxylase (ACCase) inhibitors, 4-hydroxyphenyl-pyruvate dioxygenase (HPPD) inhibitors, protoporphyrinogen oxidase (PPO) inhibitors, triazines, and bromoxynil tolerant crops possessing single, multiple or stacked traits conferring tolerance to single or multiple chemistries and/or multiple modes of action. In some embodiments, the undesirable vegetation can be controlled in a crop that is ACCase-tolerant. The combination of (a), (b), and a complementary herbicide or salt or ester thereof can be used in combination with herbicides that are selective for the crop being treated and which complement the spectrum of weeds controlled by these compounds at the application rate employed. In some embodiments, the compositions described herein and other complementary herbicides are applied at the same time, either as a combination formulation or as a tank mix, or as sequential applications.

The compositions and methods may be used in controlling undesirable vegetation in crops possessing agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture).

In some embodiments, the compositions disclosed herein can be used for controlling undesirable vegetation including grasses, broadleaf weeds, sedge weeds, and combinations thereof. In some embodiments, the compositions disclosed herein can be used for controlling undesirable vegetation including, but not limited to, Polygonum species such as wild buckwheat (Polygonum convolvolus), Amaranthus species such as pigweed (Amaranthus retroflexus), Chenopodium species such as common lambsquarters (Chenopodium album L.), Sida species such as prickly sida (Sida spinosa L.), Ambrosia species such as common ragweed (Ambrosia artemisiifolia), Cyperus species such as nutsedge (Cyperus esculentus), Setaria species such as giant foxtail (Setaria faberi), Sorghum species, Acanthospermum species, Anthemis species, Atriplex species, Brassica species, Cirsium species, Convolvulus species, Conyza species, such as horseweed (Conyza canadensis), Cassia species, Commelina species, Datura species, Euphorbia species, Geranium species, Galinsoga species, Ipomea species such as morning-glory, Lamium species, Malva species, Matricaria species, Persicaria species, Prosopis species, Rumex species, Sisymbrium species, Solanum species, Trifolium species, Xanthium species, Veronica species, Viola species such as wild pansy (Viola tricolor), common chickweed (Stellaria media), velvetleaf (Abutilon theophrasti), hemp sesbania (Sesbania exaltata Cory), Anoda cristata, Bidens pilosa, Brassica kaber, shepherd's purse (Capsella bursa-pastoris), cornflower (Centaurea cyanus or Cyanus segetum), Galeopsis tetrahit, cleavers Galium aparine), Helianthus annuus, Desmodium tortuosum, kochia (Kochia scoparia), Medicago arabica, Mercurialis annua, Myosotis arvensis, common poppy (Papaver rhoeas), Raphanus raphanistrum, Russian thistle (Salsola kali), wild mustard (Sinapis arvensis), Sonchus arvensis, Thlaspi arvense, Tagetes minuta, Richardia brasiliensis, Plantago major, Plantago lanceolata, bird's-eye speedwell (Veronica persica) and speedwell.

In certain embodiments, the undesirable vegetation includes velvetleaf (Abutilon theophrasti, ABUTH), blackgrass (Alopecurus myosuroides, ALOMY), pigweed (Amaranthus retroflexus, AMARE), wild oat (Avena fatua, AVEFA), brown mustard (Brassica juncea, BRSJU), rutabaga (Brassica napus var. napobrassica, BRSNA), spring rape (Brassica napus, BRSNN), winter rape (Brassica napus, BRSNW), turnip (Brassica rapa, BRSRR), common lambsquarters (Chenopodium album L., CHEAL), thistle (Cirsium arvense CIRAR), nutsedge (Cyperus esculentus, CYPES), large crabgrass (Digitaria sanguinalis, DIGSA), barnyardgrass (Echinochloa crus-galli, ECHCG), poinsettia (Euphorbia heterophylla, EPHHL), soybean (Glycine max, GLXMA), sunflower (Helianthus annuus, HELAN), ivyleaf momingglory (Ipomoea hederacea, IPOHE), kochia (Kochia scoparia, KCHSC), wild buckwheat (Polygonum convolvulus, POLCO), giant foxtail (Setaria faberi, SETFA), grain sorghum (Sorghum vulgare, SORVU), common chickweed (Stellaria media, STEME), wild pansy (Viola tricolor, VIOTR), or a combination thereof.

The herbicidal compositions described herein can be used to control herbicide resistant or tolerant weeds. The methods employing the compositions described herein may also be employed to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors (e.g., imidazolinones, sulfonylureas, pyrimidinyl(oxy/thio)benzoates, sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors (e.g., aryloxyphenoxypropionates, cyclohexanediones, phenylpyrazolines), synthetic auxins (e.g., benzoic acids, phenoxycarboxylic acids, pyridine carboxylic acids, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidindiones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes-of-action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, biotypes with resistance or tolerance to multiple chemical classes, biotypes with resistance or tolerance to multiple herbicide modes-of-action, and biotypes with multiple resistance or tolerance mechanisms (e.g., target site resistance or metabolic resistance).

By way of non-limiting illustration, examples of certain embodiments of the present disclosure are given below.

### EXAMPLES

### Example 1. Herbicidal Activity of Compounds of Formula (I) and Aryloxyphenoxyproprionate Herbicides on Weeds and Crops in Greenhouse Trials

### Methodology—Evaluation of Postemergence Herbicidal Activity

Seeds of the desired test plant species were planted in Sun Gro MetroMix® 306 planting mixture, which typically has a pH of 6.0 to 6.8 and an organic matter content of about 30 percent, in plastic pots with a surface area of 103.2 square centimeters (cm²). When required to ensure good germination and healthy plants, a fungicide treatment and/or other chemical or physical treatment was applied. The plants were grown for 7-36 days (d) in a greenhouse with an approximate 14-hour (h) photoperiod which was maintained at about 23° C. during the day and 22° C. during the night. Nutrients and water were added on a regular basis and supplemental lighting was provided with overhead metal halide 1000-Watt lamps as necessary. The plants were employed for testing when they reached the second or third true leaf stage.

The compound of Formula (1):

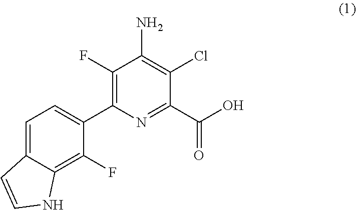 [SMILES: Nc1c(F)c(-c2ccc3cc[nH]c3c2F)nc(C(=O)O)c1Cl]

was used with various ACCase inhibitors in herbicide evaluations.

An emulsifiable concentrate (EC) formulation containing Compound 1 at 100 gai/L was prepared by combining Compound 1 with 1-butyl-2-pyrrolidinone (Tamisolve NxG; 360.5 g/L), benzyl acetate (544.6 g/L) and Agnique MBL 520L surfactant (52.9 g/L). If Compound 1 did not dissolve readily, the mixture was warmed and/or sonicated. The concentrated stock solution was diluted with an aqueous mixture of 1.5% v/v of Agri-dex crop oil concentrate to provide the appropriate application rates. Compound requirements are based upon a 12 milliliter (mL) application volume at a rate of 187 liters per hectare (L/ha). Spray solutions of the experimental compound mixtures were prepared by adding the stock solutions to the appropriate amount of dilution solution to form a 12 mL spray solution in two-way combinations. Formulated compounds were applied to the plant material with an overhead Mandel track sprayer equipped with 8002E nozzles calibrated to deliver 187 L/ha over an application area of 0.503 square meters (m²) at a spray height of 18 inches (43 centimeters (cm)) above average plant canopy. Control plants were sprayed in the same manner with the solvent blank. Application rates for component (a) are in g ae/ha, and application rates for component (b) are in g ai/ha.

The treated plants and control plants were placed in a greenhouse as described above and watered by sub-irrigation to prevent wash-off of the test compounds. After 20-22 d, the condition of the test plants as compared with that of the control plants was determined visually and scored on a scale of 0 to 100 percent where 0 corresponds to no injury and 100 corresponds to complete kill. The condition of the test plants was compared with that of the control plants as determined visually and scored on a scale of 0 to 100 percent, where 0 corresponds to no injury and 100 corresponds to complete kill. The Colby method was used to determine the herbicidal effects expected from the mixtures.

Compound 1 (formulated as an EC) was combined with clodinafop-propargyl and the efficacy of the herbicidal composition on velvetleaf (Abutilon theophrasti, ABUTH), blackgrass (Alopecurus myosuroides, ALOMY), pigweed (Amaranthus retroflexus, AMARE), wild oat (Avena fatua, AVEFA), winter rape (Brassica napus, BRSNW), large crabgrass (Digitaria sanguinalis, DIGSA), ivyleaf momingglory (Ipomoea hederacea, IPOHE), sunflower (Helianthus annuns, HELAN), soybean (Glycine max, GLXMA), barnyardgrass (Echinochloa crus-galli, FECHCG), rice (Oryza sativa, ORYSA), wild buckwheat (Polygonum convolvulus, POLCO), giant foxtail (Setaria faberi, SETFA), grain sorghum (Sorghum vulgare, SORVU), chickweed (Stellaria media, STEME), winter wheat (Triticum aestivum, TRZAW), and maize (Zea mays, ZFAMX) was evaluated. The results are summarized in Table 1.

TABLE 1
Effect (% visual injury) of compound
1 and clodinafop on weeds/crops.

| | | Compound 1 (g ai/ha) | | |
|---|---|---|---|---|
| | | 5 | 0 | 5 |
| | | Clodinafop-propargyl (g ai/ha) | | |
| Application Rate | | 0 | 30 | 30 |
| ABUTH | Obs | 50 | 0 | 75 |
| | Exp | | | 50 |
| ALOMY | Obs | 0 | 10 | 10 |
| | Exp | | | 10 |
| AMARE | Obs | 100 | 0 | 100 |
| | Exp | | | 100 |
| AVEFA | Obs | 0 | 90 | 95 |
| | Exp | | | 90 |
| BRSNW | Obs | 60 | 0 | 50 |
| | Exp | | | 60 |
| DIGSA | Obs | 0 | 95 | 100 |
| | Exp | | | 95 |
| IPOHE | Obs | 10 | 0 | 50 |
| | Exp | | | 10 |
| HELAN | Obs | 95 | 0 | 97 |
| | Exp | | | 95 |
| GLXMA | Obs | 100 | 0 | 100 |
| | Exp | | | 100 |
| ECHCG | Obs | 70 | 100 | 100 |
| | Exp | | | 100 |
| ORYSA | Obs | 0 | 90 | 95 |
| | Exp | | | 90 |
| POLCO | Obs | 95 | 0 | 97 |
| | Exp | | | 95 |
| SETFA | Obs | 65 | 98 | 95 |
| | Exp | | | 99 |
| SORVU | Obs | 40 | 100 | 100 |
| | Exp | | | 100 |
| STEME | Obs | 100 | 0 | 95 |
| | Exp | | | 100 |
| TRZAW | Obs | 0 | 0 | 0 |
| | Exp | | | 0 |
| ZEAMX | Obs | 0 | 100 | 100 |
| | Exp | | | 100 |

g ai/ha = grams active ingredient per hectare
ABUTH = Abutilon theophrasti (velvetleaf)
ALOMY = Alopecurus myosuroides (blackgrass)
AMARE = Amaranthus retroflexus (pigweed)
AVEFA = Avena fatua (wild oat)
BRSNW = Brassica napus (winter rape)
DIGSA = Digitaria sanguinalis (large crabgrass)
IPOHE = Ipomoea hederacea (ivyleaf morningglory)
HELAN = Helianthus annuus (sunflower)
GLXMA = Glycine max (soybean)
ECHCG = Echinochloa crus-galli (barnyardgrass)
ORYSA = Oryza sativa (rice)
POLCO = Polygonum convolvulus (wild buckwheat)
SORVU = Sorghum vulgare (grain sorghum)
SETFA = Setaria faberi (giant foxtail)
STEME = Stellaria media (chickweed)
TRZAW = Triticum aestivum (winter wheat)
ZEAMX = Zea mays (maize)

Compound 1 (formulated as an EC) was combined with cyhalofop-butyl and the efficacy of the herbicidal composition on velvetleaf (Abutilon theophrasti, ABUTH), pigweed (Amaranthus retroflexus, AMARE), wild oat (Avena fatua, AVEFA), winter rape (Brassica napus, BRSNW), wild pansy (Viola tricolor, VIOTR), large crabgrass (Digitaria 25 sanguinalis, DIGSA), barnyardgrass (Echinochloa crus-galli, ECHCG), sunflower (Helianthus annuus, HELAN), rice (Oryza sativa, ORYSA), wild buckwheat (Polygonum convolvulus, POLCO), giant foxtail (Setaria faberi, SETFA), grain sorghum (Sorghum vulgare, SORVU), winter wheat (Triticum aestivum, TRZAW), and maize (Zea mays, ZEAMX) was evaluated. The results are summarized in Table 2.

TABLE 2
Effect (% visual injury) of compound
1 and cyhalofop-butyl on weeds/crops.

| | | Compound 1 (g ai/ha) | | |
|---|---|---|---|---|
| | | 5 | 0 | 5 |
| | | Cyhalofop-butyl (g ai/ha) | | |
| Application Rate | | 0 | 180 | 180 |
| ABUTH | Obs | 50 | 0 | 70 |
| | Exp | | | 50 |
| AVEFA | Obs | 0 | 90 | 95 |
| | Exp | | | 90 |
| BRSNW | Obs | 60 | 0 | 80 |
| | Exp | | | 60 |
| VIOTR | Obs | 30 | 0 | 60 |
| | Exp | | | 30 |
| AMARE | Obs | 100 | 0 | 100 |
| | Exp | | | 100 |
| DIGSA | Obs | 0 | 85 | 85 |
| | Exp | | | 85 |
| ECHCG | Obs | 70 | 100 | 100 |
| | Exp | | | 100 |
| HELAN | Obs | 95 | 0 | 97 |
| | Exp | | | 95 |
| ORYSA | Obs | 0 | 0 | 0 |
| | Exp | | | 0 |
| POLCO | Obs | 95 | 0 | 95 |
| | Exp | | | 95 |
| SETFA | Obs | 65 | 90 | 95 |
| | Exp | | | 97 |
| SORVU | Obs | 40 | 95 | 97 |
| | Exp | | | 97 |
| TRZAW | Obs | 0 | 0 | 0 |
| | Exp | | | 0 |
| ZEAMX | Obs | 0 | 95 | 97 |
| | Exp | | | 95 |

g ai/ha = grams active ingredient per hectare
ABUTH = Abutilon theophrasti (velvetleaf)
AVEFA = Avena fatua (wild oat)
BRSNW = Brassica napus (winter rape)
VIOTR = Viola tricolor (wild pansy)
AMARE = Amaranthus retroflexus (pigweed)
DIGSA = Digitaria sanguinalis (large crabgrass)
ECHCG = Echinochloa crus-galli (barnyardgrass)
HELAN = Helianthus annuus (sunflower)
ORYSA = Oryza sativa (rice)
POLCO = Polygonum convolvulus (wild buckwheat)
SETFA = Setaria faberi (giant foxtail)
SORVU = Sorghum vulgare (grain sorghum)
TRZAW = Triticum aestivum (winter wheat)
ZEAMX = Zea mays (maize)

Compound 1 (formulated as an EC) was combined with diclofop-methyl and the efficacy of the herbicidal composition on pigweed (Amaranthus retroflexus, AMARE), winter rape (Brassica napus, BRSNW), wild buckwheat (Polygonum convolvulus, POLCO), giant foxtail (Setaria faberi, SETFA), wild pansy (Viola tricolor, VIOTR), common lambsquarters (Chenopodium album L., CHEAL), sunflower (Helianthus annuus, HELAN), chickweed (Stellaria media, STEME), velvetleaf (Abutilon theophrasti, ABUTH), rice (Oryza sativa, ORYSA), bamnyardgrass (Echinochloa crus-galli, FECHCG), and winter wheat (Triticum aestivum, TRZAW) was evaluated. The results are summarized in Table 3.

TABLE 3
Effect (% visual injury) of compound
1 and diclofop-methyl on weeds/crops.

| | | Compound 1 (g ai/ha) | | |
|---|---|---|---|---|
| | | 5 | 0 | 5 |
| | | Diclofop-methyl (g ai/ha) | | |
| Application Rate | | 0 | 280 | 280 |
| AMARE | Obs | 100 | 0 | 100 |
| | Exp | | | 100 |
| BRSNW | Obs | 60 | 0 | 95 |
| | Exp | | | 60 |
| POLCO | Obs | 95 | 0 | 100 |
| | Exp | | | 95 |
| SETFA | Obs | 65 | 60 | 95 |
| | Exp | | | 86 |
| VIOTR | Obs | 30 | 0 | 50 |
| | Exp | | | 30 |
| CHEAL | Obs | 100 | 0 | 100 |
| | Exp | | | 100 |
| HELAN | Obs | 95 | 0 | 97 |
| | Exp | | | 95 |
| STEME | Obs | 100 | 0 | 100 |
| | Exp | | | 100 |
| ABUTH | Obs | 50 | 0 | 40 |
| | Exp | | | 50 |
| ORYSA | Obs | 0 | 40 | 97 |
| | Exp | | | 40 |
| ECHCG | Obs | 70 | 100 | 100 |
| | Exp | | | 100 |
| TRZAW | Obs | 0 | 0 | 5 |
| | Exp | | | 0 |

g ai/ha = grams active ingredient per hectare
AMARE = Amaranthus retroflexus (pigweed)
BRSNW = Brassica napus (winter rape)
POLCO = Polygonum convolvulus (wild buckwheat)
SETFA = Setaria faberi (giant foxtail)
VIOTR = Viola tricolor (wild pansy)
CHEAL = Chenopodium album L. (common lambsquarters)
HELAN = Helianthus annuus (sunflower)
STEME = Stellaria media (chickweed)
ABUTH = Abutilon theophrasti (velvetleaf)
ORYSA = Oryza sativa (rice)
ECHCG = Echinochloa crus-galli (barnyardgrass)
TRZAW = Triticum aestivum (winter wheat)

Compound 1 (formulated as an EC) was combined with fenoxaprop-P-ethyl and the efficacy of the herbicidal composition on velvetleaf (Abutilon theophrasti, ABUTH), blackgrass (Alopecurus myosuroides, ALOMY), sunflower (Helianthus annuus, HELAN), wild pansy (Viola tricolor, VIOTR), wild oat (Avena fatua, AVEFA), winter rape (Brassica napus, BRSNW), common lambsquarters (Chenopodium album L., CHEAL), large crabgrass (Digitaria sanguinalis, DIGSA), barnyardgrass (Echinochloa crus-galli, ECHCG), wild buckwheat (Polygonum convolvulus, POLCO), giant foxtail (Setaria faberi, SETFA), winter wheat (Triticum aestivum, TRZAW), and maize (Zea mays, ZEAMX) was evaluated. The results are summarized in Table 4.

TABLE 4
Effect (% visual injury) of compound 1
and fenoxaprop-P-ethyl on weeds/crops.

| | | Compound 1 (g ai/ha) | | |
|---|---|---|---|---|
| | | 5 | 0 | 5 |
| | | Fenoxaprop-P-ethyl (g ai/ha) | | |
| Application Rate | | 0 | 46 | 46 |
| ABUTH | Obs | 50 | 0 | 70 |
| | Exp | | | 50 |
| ALOMY | Obs | 0 | 0 | 10 |
| | Exp | | | 0 |
| HELAN | Obs | 95 | 0 | 100 |
| | Exp | | | 95 |
| VIOTR | Obs | 30 | 0 | 35 |
| | Exp | | | 30 |
| AVEFA | Obs | 0 | 95 | 97 |
| | Exp | | | 95 |
| BRSNW | Obs | 60 | 0 | 50 |
| | Exp | | | 60 |
| CHEAL | Obs | 100 | 0 | 100 |
| | Exp | | | 100 |
| DIGSA | Obs | 0 | 100 | 100 |
| | Exp | | | 100 |
| ECHCG | Obs | 70 | 100 | 100 |
| | Exp | | | 100 |
| POLCO | Obs | 95 | 0 | 95 |
| | Exp | | | 95 |
| SETFA | Obs | 65 | 100 | 100 |
| | Exp | | | 100 |
| TRZAW | Obs | 0 | 0 | 0 |
| | Exp | | | 0 |
| ZEAMX | Obs | 0 | 100 | 100 |
| | Exp | | | 100 |

g ai/ha = grams active ingredient per hectare
ABUTH = Abutilon theophrasti (velvetleaf)
ALOMY = Alopecurus myosuroides (blackgrass)
HELAN = Helianthus annuus (sunflower)
VIOTR = Viola tricolor (wild pansy)
AVEFA = Avena fatua (wild oat)
BRSNW = Brassica napus (winter rape)
CHEAL = Chenopodium album L. (common lambsquarters)
DIGSA = Digitaria sanguinalis (large crabgrass)
ECHCG = Echinochloa crus-galli (barnyardgrass)
POLCO = Polygonum convolvulus (wild buckwheat)
SETFA = Setaria faberi (giant foxtail)
TRZAW = Triticum aestivum (winter wheat)
ZEAMX = Zea mays (maize)

Compound 1 (formulated as an EC) was combined with fluazifop-butyl and the efficacy of the herbicidal composition on velvetleaf (Abutilon theophrasti, ABUTH), blackgrass (Alopecurus myosuroides, ALOMY), wild pansy (Viola tricolor, VIOTR), pigweed (Amaranthus retroflexus, AMARE), wild oat (Avena fatua, AVEFA), winter rape (Brassica napus, BRSNW), large crabgrass (Digitaria sanguinalis, DIGSA), barnyardgrass (Echinochloa crus-galli, ECHCG), poinsettia (Euphorbia heterophylla, EPHHL), rice (Oryza sativa, ORYSA), wild buckwheat (Polygonum convolvulus, POLCO), giant foxtail (Setaria faberi, SETFA), chickweed (Stellaria media, STEME), winter wheat (Triticum aestivum, TRZAW), and maize (Zea mays, ZEAMX) was evaluated. The results are summarized in Table 5.

TABLE 5
Effect (% visual injury) of compound
1 and fluazifop-butyl on weeds/crops.

| | | Compound 1 (g ai/ha) | | |
|---|---|---|---|---|
| | | 5 | 0 | 5 |
| | | Fluazifop-butyl (g ai/ha) | | |
| Application Rate | | 0 | 105 | 105 |
| ABUTH | Obs | 50 | 0 | 70 |
| | Exp | | | 50 |
| ALOMY | Obs | 0 | 20 | 20 |
| | Exp | | | 20 |
| VIOTR | Obs | 30 | 0 | 65 |
| | Exp | | | 30 |
| AMARE | Obs | 100 | 0 | 100 |
| | Exp | | | 100 |
| AVEFA | Obs | 0 | 95 | 97 |
| | Exp | | | 95 |
| BRSNW | Obs | 60 | 0 | 40 |
| | Exp | | | 60 |
| DIGSA | Obs | 0 | 95 | 95 |
| | Exp | | | 95 |
| ECHCG | Obs | 70 | 100 | 100 |
| | Exp | | | 100 |
| EPHHL | Obs | 100 | 0 | 100 |
| | Exp | | | 100 |
| ORYSA | Obs | 0 | 85 | 90 |
| | Exp | | | 85 |
| POLCO | Obs | 95 | 0 | 95 |
| | Exp | | | 95 |
| SETFA | Obs | 65 | 97 | 95 |
| | Exp | | | 99 |
| STEME | Obs | 100 | 0 | 90 |
| | Exp | | | 100 |
| TRZAW | Obs | 0 | 90 | 97 |
| | Exp | | | 90 |
| ZEAMX | Obs | 0 | 100 | 100 |
| | Exp | | | 100 |

g ai/ha = grams active ingredient per hectare
ABUTH = Abutilon theophrasti (velvetleaf)
ALOMY = Alopecurus myosuroides (blackgrass)
VIOTR = Viola tricolor (wild pansy)
AMARE = Amaranthus retroflexus (pigweed)
AVEFA = Avena fatua (wild oat)
BRSNW = Brassica napus (winter rape)
DIGSA = Digitaria sanguinalis (large crabgrass)
ECHCG = Echinochloa crus-galli (barnyardgrass)
EPHHL = Euphorbia heterophylla (poinsettia)
ORYSA = Oryza sativa (rice)
POLCO = Polygonum convolvulus (wild buckwheat)
SETFA = Setaria faberi (giant foxtail)
STEME = Stellaria media (chickweed)
TRZAW = Triticum aestivum (winter wheat)
ZEAMX = Zea mays (maize)

Compound 1 (formulated as an EC) was combined with haloxyfop-P-methyl and the efficacy of the herbicidal composition on velvetleaf (Abutilon theophrasti, ABUTH), blackgrass (Alopecurus myosuroides, ALOMY), winter rape (Brassica napus, BRSNW), sunflower (Helianthus annuus, HELAN), wild buckwheat (Polygonum convolvulus, POLCO), wild pansy (Viola tricolor, VIOTR), pigweed (Amaranthus retroflexus, AMARE), common lambsquarters (Chenopodium album L., CHEAL), large crabgrass (Digitaria sanguinalis, DIGSA), barnyardgrass (Echinochloa crus-galli, ECHCG), poinsettia (Euphorbia heterophylla, EPHHL), soybean (Glycine max, GLXMA), rice (Oryza sativa, ORYSA), grain sorghum (Sorghum vulgare, SORVU), chickweed (Stellaria media, STEME), winter wheat (Triticum aestivum, TRZAW), and maize (Zea mays, ZEAMX) was evaluated. The results are summarized in Table 6.

TABLE 6
Effect (% visual injury) of compound 1
and haloxyfop-P-methyl on weeds/crops.

| | | Compound 1 (g ai/ha) | | |
|---|---|---|---|---|
| | | 5 | 0 | 5 |
| | | Haloxyfop-P-methyl (g ai/ha) | | |
| Application Rate | | 0 | 70 | 70 |
| ABUTH | Obs | 50 | 0 | 75 |
| | Exp | | | 50 |
| ALOMY | Obs | 0 | 97 | 100 |
| | Exp | | | 97 |
| BRSNW | Obs | 60 | 0 | 95 |
| | Exp | | | 60 |
| HELAN | Obs | 95 | 0 | 100 |
| | Exp | | | 95 |
| POLCO | Obs | 95 | 0 | 100 |
| | Exp | | | 95 |
| VIOTR | Obs | 30 | 0 | 65 |
| | Exp | | | 30 |
| AMARE | Obs | 100 | 0 | 100 |
| | Exp | | | 100 |
| CHEAL | Obs | 100 | 0 | 95 |
| | Exp | | | 100 |
| DIGSA | Obs | 0 | 100 | 100 |
| | Exp | | | 100 |
| ECHCG | Obs | 70 | 100 | 100 |
| | Exp | | | 100 |
| EPHHL | Obs | 100 | 0 | 100 |
| | Exp | | | 100 |
| GLXMA | Obs | 100 | 0 | 100 |
| | Exp | | | 100 |
| ORYSA | Obs | 0 | 100 | 100 |
| | Exp | | | 100 |
| SORVU | Obs | 40 | 100 | 100 |
| | Exp | | | 100 |
| STEME | Obs | 100 | 0 | 100 |
| | Exp | | | 100 |
| TRZAW | Obs | 0 | 100 | 100 |
| | Exp | | | 100 |
| ZEAMX | Obs | 0 | 100 | 100 |
| | Exp | | | 100 |

g ai/ha = grams active ingredient per hectare
ABUTH = Abutilon theophrasti (velvetleaf)
ALOMY = Alopecurus myosuroides (blackgrass)
BRSNW = Brassica napus (winter rape)
HELAN = Helianthus annuus (sunflower)
POLCO = Polygonum convolvulus (wild buckwheat)
VIOTR = Viola tricolor (wild pansy)
AMARE = Amaranthus retroflexus (pigweed)
CHEAL = Chenopodium album L. (common lambsquarters)
DIGSA = Digitaria sanguinalis (large crabgrass)
ECHCG = Echinochloa crus-galli (barnyardgrass)
EPHHL = Euphorbia heterophylla (poinsettia)
GLXMA = Glycine max (soybean)
ORYSA = Oryza sativa (rice)
SORVU = Sorghum vulgare (grain sorghum)
STEME = Stellaria media (chickweed)
TRZAW = Triticum aestivum (winter wheat)
ZEAMX = Zea mays (maize)

Compound 1 (formulated as an EC) was combined with quizalofop-P-ethyl and the efficacy of the herbicidal composition on wild pansy (Viola tricolor, VIOTR), wild buckwheat (Polygonum convolvulus, POLCO), sunflower (Helianthus annuus, HELAN), velvetleaf (Abutilon theophrasi, ABUTH), blackgrass (Alopecurus myosuroides, ALOMY), pigweed (Amaranthus retroflexus, AMARE), wild oat (Avena fatua, AVEFA), common lambsquarters (Chenopodium album L., CHEAL), large crabgrass (Digitaria sanguinalis, DIGSA), barnyardgrass (Echinochloa crus-galli, ECHCG), soybean (Glycine max, GLXMA), rice (Oryza sativa, ORYSA), giant foxtail (Setaria faberi, SETFA), grain sorghum (Sorghum vulgare, SORVU), winter wheat (Triticum aestivum, TRZAW), and maize (Zea mays, ZEAMX) was evaluated. The results are summarized in Table 7.

TABLE 7
Effect (% visual injury) of compound 1
and quizalofop-P-ethyl on weeds/crops.

| | | Compound 1 (g ai/ha) | | |
|---|---|---|---|---|
| | | 5 | 0 | 5 |
| | | Quizalofop-P-ethyl (g ai/ha) | | |
| Application Rate | | 0 | 75 | 75 |
| VIOTR | Obs | 30 | 0 | 50 |
| | Exp | | | 30 |
| POLCO | Obs | 95 | 0 | 97 |
| | Exp | | | 95 |
| HELAN | Obs | 95 | 0 | 97 |
| | Exp | | | 95 |
| ABUTH | Obs | 50 | 0 | 50 |
| | Exp | | | 50 |
| ALOMY | Obs | 0 | 100 | 95 |
| | Exp | | | 100 |
| AMARE | Obs | 100 | 0 | 100 |
| | Exp | | | 100 |
| AVEFA | Obs | 0 | 98 | 97 |
| | Exp | | | 98 |
| CHEAL | Obs | 100 | 0 | 100 |
| | Exp | | | 100 |
| DIGSA | Obs | 0 | 100 | 100 |
| | Exp | | | 100 |
| ECHCG | Obs | 70 | 100 | 100 |
| | Exp | | | 100 |
| GLXMA | Obs | 100 | 0 | 100 |
| | Exp | | | 100 |
| ORYSA | Obs | 0 | 100 | 100 |
| | Exp | | | 100 |
| SETFA | Obs | 65 | 100 | 100 |
| | Exp | | | 100 |
| SORVU | Obs | 40 | 100 | 100 |
| | Exp | | | 100 |
| TRZAW | Obs | 0 | 99 | 100 |
| | Exp | | | 99 |
| ZEAMX | Obs | 0 | 100 | 100 |
| | Exp | | | 100 |

g ai/ha = grams active ingredient per hectare
VIOTR = Viola tricolor (wild pansy)
POLCO = Polygonum convolvulus (wild buckwheat)
HELAN = Helianthus annuus (sunflower)
ABUTH = Abutilon theophrasti (velvetleaf)
ALOMY = Alopecurus myosuroides (blackgrass)
AMARE = Amaranthus retroflexus (pigweed)
AVEFA = Avena fatua (wild oat)
CHEAL = Chenopodium album L. (common lambsquarters)
DIGSA = Digitaria sanguinalis (large crabgrass)
ECHCG = Echinochloa crus-galli (barnyardgrass)
GLXMA = Glycine max (soybean)
ORYSA = Oryza sativa (rice)
SETFA = Setaria faberi (giant foxtail)
SORVU = Sorghum vulgare (grain sorghum)
TRZAW = Triticum aestivum (winter wheat)
ZEAMX = Zea mays (maize)

### Example 2. Herbicidal Activity of Compounds of Formula (I) and a Phenylpyrazolin Herbicide on Weeds and Crops in Greenhouse Trials

Compound 1 (formulated as an EC) was combined with pinoxaden and the efficacy of the herbicidal composition on large crabgrass (Digitaria sanguinalis, DIGSA), giant foxtail (Setaria faberi, SETFA), pigweed (Amaranthus retroflexus, AMARE), wild oat (Avena fatua, AVEFA), common lambsquarters (Chenopodium album L., CHEAL), barnyardgrass (Echinochloa crus-galli, ECHCG), wild buckwheat (Polygonum convolvulus, POLCO), grain sorghum (Sorghum vulgare, SORVU), chickweed (Stellaria media, STEME), velvetleaf (Abutilon theophrasti, ABUTH), soybean (Glycine max, GLXMA), sunflower (Helianthus annuus, HELAN), rice (Oryza sativa, ORYSA), winter wheat (Triticum aestivum, TRZAW), wild pansy (Viola tricolor, VIOTR), and maize (Zea mays, ZEAMX) was evaluated. The results are summarized in Table 8.

TABLE 8
Effect (% visual injury) of compound
1 and pinoxaden on weeds/crops.

| | | Compound 1 (g ai/ha) | | |
|---|---|---|---|---|
| | | 5 | 0 | 5 |
| | | Pinoxaden (g ai/ha) | | |
| Application Rate | | 0 | 30 | 30 |
| DIGSA | Obs | 0 | 10 | 70 |
| | Exp | | | 10 |
| SETFA | Obs | 65 | 0 | 97 |
| | Exp | | | 65 |
| AMARE | Obs | 100 | 0 | 100 |
| | Exp | | | 100 |
| AVEFA | Obs | 0 | 95 | 97 |
| | Exp | | | 95 |
| CHEAL | Obs | 100 | 0 | 100 |
| | Exp | | | 100 |
| ECHCG | Obs | 70 | 100 | 100 |
| | Exp | | | 100 |
| POLCO | Obs | 95 | 0 | 97 |
| | Exp | | | 95 |
| SORVU | Obs | 40 | 100 | 100 |
| | Exp | | | 100 |
| STEME | Obs | 100 | 0 | 100 |
| | Exp | | | 100 |
| ABUTH | Obs | 50 | 0 | 30 |
| | Exp | | | 50 |
| GLXMA | Obs | 100 | 0 | 100 |
| | Exp | | | 100 |
| HELAN | Obs | 95 | 0 | 30 |
| | Exp | | | 95 |
| ORYSA | Obs | 0 | 99 | 97 |
| | Exp | | | 99 |
| TRZAW | Obs | 0 | 0 | 0 |
| | Exp | | | 0 |
| VIOTR | Obs | 30 | 0 | 10 |
| | Exp | | | 30 |
| ZEAMX | Obs | 0 | 10 | 20 |
| | Exp | | | 10 |

g ai/ha = grams active ingredient per hectare
DIGSA = Digitaria sanguinalis (large crabgrass)
SETFA = Setaria faberi (giant foxtail)
AMARE = Amaranthus retroflexus (pigweed)
AVEFA = Avena fatua (wild oat)
CHEAL = Chenopodium album L. (common lambsquarters)
ECHCG = Echinochloa crus-galli (barnyardgrass)
POLCO = Polygonum convolvulus (wild buckwheat)
SORVU = Sorghum vulgare (grain sorghum)
STEME = Stellaria media (chickweed)
ABUTH = Abutilon theophrasti (velvetleaf)
GLXMA = Glycine max (soybean)
HELAN = Helianthus annuus (sunflower)
ORYSA = Oryza sativa (rice)
TRZAW = Triticum aestivum (winter wheat)
VIOTR = Viola tricolor (wild pansy)
ZEAMX = Zea mays (maize)

### Example 3. Herbicidal Activity of Compounds of Formula (I) and Cyclohexanedione Herbicides in Greenhouse Trials

Compound 1 (formulated as an EC) was combined with clethodim and the efficacy of the herbicidal composition on velvetleaf (Abutilon theophrasti, ABUTH), pigweed (Amaranthus retroflexus, AMARE), wild oat (Avena fatua, AVEFA), winter rape (Brassica napus, BRSNW), common lambsquarters (Chenopodium album L., CHEAL), large crabgrass (Digitaria sanguinalis, DIGSA), soybean (Glycine max, GLXMA), sunflower (Helianthus annuus, HELAN), kochia (Kochia scoparia, KCHSC), rice (Oryza sativa, ORYSA), wild buckwheat (Polygonum convolvulus, POLCO), giant foxtail (Setaria faberi, SETFA), chickweed (Stellaria media, STEME), wild pansy (Viola tricolor, VIOTR), barnyardgrass (Echinochloa crus-galli, ECHCG), poinsettia (Euphorbia heterophylla, EPHHL), blackgrass (Alopecurus myosuroides, ALOMY), winter wheat (Triticum aestivum, TRZAW), and maize (Zea mays, ZEAMX) was evaluated. The results are summarized in Table 9.

TABLE 9
Effect (% visual injury) of compound 1 and clethodim on
weeds/crops.

| Application | Compound 1 (g ai/ha) | 5 | 10 | 0 | 5 | 10 |
|---|---|---|---|---|---|---|
| Rate | Clethodim (g ai/ha) | 0 | 0 | 70 | 70 | 70 |
| ABUTH | Obs | 50 | 60 | 0 | 60 | 70 |
| | Exp | | | | 50 | 60 |
| AMARE | Obs | 75 | 97 | 5 | 100 | 100 |
| | Exp | | | | 76 | 97 |
| AVEFA | Obs | 0 | 0 | 97 | 100 | 100 |
| | Exp | | | | 97 | 97 |
| BRSNW | Obs | 40 | 45 | 5 | 30 | 60 |
| | Exp | | | | 43 | 48 |
| CHEAL | Obs | 90 | 100 | 5 | 95 | 97 |
| | Exp | | | | 91 | 100 |
| DIGSA | Obs | 0 | 10 | 70 | 90 | 75 |
| | Exp | | | | 70 | 73 |
| GLXMA | Obs | 95 | 100 | 10 | 100 | 100 |
| | Exp | | | | 96 | 100 |
| HELAN | Obs | 90 | 90 | 0 | 85 | 93 |
| | Exp | | | | 90 | 90 |
| KCHSC | Obs | 60 | 60 | 0 | 65 | 70 |
| | Exp | | | | 60 | 60 |
| ORYSA | Obs | 0 | 10 | 90 | 95 | 100 |
| | Exp | | | | 90 | 91 |
| POLCO | Obs | 65 | 75 | 10 | 65 | 100 |
| | Exp | | | | 69 | 78 |
| SETFA | Obs | 10 | 50 | 85 | 85 | 80 |
| | Exp | | | | 87 | 93 |
| STEME | Obs | 70 | 70 | 10 | 80 | 90 |
| | Exp | | | | 73 | 73 |
| VIOTR | Obs | 5 | 10 | 5 | 25 | 30 |
| | Exp | | | | 10 | 15 |
| ECHCG | Obs | 20 | 60 | 100 | 100 | 100 |
| | Exp | | | | 100 | 100 |
| EPHHL | Obs | 97 | 97 | 30 | 100 | 100 |
| | Exp | | | | 98 | 98 |
| ALOMY | Obs | 0 | 0 | 93 | 90 | 100 |
| | Exp | | | | 93 | 93 |
| TRZAW | Obs | 0 | 0 | 70 | 80 | 95 |
| | Exp | | | | 70 | 70 |
| ZEAMX | Obs | 0 | 0 | 100 | 100 | 100 |
| | Exp | | | | 100 | 100 |

g ai/ha = grams active ingredient per hectare
ABUTH = Abutilon theophrasti (velvetleaf)
AMARE = Amaranthus retroflexus (pigweed)
AVEFA = Avena fatua (wild oat)
BRSNW = Brassica napus (winter rape)
CHEAL = Chenopodium album L. (common lambsquarters)
DIGSA = Digitaria sanguinalis (large crabgrass)
GLXMA = Glycine max (soybean)
HELAN = Helianthus annuus (sunflower)
KCHSC = Kochia scoparia (kochia)
ORYSA = Oryza sativa (rice)
POLCO = Polygonum convolvulus (wild buckwheat)
SETFA = Setaria faberi (giant foxtail)
STEME = Stellaria media (chickweed)
VIOTR = Viola tricolor (wild pansy)
ECHCG = Echinochloa crus-galli (barnyardgrass)
EPHHL = Euphorbia heterophylla (poinsettia)
ALOMY = Alopecurus myosuroides (blackgrass)
TRZAW = Triticum aestivum (winter wheat)
ZEAMX = Zea mays (maize)

Compound 1 (formulated as an EC) was combined with sethoxydim and the efficacy of the herbicidal composition on velvetleaf (Abutilon theophrasti, ABUTH), blackgrass (Alopecurus myosuroides, ALOMY), pigweed (Amaranthus retroflexus, AMARE), wild oat (Avena fatua, AVEFA), winter rape (Brassica napus, BRSNW), common lambsquarters (Chenopodium album L., CHEAL), large crabgrass (Digitaria sanguinalis, DIGSA), poinsettia (Euphorbia heterophylla, EPHHL), barnyardgrass (Echinochloa crus-galli, ECHCG), soybean (Glycine max, GLXMA), sunflower (Helianthus annuus, HELAN), kochia (Kochia scoparia, KCHSC), rice (Oryza sativa, ORYSA), wild buckwheat (Polygonum convolvulus, POLCO), giant foxtail (Setaria faberi, SETFA), grain sorghum (Sorghum vulgare, SORVU), chickweed (Stellaria media, STEME), wild pansy (Viola tricolor, VIOTR), winter wheat (Triticum aestivum, TRZAW), and maize (Zea mays, ZEAMX) was evaluated. The results are summarized in Table 10.

TABLE 10
Effect (% visual injury) of compound 1 and sethoxydim
on weeds.

| Application | Compound 1 (g ai/ha) | 5 | 10 | 0 | 5 | 10 |
|---|---|---|---|---|---|---|
| Rate | Sethoxydim (g ai/ha) | 0 | 0 | 140 | 140 | 140 |
| ABUTH | Obs | 50 | 60 | 0 | 60 | 60 |
| | Exp | | | | 50 | 60 |
| ALOMY | Obs | 0 | 0 | 95 | 70 | 90 |
| | Exp | | | | 95 | 95 |
| AMARE | Obs | 75 | 97 | 0 | 100 | 100 |
| | Exp | | | | 75 | 97 |
| AVEFA | Obs | 0 | 0 | 85 | 85 | 93 |
| | Exp | | | | 85 | 85 |
| BRSNW | Obs | 40 | 45 | 0 | 70 | 75 |
| | Exp | | | | 40 | 45 |
| CHEAL | Obs | 90 | 100 | 5 | 80 | 95 |
| | Exp | | | | 91 | 100 |
| DIGSA | Obs | 0 | 10 | 60 | 70 | 70 |
| | Exp | | | | 60 | 64 |
| ECHCG | Obs | 20 | 60 | 50 | 100 | 100 |
| | Exp | | | | 60 | 80 |
| EPHHL | Obs | 97 | 97 | 10 | 100 | 100 |
| | Exp | | | | 97 | 97 |
| GLXMA | Obs | 95 | 100 | 0 | 100 | 95 |
| | Exp | | | | 95 | 100 |
| HELAN | Obs | 90 | 90 | 0 | 60 | 70 |
| | Exp | | | | 90 | 90 |
| KCHSC | Obs | 60 | 60 | 0 | 60 | 80 |
| | Exp | | | | 60 | 60 |
| ORYSA | Obs | 0 | 10 | 75 | 75 | 85 |
| | Exp | | | | 75 | 78 |
| POLCO | Obs | 65 | 75 | 0 | 85 | 85 |
| | Exp | | | | 65 | 75 |
| SETVA | Obs | 10 | 50 | 85 | 75 | 75 |
| | Exp | | | | 87 | 93 |
| SORVU | Obs | 0 | 50 | 100 | 100 | 100 |
| | Exp | | | | 100 | 100 |
| STEME | Obs | 70 | 70 | 10 | 70 | 75 |
| | Exp | | | | 73 | 73 |
| VIOTR | Obs | 5 | 10 | 5 | 10 | 10 |
| | Exp | | | | 10 | 15 |
| TRZAW | Obs | 0 | 0 | 60 | 80 | 85 |
| | Exp | | | | 60 | 60 |
| ZEAMX | Obs | 0 | 0 | 75 | 100 | 100 |
| | Exp | | | | 75 | 75 |

g ai/ha = grams active ingredient per hectare
ABUTH = Abutilon theophrasti (velvetleaf)
ALOMY = Alopecurus myosuroides (blackgrass)
AMARE = Amaranthus retroflexus (pigweed)
AVEFA = Avena fatua (wild oat)
BRSNW = Brassica napus (winter rape)
CHEAL = Chenopodium album L. (common lambsquarters)
DIGSA = Digitaria sanguinalis (large crabgrass)
EPHHL = Euphorbia heterophylla (poinsettia)
ECHCG = Echinochloa crus-galli (barnyardgrass)
GLXMA = Glycine max (soybean)
HELAN = Helianthus annuus (sunflower)
KCHSC = Kochia scoparia (kochia)
ORYSA = Oryza sativa (rice)
POLCO = Polygonum convolvulus (wild buckwheat)
SETFA = Setaria faberi (giant foxtail)
SORVU = Sorghum vulgare (grain sorghum)
STEME = Stellaria media (chickweed)
VIOTR = Viola tricolor (wild pansy)
TRZAW = Triticum aestivum (winter wheat)
ZEAMX = Zea mays (maize)

Compound 1 (formulated as an EC) was combined with tralkoxydim and the efficacy of the herbicidal composition on velvetleaf (Abutilon theophrasti, ABUTH), pigweed (Amaranthus retroflexus, AMARE), wild oat (Avena fatua, AVEFA), winter rape (Brassica napus, BRSNW), common lambsquarters (Chenopodium album L., CHEAL), large crabgrass (Digitaria sanguinalis, DIGSA), barnyardgrass (Echinochloa crus-galli, ECHCG), poinsetia (Euphorbia heterophylla, EPHHL), soybean (Glycine max, GLXMA), kochia(Kochia scoparia, KCHSC), rice (Oryza sativa, ORYSA), wild buckwheat (Polygonum convolvulus, POLCO), giant foxtail (Setaria faberi, SETFA), grain sorghum (Sorghum vulgare, SORVU), chickweed (Stel laria media, STEME), wild pansy (Viola tricolor, VIOTR), and maize (Zea mays, ZEAMX) and was evaluated. The results are summarized in Table 11.

TABLE 11
Effect (% visual injury) of compound 1 and tralkoxydim on
weeds/crops.

| Application | Compound 1 (g ai/ha) | 5 | 10 | 0 | 5 | 10 |
|---|---|---|---|---|---|---|
| Rate | Tralkoxydim (g ai/ha) | 0 | 0 | 200 | 200 | 200 |
| ABUTH | Obs | 50 | 60 | 0 | 50 | 60 |
| | Exp | | | | 50 | 60 |
| AMARE | Obs | 75 | 97 | 0 | 60 | 85 |
| | Exp | | | | 75 | 97 |
| AVEFA | Obs | 0 | 0 | 100 | 100 | 97 |
| | Exp | | | | 100 | 100 |
| BRSNW | Obs | 40 | 45 | 0 | 70 | 85 |
| | Exp | | | | 40 | 45 |
| CHEAL | Obs | 90 | 100 | 5 | 90 | 97 |
| | Exp | | | | 91 | 100 |
| DIGSA | Obs | 0 | 10 | 50 | 0 | 40 |
| | Exp | | | | 50 | 55 |
| ECHCG | Obs | 20 | 60 | 30 | 75 | 100 |
| | Exp | | | | 44 | 72 |
| EPHHL | Obs | 97 | 97 | 0 | 100 | 100 |
| | Exp | | | | 97 | 97 |
| GLXMA | Obs | 95 | 100 | 0 | 100 | 100 |
| | Exp | | | | 95 | 100 |
| KCHSC | Obs | 60 | 60 | 0 | 60 | 70 |
| | Exp | | | | 60 | 60 |
| ORYSA | Obs | 0 | 10 | 75 | 90 | 93 |
| | Exp | | | | 75 | 78 |
| POLCO | Obs | 65 | 75 | 0 | 90 | 95 |
| | Exp | | | | 65 | 75 |
| SETFA | Obs | 10 | 50 | 0 | 80 | 85 |
| | Exp | | | | 10 | 50 |
| SORVU | Obs | 0 | 50 | 60 | 100 | 100 |
| | Exp | | | | 60 | 80 |
| STEME | Obs | 70 | 70 | 10 | 75 | 70 |
| | Exp | | | | 73 | 73 |
| VIOTR | Obs | 5 | 10 | 5 | 10 | 20 |
| | Exp | | | | 10 | 15 |
| ZEAMX | Obs | 0 | 0 | 100 | 100 | 100 |
| | Exp | | | | 100 | 100 |

g ai/ha = grams active ingredient per hectare
ABUTH = Abutilon theophrasti (velvetleaf)
AMARE = Amaranthus retroflexus (pigweed)
AVEFA = Avena fatua (wild oat)
BRSNW = Brassica napus (winter rape)
CHEAL = Chenopodium album L. (common lambsquarters)
DIGSA = Digitaria sanguinalis (large crabgrass)
ECHCG = Echinochloa crus-galli (barnyardgrass)
EPHHL = Euphorbia heterophylla (poinsettia)
GLXMA = Glycine max (soybean)
KCHSC = Kochia scoparia (kochia)
ORYSA = Oryza sativa (rice)
POLCO = Polygonum convolvulus (wild buckwheat)
SETFA = Setaria faberi (giant foxtail)
SORVU = Sorghum vulgare (grain sorghum)
STEME = Stellaria media (chickweed)
VIOTR = Viola tricolor (wild pansy)
ZEAMX = Zea mays (maize)

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including”, “containing”, and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments/aspects of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A herbicidal composition comprising a herbicidally effective amount of (a) a pyridine carboxylic acid herbicide or an agriculturally acceptable N-oxide, salt, or ester thereof and (b) an acetyl CoA carboxylase (ACCase) inhibitor or an agriculturally acceptable salt or ester thereof,
wherein the pyridine carboxylic acid herbicide comprises a compound defined by Formula (I) 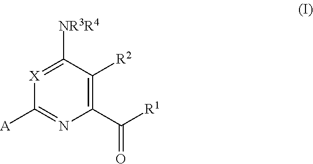
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is one of groups A1 to A36 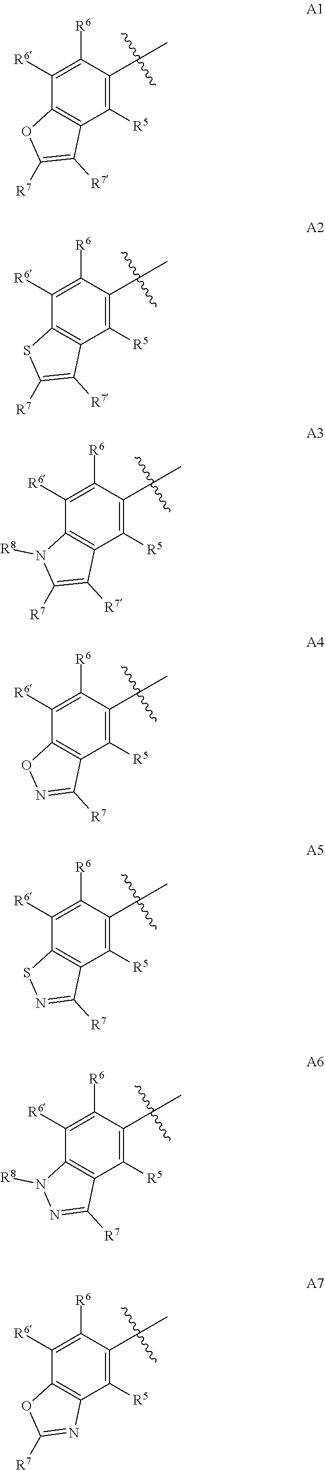 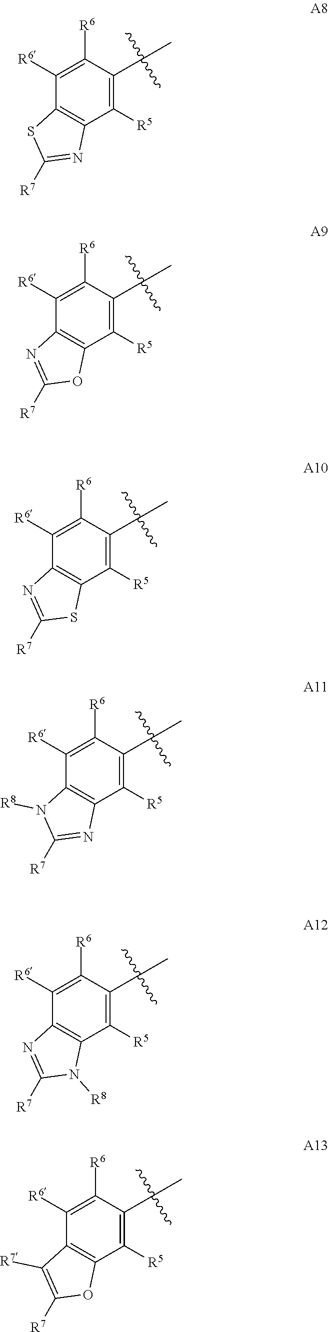 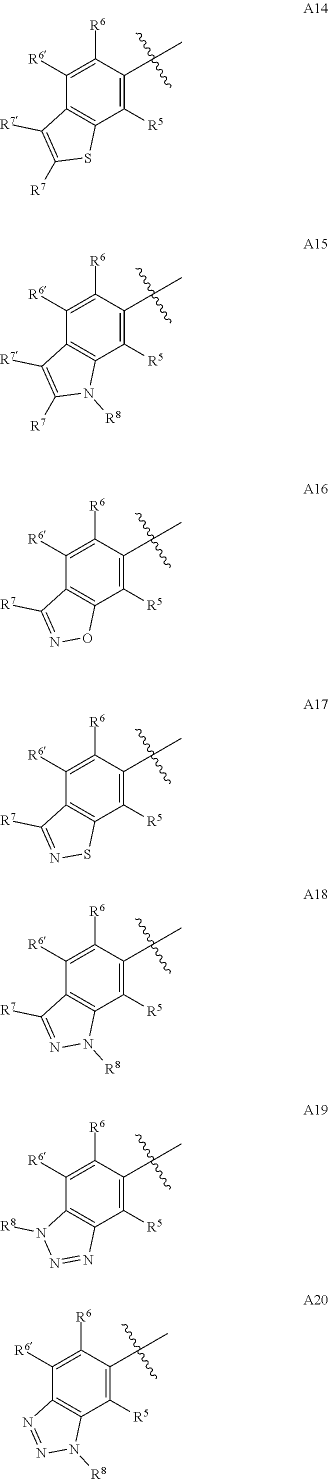 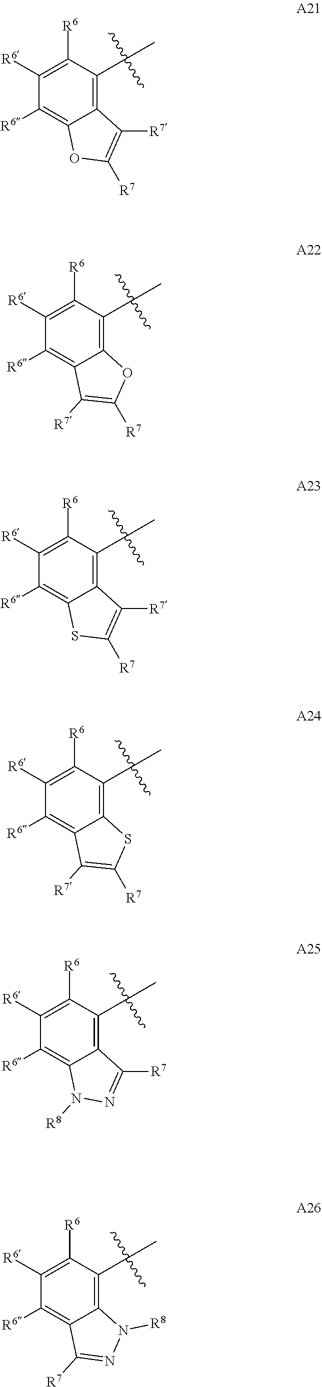 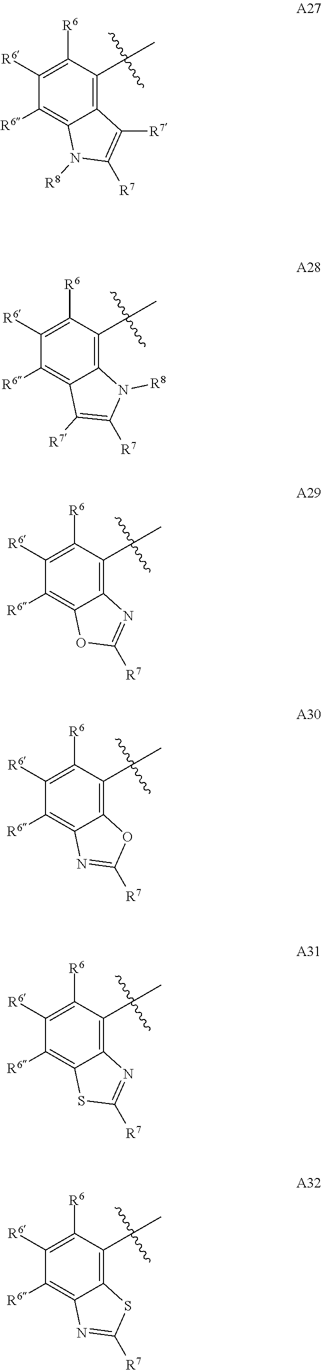 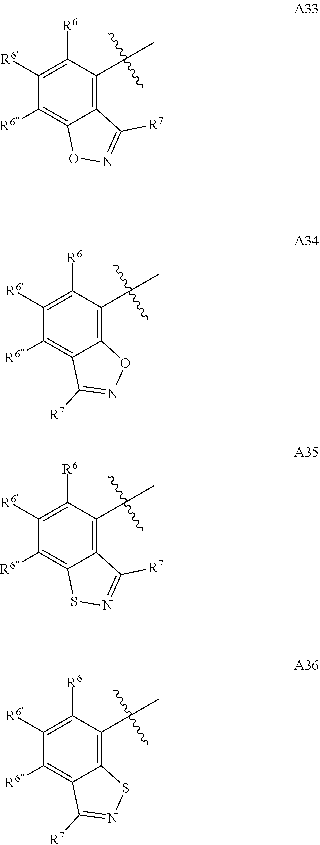
R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

2. The composition of claim 1, wherein the pyridine carboxylic acid herbicide comprises a compound defined by Formula (II) 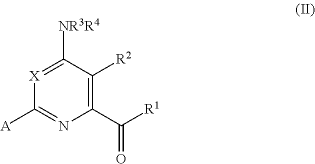
wherein
R¹ is OR^{1′} or NR^{1″}R^{1′″}, wherein R^{1′} is hydrogen, C₁-C₈ alkyl, or C₇-C₁₀ arylalkyl, and R^{1″} and R^{1″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;
R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

3. The composition of claim 2, wherein
R¹ is OR^{1′}, wherein R^{1′} is hydrogen, C₁-C₈ alkyl, or C₇-C₁₀ arylalkyl;
R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio;
R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;
A is A1, A2, A3, A7, A8, A9, A10, A11, A12, A13, A14, A15, A21, A22, A23, A24, A27, A28, A29, A30, A31, or A32;
R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;
R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and
R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

4. The composition of claim 1, wherein the pyridine carboxylic acid herbicide comprises a compound defined by Formula (III): 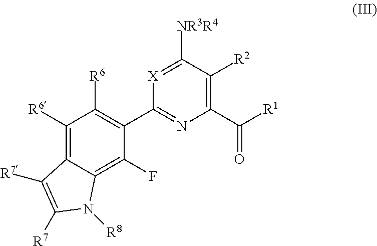
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

5. The composition of claim 1, wherein the pyridine carboxylic acid herbicide comprises one of the following:

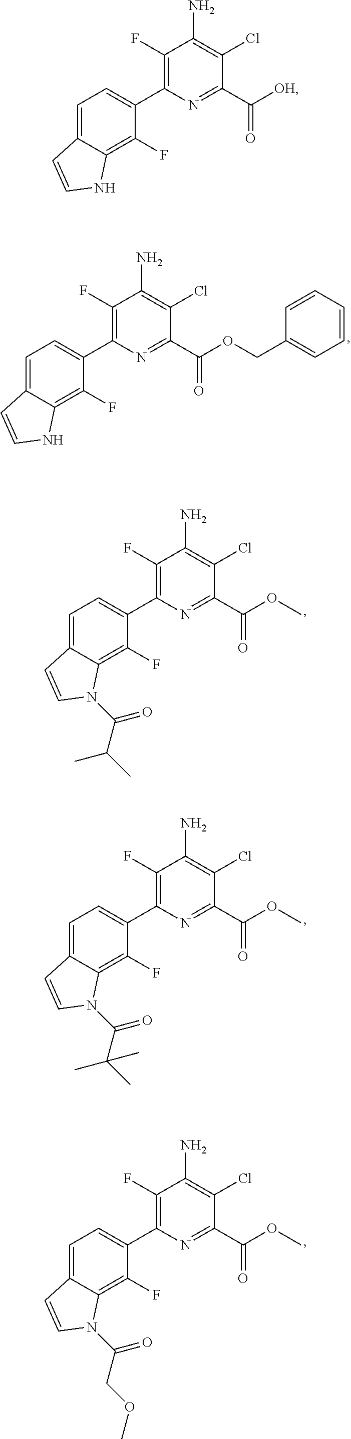 [SMILES: Nc1c(F)c(-c2ccc3cc[nH]c3c2F)nc(C(=O)O)c1Cl ; Nc1c(F)c(-c2ccc3cc[nH]c3c2F)nc(C(=O)OCc2ccccc2)c1Cl ; COC(=O)c1nc(-c2ccc3ccn(C(=O)C(C)C)c3c2F)c(F)c(N)c1Cl ; COC(=O)c1nc(-c2ccc3ccn(C(=O)C(C)(C)C)c3c2F)c(F)c(N)c1Cl ; COCC(=O)n1ccc2ccc(-c3nc(C(=O)OC)c(Cl)c(N)c3F)c(F)c21]

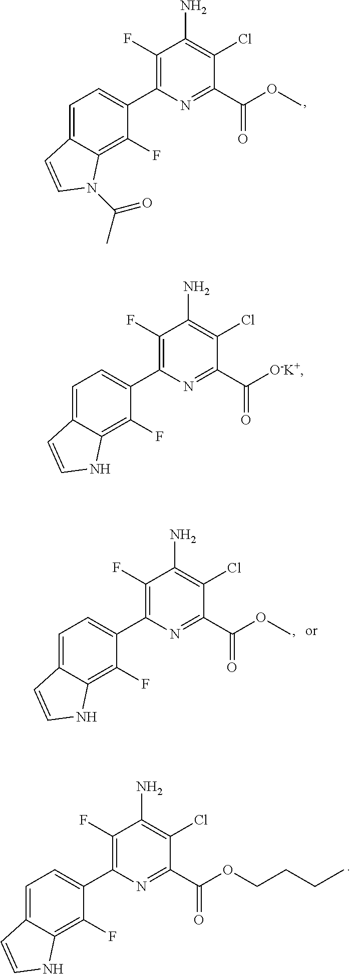

6. The composition of claim 1, wherein the pyridine carboxylic acid herbicide comprises

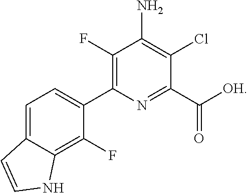 [SMILES: Nc1c(F)c(-c2ccc3cc[nH]c3c2F)nc(C(=O)O)c1Cl]

7. The composition of claim 1, wherein (b) is an aryloxyphenoxypropionate herbicide.

8. The composition of claim 7, wherein the aryloxyphenoxypropionate herbicide is selected from the group consisting of clodinafop, cyhalofop, diclofop, fenoxaprop, fluazifop, haloxyfop, metamifop, propaquizafop, quizalofop and agriculturally acceptable salts and esters thereof, and combinations thereof.

9. The composition of claim 8, wherein the weight ratio of (a) to (b) is within the range from about 1:2500 to about 1200:1.

10. The composition of claim 9, wherein the weight ratio of (a) to (b) is within the range from about 1:500 to about 160:1.

11. The composition of claim 10, wherein the weight ratio of (a) to (b) is within the range from about 1:20 to about 10:1.

12. The composition of claim 1, wherein (b) is a cyclohexanedione herbicide.

13. The composition of claim 12, wherein the cyclohexanedione herbicide is selected from the group consisting of alloxydim, butroxydim, clethodim, cycloxydim, profoxydim, setoxydim, tepraloxydim, tralkoxydim, and agriculturally acceptable salts thereof, and combinations thereof.

14. The composition of claim 13, wherein the weight ratio of (a) to (b) is within the range from about 1:3000 to about 500:1.

15. The composition of claim 14, wherein the weight ratio of (a) to (b) is within the range from about 1:500 to about 80:1.

16. The composition of claim 15, wherein the weight ratio of (a) to (b) is within the range from about 1:30 to about 5:1.

17. The composition claim 1, wherein (b) is a phenylpyrazoline herbicide.

18. The composition of claim 17, wherein the phenylpyrazoline herbicide is pinoxaden.

19. The composition of claim 18, wherein the weight ratio of (a) to (b) is within the range from about 1:3000 to about 500:1.

20. The composition of claim 19, wherein the weight ratio of (a) to (b) is within the range from about 1:500 to about 80:1.

21. The composition of claim 20, wherein the weight ratio of (a) to (b) is within the range from about 1:30 to about 5:1.

22. The composition of claim 1, further comprising an agriculturally acceptable adjuvant or carrier.

23. The composition of claim 1, further comprising an additional pesticide.

24. The composition of claim 1, wherein the active ingredients in the composition consist of (a) and (b).

25. The composition of claim 1, wherein the composition is provided as a herbicidal concentrate.

26. A method of controlling undesirable vegetation comprising applying to vegetation or an area adjacent the vegetation or applying to soil or water to control the emergence or growth of vegetation a herbicidally effective amount of:
(a) a pyridine carboxylic acid herbicide comprising a compound defined by Formula (I) 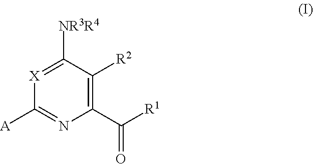
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is one of groups A1 to A36 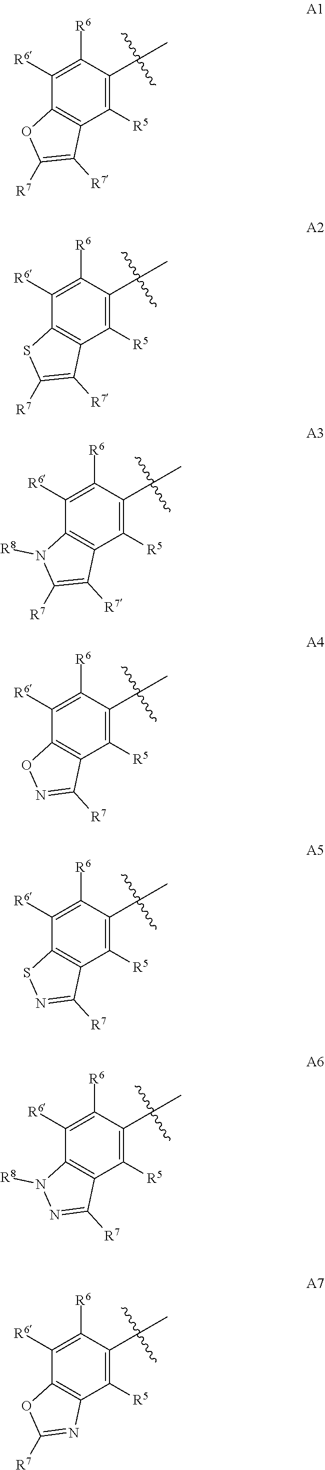 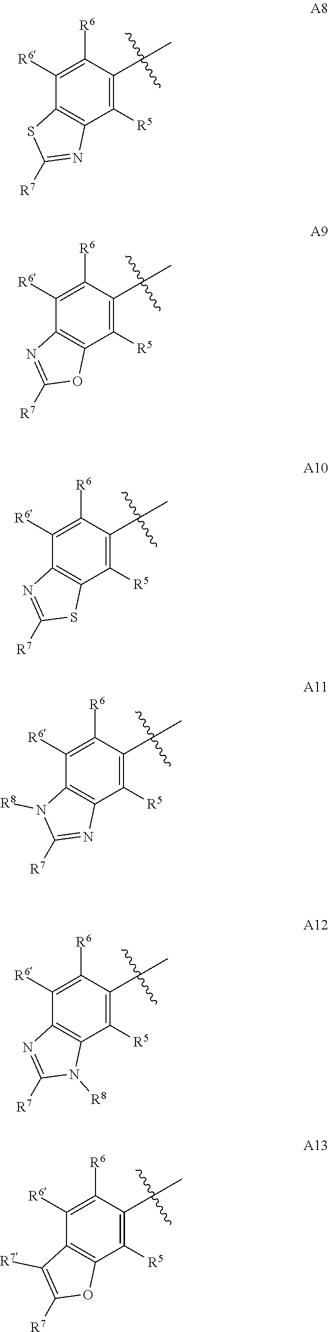 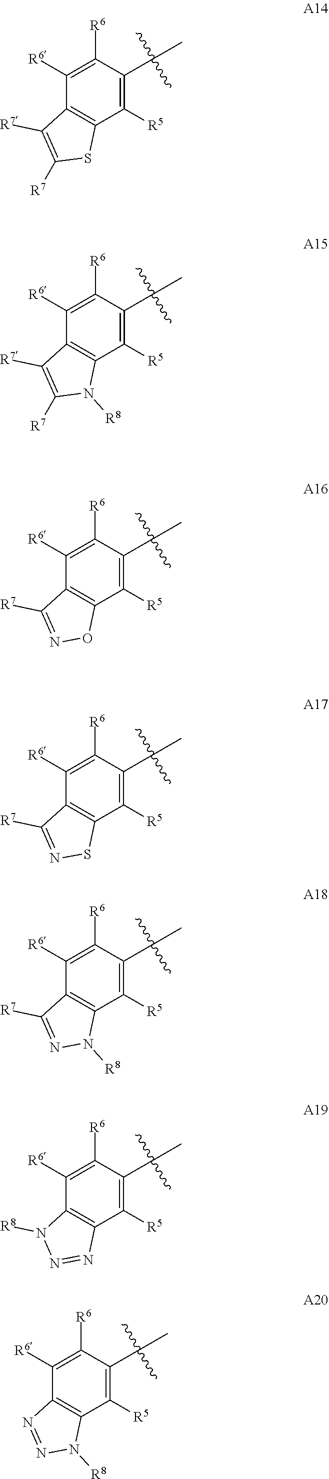 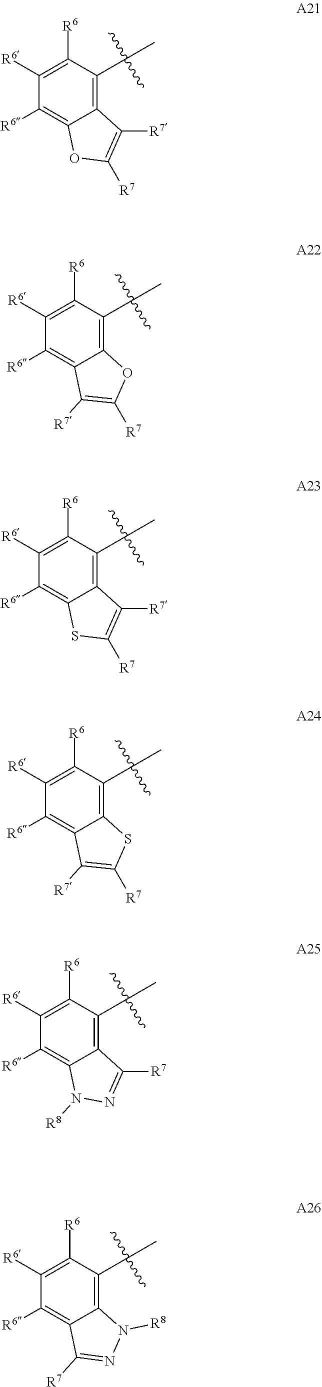 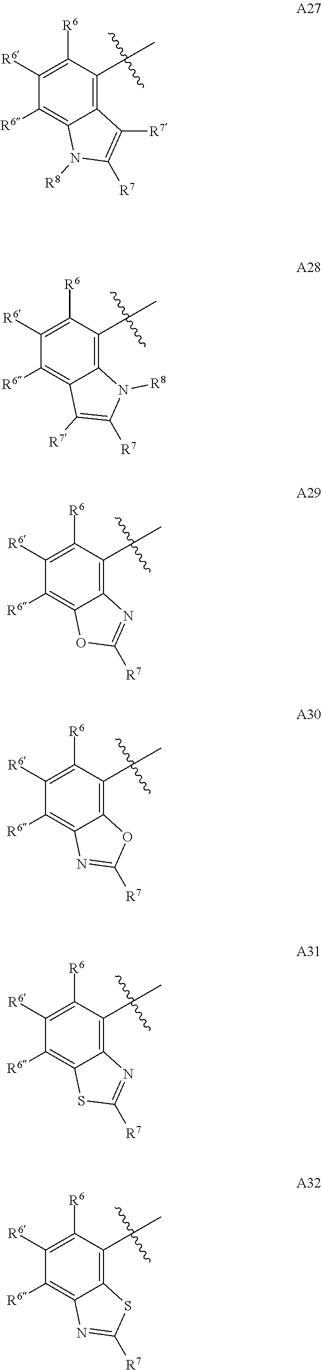 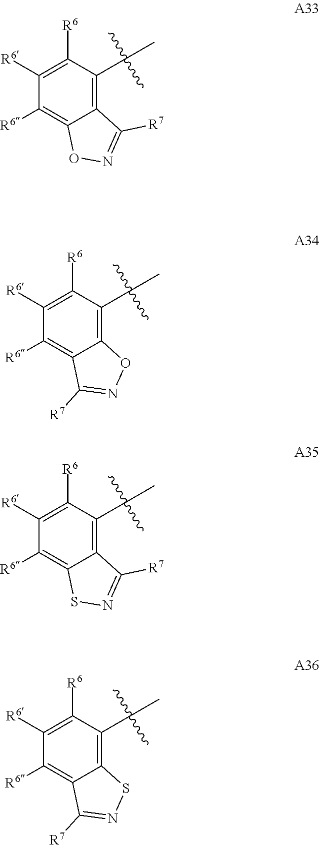
R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof; and
(b) an acetyl CoA carboxylase (ACCase) inhibitor or an agriculturally acceptable salt or ester thereof.

27. The method of claim 26, wherein the pyridine carboxylic acid herbicide comprises a compound defined by Formula (II) 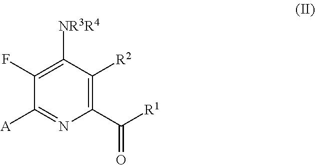
wherein
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;
R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

28. The method of claim 26, wherein
R¹ is OR^{1′}, wherein R^{1′} is hydrogen, C₁-C₈ alkyl, or C₇-C₁₀ arylalkyl;
R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio;
R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;
A is A1, A2, A3, A7, A8, A9, A10, A11, A12, A13, A14, A15, A21, A22, A23, A24, A27, A28, A29, A30, A31, or A32;
R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;
R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and
R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

29. The method of claim 26, wherein the pyridine carboxylic acid herbicide comprises a compound defined by Formula (III): 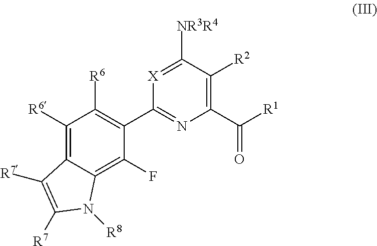
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

30. The method of claim 26, wherein the pyridine carboxylic acid herbicide comprises one of the following:

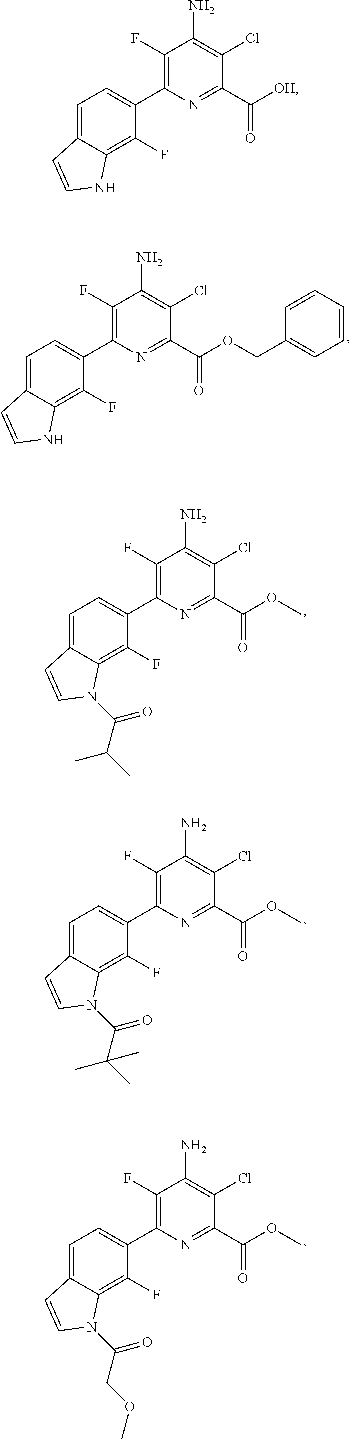 [SMILES: Nc1c(F)c(-c2ccc3cc[nH]c3c2F)nc(C(=O)O)c1Cl ; Nc1c(F)c(-c2ccc3cc[nH]c3c2F)nc(C(=O)OCc2ccccc2)c1Cl ; COC(=O)c1nc(-c2ccc3ccn(C(=O)C(C)C)c3c2F)c(F)c(N)c1Cl ; COC(=O)c1nc(-c2ccc3ccn(C(=O)C(C)(C)C)c3c2F)c(F)c(N)c1Cl ; COCC(=O)n1ccc2ccc(-c3nc(C(=O)OC)c(Cl)c(N)c3F)c(F)c21]

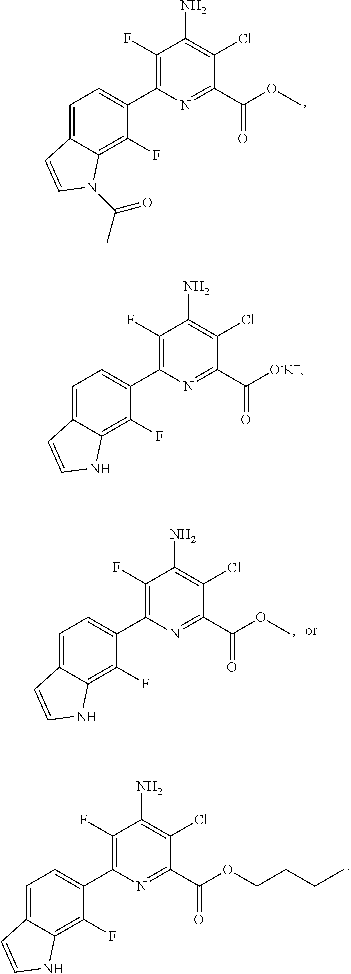

31. The method of claim 26, wherein the pyridine carboxylic acid herbicide comprises

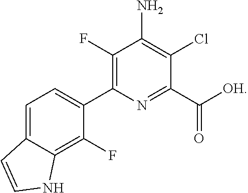 [SMILES: Nc1c(F)c(-c2ccc3cc[nH]c3c2F)nc(C(=O)O)c1Cl]

32. The method of claim 26, wherein (b) is an aryloxyphenoxypropionate herbicide.

33. The method of claim 32, wherein the aryloxyphenoxypropionate herbicide is selected from the group consisting of clodinafop, cyhalofop, diclofop, fenoxaprop, fluazifop, haloxyfop, metamifop, propaquizafop, quizalofop and agriculturally acceptable salts and esters thereof, and combinations thereof.

34. The method of claim 33, wherein the weight ratio of (a) to (b) is within the range from about 1:2500 to about 1200:1.

35. The method of claim 34, wherein the weight ratio of (a) to (b) is within the range from about 1:500 to about 160:1.

36. The method of claim 35, wherein the weight ratio of (a) to (b) is within the range from about 1:20 to about 10:1.

37. The method of claim 26, wherein (b) is a cyclohexanedione herbicide.

38. The method of claim 37, wherein the cyclohexanedione herbicide is selected from the group consisting of alloxydim, butroxydim, clethodim, cycloxydim, profoxydim, setoxydim, tepraloxydim, tralkoxydim, and agriculturally acceptable salts thereof, and combinations thereof.

39. The method of claim 38, wherein the weight ratio of (a) to (b) is within the range from about 1:3000 to about 500:1.

40. The method of claim 39, wherein the weight ratio of (a) to (b) is within the range from about 1:500 to about 80:1.

41. The method of claim 40, wherein the weight ratio of (a) to (b) is within the range from about 1:30 to about 5:1.

42. The method of claim 26, wherein (b) is a phenylpyrazoline herbicide.

43. The method of claim 42, wherein the phenylpyrazoline herbicide is pinoxaden.

44. The method of claim 43, wherein the weight ratio of (a) to (b) is within the range from about 1:3000 to about 500:1.

45. The method of claim 44, wherein the weight ratio of (a) to (b) is within the range from about 1:500 to about 80:1.

46. The method of claim 45, wherein the weight ratio of (a) to (b) is within the range from about 1:30 to about 5:1.

47. The method of claim 26, wherein (a) is applied in amount of from 0.5 g ae/ha to 300 g ae/ha.

48. The method of claim 26, wherein (a) is applied in amount of from 5 g ae/ha to 40 g ae/ha.

49. The method of claim 26, wherein (b) is applied in amount of from 1 g ai/ha to 1700 g ai/ha.

50. The method of claim 26, wherein (b) is applied in amount of from 10 g ai/ha to 700 g ai/ha.

51. The method of claim 26, wherein (a) and (b) are applied simultaneously.

52. The method of claim 26, wherein (a) and (b) are applied postemergence to the undesirable vegetation.

53. The method of claim 26, further comprising applying an agriculturally acceptable adjuvant or carrier.

54. The method of claim 26, further comprising applying an additional pesticide.

55. The method of claim 26, wherein the undesirable vegetation is controlled in a glyphosate-, glufosinate-, dicamba-, phenoxy auxin-, pyridyloxy auxin-, aryloxyphenoxypropionate-, acetyl CoA carboxylase (ACCase) inhibitor-, imidazolinone-, 4-hydroxyphenyl-pyruvate dioxygenase (HPPD) inhibitor-, protoporphyrinogen oxidase (PPO) inhibitor-, triazine-, or bromoxynil-tolerant crop.

56. The method of claim 55, wherein the tolerant crop possesses multiple or stacked traits conferring tolerance to multiple herbicides or multiple modes of action

57. The method of claim 26, wherein the undesirable vegetation includes a broadleaf weed and/or a grass weed.

58. The method of claim 26, wherein the undesirable vegetation comprises a herbicide resistant or tolerant weed.

59. The method of claim 58, wherein the resistant or tolerant weed is a biotype with resistance or tolerance to multiple herbicides, multiple chemical classes, or multiple herbicide modes-of-action.

60. The method of claim 58, wherein the resistant or tolerant weed is a biotype resistant or tolerant to photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action, quinclorac, arylaminopropionic acids, difenzoquat, endothall, or organoarsenicals.

61. The method of claim 26, wherein the undesirable vegetation includes velvetleaf, blackgrass, pigweed, wild oat, brown mustard, rutabaga, spring rape, winter rape, turnip, lambsquarters, thistle, nutsedge, large crabgrass, barnyardgrass, poinsettia, soybean, sunflower, ivyleaf morningglory, kochia, wild buckwheat, giant foxtail, sorghum, common chickweed, wild pansy, or a combination thereof.

62. The method of claim 26, wherein the active ingredients applied to the vegetation or an area adjacent the vegetation or applied to soil or water to control the emergence or growth of vegetation consist of (a) and (b).

63. The composition of claim 8, wherein the aryloxyphenoxypropionate herbicide is fenoxaprop.

64. The composition of claim 8, wherein the aryloxyphenoxypropionate herbicide is clodinafop.

65. The composition of claim 8, wherein the aryloxyphenoxypropionate herbicide is cyhalofop.

66. The composition of claim 8, wherein the aryloxyphenoxypropionate herbicide is diclofop.

67. The composition of claim 8, wherein the aryloxyphenoxypropionate herbicide is fluazifop.

68. The composition of claim 8, wherein the aryloxyphenoxypropionate herbicide is haloxyfop.

69. The composition of claim 8, wherein the aryloxyphenoxypropionate herbicide is quizalofop.

70. The composition of claim 8, wherein the aryloxyphenoxypropionate herbicide is clethodim.

71. The composition of claim 8, wherein the aryloxyphenoxypropionate herbicide is setoxydim.

72. The composition of claim 8, wherein the aryloxyphenoxypropionate herbicide is tralkoxydim.
